(19) United States
(12) Patent Application Publication
(10) Pub. No.: US 2026/0067142 A1
(43) Pub. Date: Mar. 5, 2026

(54) SYSTEMS, APPARATUSES, METHODS, AND NON-TRANSITORY COMPUTER-READABLE STORAGE DEVICES FOR WIRELESS COMMUNICATION EMPLOYING DISTRIBUTIVE RESOURCE UNITS WITH PREAMBLE PUNCTURING

(71) Applicant: HUAWEI TECHNOLOGIES CO., LTD., Shenzhen (CN)

(72) Inventors: Yan Xin, Kanata (CA); Jung Hoon Suh, Kanata (CA); Osama Aboul-Magd, Kanata (CA); Sara Norouzi, Vancouver (CA); Mahmoud Hasabelnaby, Kelowna (CA)

(21) Appl. No.: 19/012,436

(22) Filed: Jan. 7, 2025

Related U.S. Application Data
(60) Provisional application No. 63/691,100, filed on Sep. 5, 2024.

(51) Int. Cl. H04L 27/26; H04L 5/00

(52) U.S. Cl. CPC H04L 27/2602; H04L 5/0092; H04L 5/0094

(57) ABSTRACT

A method has the step of: transmitting or receiving a signal using a first resource unit (RU) in an orthogonal frequency-division multiple access (OFDMA) physical layer protocol data unit (PPDU). The first RU is selected from multiple first RUs of a first tone plan for the PPDU, which are same as second RUs of a second tone plan obtained by a tone-distribution method have the steps of: partitioning the PPDU into multiple subchannels, determining a third tone plan having third RUs, the tone indices of the third tone plan being greater than or equal to zero, and modifying tone indices of the third tone plan such that the modified tone indices thereof have negative and positive indices excluding a plurality of direct current (DC) tones at and around index zero, to obtain multiple modified third RUs as part of the second RUs for at least a first subchannel.

### CROSS-REFERENCE TO RELATED APPLICATIONS

This application claims the benefit of U.S. Provisional Patent Application Ser. No. 63/691,100, filed Sep. 5, 2024, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing distributive resource units with preamble puncturing.

### BACKGROUND

Wireless communication systems such as IEEE 802.1lac (WI-FI® 5; WI-FI is a registered trademark of Wi-Fi Alliance, Austin, TX, USA) and IEEE 802.1 lax (WI-FI® 6) systems need to meet the government-regulated power spectral density (PSD) requirements, which lays the limit in the upper bound on the transmitter (TX) power at, for example, every one (1) megahertz (MHz). The total TX power has also been regulated.

In wireless communication systems (such as IEEE 802.1 lax (WI-FI® 6) systems) using orthogonal frequency division multiple access (OFDMA; which uses orthogonal frequency division multiplexing (OFDM) for multiple access), the resource unit (RU) is the OFDMA scheduling unit. In conventional wireless communication technologies, a RU usually only occupies a sub-bandwidth of consecutive subcarriers of the OFDM frame according to the size of the RU. When using OFDMA, different RUs may be used with different TX power. However, the government-regulated PSD requirements limit the TX power that can be used in RUs.

### SUMMARY

According to one aspect of this disclosure, there is provided a first communication method comprising: transmitting or receiving a signal using a resource unit (RU) in an orthogonal frequency-division multiple access (OFDMA) physical layer protocol data unit (PPDU); wherein the PPDU has a bandwidth of 60 MHz partitioned to three 20 MHz subchannels, or a bandwidth of 80 MHz partitioned to four 20 MHz subchannels with a highest 20 MHz subchannels temporarily unusable; wherein the RU is selected from a first tone plan, and the first tone plan is one of a second tone plan or a third tone plan; wherein the second tone plan comprises: a plurality of 26-tone RUs, a plurality of 52-tone RUs, a plurality of 106-tone RUs, a plurality of 242-tone RUs, or a combination thereof; wherein the plurality of 26-tone RUs of the second tone plan comprise:
[−494:27:−278, −246:27:−165, −120:27:−12, 38:27:227],
[−482:27:−266, −234:27:−153, −108:27:−27, 23:27:239],
[−488:27:−272, −240:27:−159, −114:27:−33, 17:27:233],
[−476:27:−260, −228:27:−147, −102:27:−21, 29:27:245],
[−470:27:−281, −249:27:−141, −123:27:−15, 35:27:224],
[−491:27:−275, −243:27:−162, −117:27:−36, 14:27:230],
[−479:27:−263, −231:27:−150, −105:27:−24, 26:27:242],
[−485:27:−269, −237:27:−156, −111:27:−30, 20:27:236],
[−473:27:−284, −252:27:−144, −126:27:−18, 32:27:221],
[−492:27:−276, −244:27:−163, −118:27:−37, 13:27:229],
[−480:27:−264, −232:27:−151, −106:27:−25, 25:27:241],
[−486:27:−270, −238:27:−157, −112:27:−31, 19:27:235],
[−474:27:−285, −253:27:−145, −100:27:−19, 31:27:247],
[−468:27:−279, −247:27:−139, −121:27:−13, 37:27:226],
[−489:27:−273, −241:27:−160, −115:27:−34, 16:27:232],
[−477:27:−261, −229:27:−148, −103:27:−22, 28:27:244],
[−483:27:−267, −235:27:−154, −109:27:−28, 22:27:238],
[−471:27:−282, −250:27:−142, −124:27:−16, 34:27:223],
[−493:27:−277, −245:27:−164, −119:27:−38, 12:27:228],
[−481:27:−265, −233:27:−152, −107:27:−26, 24:27:240],
[−487:27:−271, −239:27:−158, −113:27:−32, 18:27:234],
[−475:27:−259, −227:27:−146, −101:27:−20, 30:27:246],
[−469:27:−280, −248:27:−140, −122:27:−14, 36:27:225],
[−490:27:−274, −242:27:−161, −116:27:−35, 15:27:231],
[−478:27:−262, −230:27:−149, −104:27:−23, 27:27:243],
[−484:27:−268, −236:27:−155, −110:27:−29, 21:27:237], and
[−472:27:−283, −251:27:−143, −125:27:−17, 33:27:222];
the plurality of 52-tone RUs of the second tone plan comprise:
[−494:27:−278, −246:27:−165, −120:27:−12, 38:27:227, −482:27:−266, −234:27:−153, −108:27:−27, 23:27:239],
[−488:27:−272, −240:27:−159, −114:27:−33, 17:27:233, −476:27:−260, −228:27:−147, −102:27:−21, 29:27:245],
[−491:27:−275, −243:27:−162, −117:27:−36, 14:27:230, −479:27:−263, −231:27:−150, −105:27:−24, 26:27:242],
[−485:27:−269, −237:27:−156, −111:27:−30, 20:27:236, −473:27:−284, −252:27:−144, −126:27:−18, 32:27:221],
[−492:27:−276, −244:27:−163, −118:27:−37, 13:27:229, −480:27:−264, −232:27:−151, −106:27:−25, 25:27:241],
[−486:27:−270, −238:27:−157, −112:27:−31, 19:27:235, −474:27:−285, −253:27:−145, −100:27:−19, 31:27:247],
[−489:27:−273, −241:27:−160, −115:27:−34, 16:27:232, −477:27:−261, −229:27:−148, −103:27:−22, 28:27:244],
[−483:27:−267, −235:27:−154, −109:27:−28, 22:27:238, −471:27:−282, −250:27:−142, −124:27:−16, 34:27:223],
[−493:27:−277, −245:27:−164, −119:27:−38, 12:27:228, −481:27:−265, −233:27:−152, −107:27:−26, 24:27:240],
[−487:27:−271, −239:27:−158, −113:27:−32, 18:27:234, −475:27:−259, −227:27:−146, −101:27:−20, 30:27:246],
[−490:27:−274, −242:27:−161, −116:27:−35, 15:27:231, −478:27:−262, −230:27:−149, −104:27:−23, 27:27:243], and
[−484:27:−268, −236:27:−155, −110:27:−29, 21:27:237, −472:27:−283, −251:27:−143, −125:27:−17, 33:27:222];
the plurality of 106-tone RUs of the second tone plan comprise:
[−500, −494:27:−278, −246:27:−165, −120:27:−12, 38:27:227, −482:27:−266, −234:27:−153, −108:27:−27, 23:27:239, −488:27:−272, −240:27:−159, −114:27:−33, 17:27:233, −476:27:−260, −228:27:−147, −102:27:−21, 29:27:245, 251],
[−497, −491:27:−275, −243:27:−162, −117:27:−36, 14:27:230, −479:27:−263, −231:27:−150, −105:27:−24, 26:27:242, −485:27:−269, −237:27:−156, −111:27:−30, 20:27:236, −473:27:−284, −252:27:−144, −126:27:−18, 32:27:221, 248],
[−498, −492:27:−276, −244:27:−163, −118:27:−37, 13:27:229, −480:27:−264, −232:27:−151, −106:27:−25, 25:27:241, −486:27:−270, −238:27:−157, −112:27:−31, 19:27:235, −474:27:−285, −253:27:−145, −100:27:−19, 31:27:247, 253],
[−495, −489:27:−273, −241:27:−160, −115:27:−34, 16:27:232, −477:27:−261, −229:27:−148, −103:27:−22, 28:27:244, −483:27:−267, −235:27:−154, −109:27:−28, 22:27:238, −471:27:−282, −250:27:−142, −124:27:−16, 34:27:223, 250],
[−499, −493:27:−277, −245:27:−164, −119:27:−38, 12:27:228, −481:27:−265, −233:27:−152, −107:27:−26, 24:27:240, −487:27:−271, −239:27:−158, −113:27:−32, 18:27:234, −475:27:−259, −227:27:−146, −101:27:−20, 30:27:246, 252], and
[−496, −490:27:−274, −242:27:−161, −116:27:−35, 15:27:231, −478:27:−262, −230:27:−149, −104:27:−23, 27:27:243, −484:27:−268, −236:27:−155, −110:27:−29, 21:27:237, −472:27:−283, −251:27:−143, −125:27:−17, 33:27:222, 249]; and
the plurality of 242-tone RUs of the second tone plan comprise:
[−500:3:−260, −252:3:−12, 14:3:251],
[−498:3:−261, −253:3:−13, 13:3:253], and
[−499:3:−259, −251:3:−14, 12:3:252],
where indices of each RU are enclosed between “[” and “]”, and a:b:c represents an index range from a to c with a spacing of b;
wherein the third tone plan comprises: a plurality of 26-tone RUs, a plurality of 52-tone RUs, a plurality of 106-tone RUs, a plurality of 242-tone RUs, or a combination thereof; wherein the plurality of 26-tone RUs of the third tone plan comprise:
[−486:27:−27, 27:27:216],
[−471:27:−39, 15:27:231],
[−480:27:−21, 33:27:222],
[−465:27:−33, 21:27:237],
[−474−:27:−15, 39:27:228],
[−483:27:−24, 30:27:219],
[−468:27:−36, 18:27:234],
[−477:27:−18, 36:27:225],
[−462:27:−30, 24:27:240],
[−485:27:−26, 28:27:217],
[−470:27:−38, 16:27:232],
[−479:27:−20, 34:27:223],
[−464:27:−32, 22:27:238],
[−473−:27:−14, 40:27:229],
[−482:27:−23, 31:27:220],
[−467:27:−35, 19:27:235],
[−476:27:−17, 37:27:226],
[−461:27:−29, 25:27:241],
[−484:27:−25, 29:27:218],
[−469:27:−37, 17:27:233],
[−478:27:−19, 35:27:224],
[−463:27:−31, 23:27:239],
[−472−:27:−13, 41:27:230],
[−481:27:−22, 32:27:221],
[−466:27:−34, 20:27:236],
[−475:27:−16, 38:27:227], and
[−460:27:−28, 26:27:242],
the plurality of 52-tone RUs of the third tone plan comprise:
[−486:27:−27, 27:27:216, −471:27:−39, 15:27:231],
[−480:27:−21, 33:27:222, −465:27:−33, 21:27:237],
[−483:27:−24, 30:27:219, −468:27:−36, 18:27:234],
[−477:27:−18, 36:27:225, −462:27:−30, 24:27:240],
[−485:27:−26, 28:27:217, −470:27:−38, 16:27:232],
[−479:27:−20, 34:27:223, −464:27:−32, 22:27:238],
[−482:27:−23, 31:27:220, −467:27:−35, 19:27:235],
[−476:27:−17, 37:27:226, −461:27:−29, 25:27:241],
[−484:27:−25, 29:27:218, −469:27:−37, 17:27:233],
[−478:27:−19, 35:27:224, −463:27:−31, 23:27:239],
[−481:27:−22, 32:27:221, −466:27:−34, 20:27:236], and
[−475:27:−16, 38:27:227, −460:27:−28, 26:27:242],
the plurality of 106-tone RUs of the third tone plan comprise:
[−486:27:−27, 27:27:216, −471:27:−39, 15:27:231, −480:27:−21, 33:27:222, −465:27:−33, 21:27:237, −492, 243],
[−483:27:−24, 30:27:219, −468:27:−36, 18:27:234, −477:27:−18, 36:27:225, −462:27:−30, 24:27:240, −489, 246],
[−485:27:−26, 28:27:217, −470:27:−38, 16:27:232, −479:27:−20, 34:27:223, −464:27:−32, 22:27:238, −491, 244],
[−482:27:−23, 31:27:220, −467:27:−35, 19:27:235, −476:27:−17, 37:27:226, −461:27:−29, 25:27:241, −488, 247],
[−484:27:−25, 29:27:218, −469:27:−37, 17:27:233, −478:27:−19, 35:27:224, −463:27:−31, 23:27:239, −490, 245], and
[−481:27:−22, 32:27:221, −466:27:−34, 20:27:236, −475:27:−16, 38:27:227, −460:27:−28, 26:27:242, −487, 248], and
the plurality of 242-tone RUs comprise:
[−498:3:−15, 15:3:252],
[−497:3−14, 16:3:253], and
[−496:3:−13, 17:3:254].

In some embodiments, the plurality of 26-tone, 52-tone, 106-tone, and 242-tone RUs are obtained from a plurality of intermediate 26-tone, 52-tone, 106-tone, and 242-tone RUs by deducting 5 from indices of the plurality of intermediate 26-tone, 52-tone, 106-tone, and 242-tone RUs that are smaller than or equal to −254; wherein the plurality of intermediate 26-tone RUs comprise:
[−489:27:−165, −120:27:−12, 38:27:227],
[−477:27:−153, −108:27:−27, 23:27:239],
[−483:27:−159, −114:27:−33, 17:27:233],
[−471:27:−147, −102:27:−21, 29:27:245],
[−465−:27:−141, −123:27:−15, 35:27:224],
[−486:27:−162, −117:27:−36, 14:27:230],
[−474:27:−150, −105:27:−24, 26:27:242],
[−480:27:−156, −111:27:−30, 20:27:236],
[−468:27:−144, −126:27:−18, 32:27:221],
[−487:27:−163, −118:27:−37, 13:27:229],
[−475:27:−151, −106:27:−25, 25:27:241],
[−481:27:−157, −112:27:−31, 19:27:235],
[−469:27:−145, −100:27:−19, 31:27:247],
[−463−:27:−139, −121:27:−13, 37:27:226],
[−484:27:−160, −115:27:−34, 16:27:232],
[−472:27:−148, −103:27:−22, 28:27:244],
[−478:27:−154, −109:27:−28, 22:27:238],
[−466:27:−142, −124:27:−16, 34:27:223],
[−488:27:−164, −119:27:−38, 12:27:228],
[−476:27:−152, −107:27:−26, 24:27:240],
[−482:27:−158, −113:27:−32, 18:27:234],
[−470:27:−146, −101:27:−20, 30:27:246],
[−464−:27:−140, −122:27:−14, 36:27:225],
[−485:27:−161, −116:27:−35, 15:27:231],
[−473:27:−149, −104:27:−23, 27:27:243],
[−479:27:−155, −110:27:−29, 21:27:237],
[−467:27:−143, −125:27:−17, 33:27:222];
wherein the plurality of intermediate 52-tone RUs comprise:
[−489:27:−165, −120:27:−12, 38:27:227, −477:27:−153, −108:27:−27, 23:27:239],
[−483:27:−159, −114:27:−33, 17:27:233, −471:27:−147, −102:27:−21, 29:27:245],
[−486:27:−162, −117:27:−36, 14:27:230, −474:27:−150, −105:27:−24, 26:27:242],
[−480:27:−156, −111:27:−30, 20:27:236, −468:27:−144, −126:27:−18, 32:27:221],
[−487:27:−163, −118:27:−37, 13:27:229, −475:27:−151, −106:27:−25, 25:27:241],
[−481:27:−157, −112:27:−31, 19:27:235, −469:27:−145, −100:27:−19, 31:27:247],
[−484:27:−160, −115:27:−34, 16:27:232, −472:27:−148, −103:27:−22, 28:27:244],
[−478:27:−154, −109:27:−28, 22:27:238, −466:27:−142, −124:27:−16, 34:27:223],
[−488:27:−164, −119:27:−38, 12:27:228, −476:27:−152, −107:27:−26, 24:27:240],
[−482:27:−158, −113:27:−32, 18:27:234, −470:27:−146, −101:27:−20, 30:27:246],
[−485:27:−161, −116:27:−35, 15:27:231, −473:27:−149, −104:27:−23, 27:27:243],
[−479:27:−155, −110:27:−29, 21:27:237, −467:27:−143, −125:27:−17, 33:27:222];
wherein the plurality of intermediate 106-tone RUs comprise:
[−489:27:−165, −120:27:−12, 38:27:227, −477:27:−153, −108:27:−27, 23:27:239, −483:27:−159, −114:27:−33, 17:27:233, −471:27:−147, −102:27:−21, 29:27:245, −495, 251],
[−486:27:−162, −117:27:−36, 14:27:230, −474:27:−150, −105:27:−24, 26:27:242, −480:27:−156, −111:27:−30, 20:27:236, −468:27:−144, −126:27:−18, 32:27:221, −492, 248],
[−487:27:−163, −118:27:−37, 13:27:229, −475:27:−151, −106:27:−25, 25:27:241, −481:27:−157, −112:27:−31, 19:27:235, −469:27:−145, −100:27:−19, 31:27:247, −493, 253],
[−484:27:−160, −115:27:−34, 16:27:232, −472:27:−148, −103:27:−22, 28:27:244, −478:27:−154, −109:27:−28, 22:27:238, −466:27:−142, −124:27:−16, 34:27:223, −490, 250],
[−488:27:−164, −119:27:−38, 12:27:228, −476:27:−152, −107:27:−26, 24:27:240, −482:27:−158, −113:27:−32, 18:27:234, −470:27:−146, −101:27:−20, 30:27:246, −494, 252],
[−485:27:−161, −116:27:−35, 15:27:231, −473:27:−149, −104:27:−23, 27:27:243, −479:27:−155, −110:27:−29, 21:27:237, −467:27:−143, −125:27:−17, 33:27:222, −491 249]; and
wherein the plurality of intermediate 242-tone RUs comprise:
[−495:3:−12, 14:3:251](that is, [DRU_base_60]),
[−493:3:−13, 13:3:253], and
[−494:3:−14, 12:3:252].

According to one aspect of this disclosure, there is provided a second communication method comprising: transmitting or receiving a signal using a first resource unit (RU) in an orthogonal frequency-division multiple access (OFDMA) physical layer protocol data unit (PPDU), the first RU being selected from a plurality of first RUs of a first tone plan for the PPDU; wherein the plurality of first RUs are same as a plurality of second RUs defined according to a second tone plan; and wherein the second tone plan is obtained by a tone-distribution method comprising: partitioning the PPDU into a plurality of subchannels, determining a third tone plan having a plurality of third RUs, the indices of tones of the third tone plan being greater than or equal to zero, and modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for at least a first subchannel of the plurality of subchannels.

In some embodiments, said modifying the indices of the tones of the third tone plan comprises: modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for the first subchannel of the plurality of subchannels; and shifting the modified indices of the tones of the third tone plan to obtain a plurality of further modified third RUs as a subset of the plurality of second RUs for each of one or more second subchannels of the plurality of subchannels.

In some embodiments, the third tone plan comprises: a plurality of 26-tone RUs, a plurality of 52-tone RUs, a plurality of 106-tone RUs, a plurality of 242-tone RUs, or a combination thereof; wherein the plurality of 26-tone RUs comprise:
[2:9:110, 125:9:233],
[6:9:114, 129:9:237],
[4:9:112, 127:9:235],
[8:9:116, 131:9:239],
[10:9:118, 124:9:232],
[3:9:111, 126:9:234],
[7:9:115, 130:9:238],
[5:9:113, 128:9:236], and
[9:9:117, 123:9:231];
wherein the plurality of 52-tone RUs comprise:
[2:9:110, 125:9:233, 6:9:114, 129:9:237],
4:9:112, 127:9:235, 8:9:116, 131:9:239],
[3:9:111, 126:9:234, 7:9:115, 130:9:238], and
[5:9:113, 128:9:236, 9:9:117, 123:9:231];
wherein the plurality of 106-tone RUs comprise:
[2:9:110, 125:9:233, 6:9:114, 129:9:237, 4:9:112, 127:9:235, 8:9:116, 131:9:239, 119, 122], and
[3:9:111, 126:9:234, 7:9:115, 130:9:238, 5:9:113, 128:9:236, 9:9:117, 123:9:231, 120, 121]; and
wherein the plurality of 242-tone RUs comprise: [0:241].

In some embodiments, the PPDU has a bandwidth of 40 MHz partitioned to two 20 MHz subchannels; and said modifying the indices of the tones of the third tone plan comprises: modifying the indices of the tones of the third tone plan by replacing each index idx of the second number of tones with index (idx*2+ini) when idx≤120, or with the index (idx*2+ini+5) when idx>120, where ini=−244 or 243.

In some embodiments, the PPDU has a bandwidth of 80 MHz partitioned to four 20 MHz subchannels; and said modifying the indices of the tones of the third tone plan comprises: (i) modifying the indices of the tones of the third tone plan by replacing each index idx of the tones of the third tone plan with index (idx*4+ini) when idx≤120, or with the index (idx*4+ini+23) when idx>120, where ini=−495, 494, −493, or −492, and (ii) replacing each index idx of the tones of the third tone plan with index (idx−5) if idx≤−254, or with index (idx+5) if idx≥254.

In some embodiments, the PPDU has a bandwidth of 60 MHz partitioned to three 20 MHz subchannels, or a bandwidth of 80 MHz partitioned to four 20 MHz subchannels with a highest 20 MHz subchannel temporarily unusable; and said modifying the indices of the tones of the third tone plan comprises: (i) modifying the indices of the tones of the third tone plan by replacing each index idx of the tones of the third tone plan with index (idx*3+ini) when idx≤161, or with the index (idx*3+ini+23) when idx>161, where ini=−495, or modifying the indices of the tones of the third tone plan by replacing each index idx of the tones of the third tone plan with index (idx*3+ini) when idx≤160, or with the index (idx*3+ini+23) when idx>160, where ini=−493, or −494, and (ii) replacing each index idx of the tones of the third tone plan with index (idx−5) if idx≤−254.

In some embodiments, the PPDU has a bandwidth of 40 MHz partitioned to two 20 MHz subchannels, or a bandwidth of 80 MHz partitioned to four 20 MHz subchannels with two highest 20 MHz subchannels temporarily unusable; and said modifying the indices of the tones of the third tone plan comprises: (i) modifying the indices of the tones of the third tone plan by replacing each index idx of the tones of the third tone plan with index (idx*2+ini), where ini=−495 or −494, and (ii) replacing each index idx of the tones of the third tone plan with index (idx−5) if idx≤−254.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform any of above-described methods.

According to one aspect of this disclosure, there is provided one or more non-transitory computer-readable storage media comprising computer-executable instructions, wherein the instructions, when executed, cause one or more processors to perform any of above-described methods.

According to one aspect of this disclosure, there is provided a second communication method comprising: transmitting or receiving a signal to a device using a resource unit (RU) in an orthogonal frequency-division multiple access (OFDMA) physical layer protocol data unit (PPDU); wherein the RU is one of a plurality of RUs of the OFDMA PPDU; wherein each RU of the plurality of RUs comprises a plurality of subcarriers for data and/or pilot-symbol transmission; and wherein, the plurality of subcarriers of each RU of the plurality of RUs comprises subcarriers of a distributed RU (DRU) shown in any one of Table 6B, Tables 9A and 9B, Tables 10A and 1OB, Tables 13A to 13D, Table 14, Tables 17A to 17C, Table 18, Table 19, Table 20, Table 21, Tables 23A and 23B, and Table 24 described in the Detailed Description section.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform the above-described first and/or second methods.

According to one aspect of this disclosure, there is provided one or more circuits, such as at least one processing unit or at least one processor, for performing above-described first and/or second methods.

According to one aspect of this disclosure, there is provided one or more non-transitory computer-readable storage devices or media comprising computer-executable instructions, wherein the instructions, when executed, cause one or more circuits, such as one or more processing units or one or more processors, to perform above-described first and/or second methods.

With above-described summary and the Detailed Description section below, those skilled in the art will appreciate that various DRU tone plans in PPDU BWs and related methods for tone distribution are disclosed. The DRU tone plans disclosed herein may be used without subchannel puncturing, and are also suitable for subchannel puncturing if needed. The DRU-design methods disclosed herein are systematic methods using a dual-level tone distribution methodology for designing tone distributions in DRU with different tone sizes, DRU BWs, and subchannel puncturing patterns, so as to distribute subcarriers (that is, tones) in multiple RUs, each of which is for a specific STA, in an OFDMA PPDU. The DRU tone plans and methods disclosed herein provide simple implementation on tone distributions in DRU for various cases of different tone sizes, DRU BWs, and subchannel puncturing patterns.

With the DRU tone plans and methods disclosed herein, individual tones (including data tones and pilot tones) in an RRU for a STA 112 using OFDMA are substantially distributed over a DRU BW as large as possible so as to maximize the per-tone power based on the regulatory body's PSD limitation rules. By using the DRU tone plans and methods disclosed herein, the DRUs in some embodiments have the same set of RU sizes as corresponding RRUs.

The DRU tone plans and methods disclosed herein are flexible for different RU sizes and different PPDU BWs, and provide simplified practical implementation with simple signaling for tone distribution. For example, the DRU tone plans and methods disclosed herein provide at least the following advantages:
unified design for DRU tone distribution with or without subchannel puncturing; and
simple implementation while maximizing tone separation in DRU.

The DRU tone plans and methods disclosed herein and the resulting DRU plans may be related to the standardization of next generation of WLAN systems such as IEEE 802.11bn (WI-FI® 8).

The DRU tone plans and methods disclosed herein may be used in WI-FI APs and STAs with operating capability in both sub-7 GHz and millimeter bands.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing resource unit (RU) locations in an 80 megahertz (MHz) Enhanced High Throughput (EHT) physical layer protocol data unit (PPDU);

FIGS. 5A and 5B are schematic diagrams showing regular RUs (RRUs) (FIG. 5A) and distributed RUs (DRUs) (FIG. 5B);

FIG. 6 is a flowchart showing a dual-level tone distribution method, according to some embodiments of this disclosure;

FIG. 7 illustrates a table showing data and pilot subcarrier indices for DRUs in a 20 MHz Ultra High Reliability (UHR) PPDU;

FIG. 8 illustrates a table showing a first-level tone distribution on the universal data, pilot, and null subcarrier indices of the DRU indices per 20 MHz, for the dual-level tone distribution method shown in FIG. 6, according to some embodiments of this disclosure;

FIG. 9 illustrates a table showing the data and pilot indices of the 26-, 52-, and 106-tone DRUs as well as null tones corresponding to the 242-tone RU in a 20 MHz PPDU, obtained following the dual-level tone distribution method shown in FIG. 6, according to some embodiments of this disclosure;

FIGS. 10A and 10B illustrate tables showing the preliminary 26-tone DRU tone distributions corresponding to the 242-tone DRU1 and DRU2, respectively, in a 40 MHz PPDU obtained based on the first-level tone distribution on the universal data, pilot, and null subcarrier indices of the DRU indices per 20 MHz shown in FIG. 8, and within the second-level tone distribution of 242-tone DRUs in a 40 MHz PPDU, according to some embodiments of this disclosure;

FIGS. 11A and 11B illustrate tables showing an example of tone distributions in 26-, 52-, and 106-tone DRUs corresponding to the 242-tone DRU1 and DRU2, respectively, in a 40 MHz PPDU, according to some embodiments of this disclosure;

FIGS. 12A and 12B illustrate tables showing another example of tone distributions in 26-, 52-, and 106-tone DRUs corresponding to the 242-tone DRU1 and DRU2, respectively, in a 40 MHz PPDU, according to some embodiments of this disclosure;

FIG. 13 illustrates a table showing a second-level tone distribution of 242-tone DRUs in an 80 MHz PPDU, according to some embodiments of this disclosure;

FIGS. 14A to 14D illustrate tables showing the preliminary 26-tone DRU tone distributions corresponding to the 242-tone DRU1, DRU2, DRU3, and DRU4, respectively, in an 80 MHz PPDU obtained based on the first-level tone distribution on the universal data, pilot, and null subcarrier indices of the DRU indices per 20 MHz shown in FIG. 8 and the second-level tone distribution of 242-tone DRUs in an 80 MHz PPDU shown in FIG. 13, according to some embodiments of this disclosure;

FIGS. 15A to 15D illustrate tables of 26-, 52-, and 106-tone DRU tone distributions corresponding to 242-tone DRUs in an 80 MHz PPDU, according to some embodiments of this disclosure;

FIG. 16 illustrates a table showing tone distribution of 484-tone DRUs in an 80 MHz PPDU, according to some embodiments of this disclosure;

FIG. 17 is a schematic diagram showing an 80 MHz PPDU with the last (highest) 20 MHz subchannel thereof being punctured;

FIGS. 18A to 18C illustrate tables showing the preliminary 26-tone DRU tone distributions corresponding to the 242-tone DRU1, DRU2, and DRU3, respectively, in an 80 MHz PPDU with DRU BW of 60 MHz when the last (highest) 20 MHz subchannel is punctured, according to some embodiments of this disclosure;

FIGS. 19A to 19C illustrate tables showing 26-, 52-, and 106-tone DRU tone distributions corresponding to the 242-tone DRU1, DRU2, and DRU3, respectively, in an 80 MHz PPDU with DRU BW of 60 MHz when the last (highest) 20 MHz subchannel is punctured, according to some embodiments of this disclosure;

FIG. 20 is a schematic diagram showing an 80 MHz PPDU with the third (second highest) 20 MHz subchannel thereof being punctured;

FIG. 21 illustrates a table showing tone distributions of 26-, 52-, 106-, and 242-tone DRUs in an 80 MHz PPDU with DRU BW of 60 MHz when the third (second highest) 20 MHz subchannel is punctured, according to some embodiments of this disclosure;

FIG. 22 is a schematic diagram showing an 80 MHz PPDU with the second (second lowest) 20 MHz subchannel thereof being punctured;

FIG. 23 illustrates a table showing tone distributions of 26-, 52-, 106-, and 242-tone DRUs in an 80 MHz PPDU with DRU BW of 60 MHz when the second (second lowest) 20 MHz subchannel is punctured, according to some embodiments of this disclosure;

FIG. 24 is a schematic diagram showing an 80 MHz PPDU with the first (lowest) 20 MHz subchannel thereof being punctured;

FIG. 25 illustrates a table showing tone distributions of 26-, 52-, 106-, and 242-tone DRUs in an 80 MHz PPDU with DRU BW of 60 MHz when the first (lowest) 20 MHz subchannel is punctured, according to some embodiments of this disclosure;

FIG. 26 is a schematic diagram showing an 80 MHz PPDU with the last (highest) two 20 MHz subchannels thereof being punctured;

FIG. 27 illustrates a table showing the second-level tone distribution of 242-tone DRUs in an 80 MHz PPDU with DRU BW of 40 MHz when the last (highest) two 20 MHz subchannels are punctured, according to some embodiments of this disclosure;

FIGS. 28A and 28B illustrate tables showing the preliminary 26-tone DRU tone distributions corresponding to the 242-tone DRU1 and DRU2, respectively, in an 80 MHz PPDU with DRU BW of 40 MHz when the last (highest) two 20 MHz subchannels are punctured, according to some embodiments of this disclosure;

FIGS. 29A and 29B illustrate tables showing 26-, 52-, and 106-tone DRU tone distributions corresponding to 242-tone DRUs in an 80 MHz PPDU with DRU BW of 40 MHz when the last (highest) two 20 MHz subchannels are punctured, according to some embodiments of this disclosure;

FIG. 30 is a schematic diagram showing an 80 MHz PPDU with the two 20 MHz subchannels in the middle thereof being punctured; and

FIG. 31 illustrates a table showing tone distributions of 26-, 52-, 106-, and 242-tone DRUs in an 80 MHz PPDU with DRU BW of 40 MHz when the two 20 MHz subchannels in the middle thereof are punctured, according to some embodiments of this disclosure;

FIG. 32 is a schematic diagram showing an example of an 80 MHz PPDU having four (4) 20 MHz subchannels, wherein the last (highest) 20 MHz subchannel is punctured;

FIG. 33 illustrates a table showing the second-level tone distribution for the three usable subchannels of the 80 MHz PPDU shown in FIG. 32 with the last (highest) 20 MHz subchannel being punctured, according to some embodiments of this disclosure;

FIG. 34 illustrates a table showing the first-level tone distribution on the universal data, pilot, and null subcarrier indices of the DRU indices per 20 MHz, according to some embodiments of this disclosure;

FIGS. 35A to 35C illustrate tables showing the tone plan for the 242-tone DRUs and the corresponding 26-tone, 52-tone and 106-tone DRUs of the 80 MHz PPDU shown in FIG. 32 with the last (highest) 20 MHz subchannel being punctured, according to some embodiments of this disclosure; and

FIGS. 36A to 36D illustrate the tables showing the summary of 26-, 52-, 106, and 242-tone DRU tone distributions of the 80 MHz PPDU shown in FIG. 32 with the last (highest) 20 MHz subchannel being punctured, according to some embodiments of this disclosure.

### DETAILED DESCRIPTION

Embodiments disclosed herein relate to systems, apparatuses, methods, and non-transitory computer-readable storage devices for wireless communication employing distributive resource units. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

a. System Structure

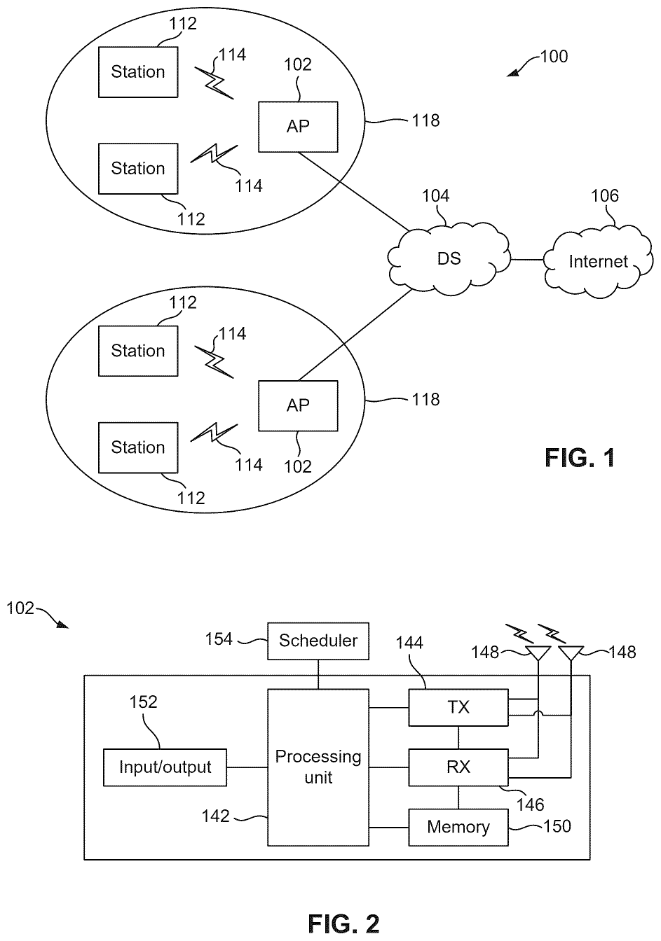

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

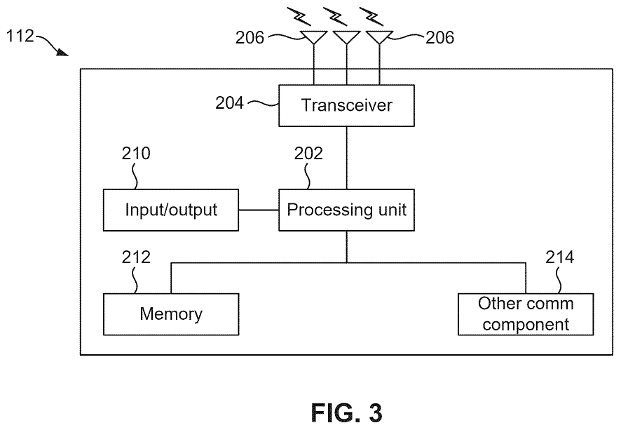

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa'‘naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Orthogonal Frequency Division Multiple Access and Resource Units

### B-1. Resource Units and Tone Distributions

Some wireless communication systems such as IEEE 802.11ax (WI-FI® 6) systems use OFDMA for multiple access. Generally, OFDMA uses orthogonal frequency division multiplexing (OFDM) for multiple users to transmit data at the same time.

For example, in an IEEE 802.1lax system, a device such as an AP 102 or a STA 112 transmits data using physical layer protocol data units (PPDUs). A PPDU contains a preamble and a data field containing an OFDM symbol. As those skilled in the art understand, an OFDM symbol combines data elements into a plurality of subcarriers (also called “tones”) and uses the so-called cyclic prefix for combating inter-symbol interferences. The number of tones in an OFDM symbol depends on the bandwidth (BW) thereof. In IEEE 802.11ax, the subcarrier spacing is 78.125 kilohertz (kHz), and the OFDM BW (that is, the BW of OFDM symbols; also denoted “OFDMA BW” when OFDMA is used) may be 20 MHz, 40 MHz, or 80 MHz. Correspondingly, the number of OFDM tones (that is, the tones in an OFDM symbol; also denoted “OFDMA tones” hereinafter when OFDMA is used) may be 256, 512, or 1024. Some of these tones are unused, including direct-current (DC) tones (also called direct-conversion tones, which include the tone whose frequency is equal to the RF carrier frequency, and some neighboring tones thereof), guard tones, and null tones. Therefore, the usable tones are generally a subset of the total OFDM tones.

When OFDMA is used, the usable OFDMA tones or subcarriers are partitioned into a plurality of resource units (RUs) for assigning to a plurality of users for data and pilot transmission. In an OFDMA transmission, each RU in a PPDU is assigned to a specific STA so that multiple STAs data can be multiplexed within a single PPDU.

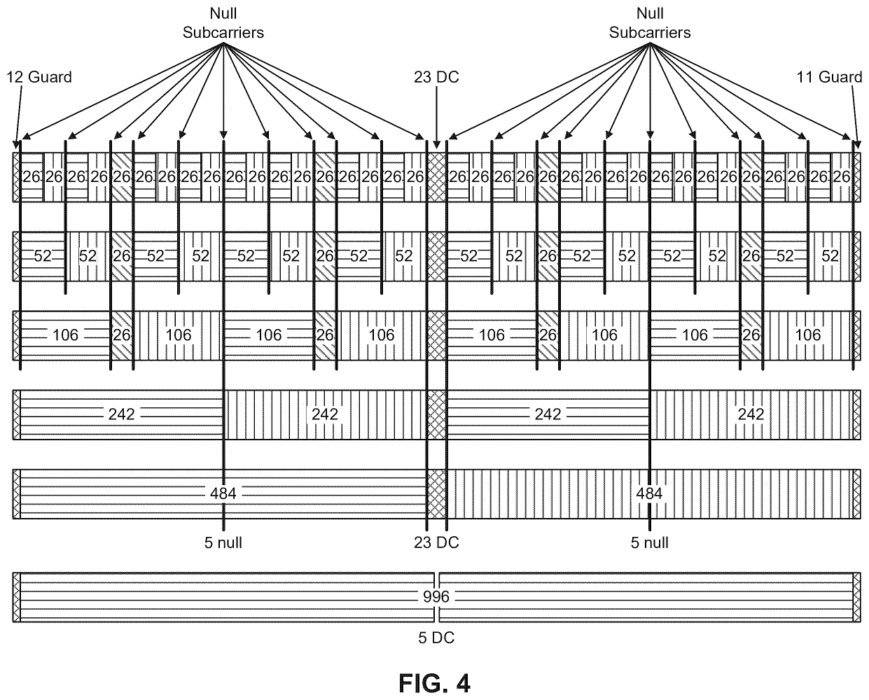

In prior art, consecutive-tone RUs (denoted “regular RUs” or “RRUs” hereinafter) are used, wherein each RU consists of a plurality of consecutive tones. The smallest number of tones of a RU is 26 tones which forms the base RU size and the bigger size of RU has been built up based on the 26-tone RU. For example, FIG. 4 shows the RU locations in an 80 MHz EHT PPDU (see subclause 36.3.2.1, IEEE P802.11be/D5.1).

Table 1 below (reproduced from Table 27-8 in Sec. 27.3.2.2 specified in 802.1lax, Draft P802.11REVme_D7.0) shows the mapping between the subcarrier indices of 26-, 52- and 106-tone RUs and the corresponding subcarrier indices of a 242-tone RU for a 20 MHz PPDU (which are identical to those defined in specified in 802.11be). Note that each of the 26-, 52- and 106-tone RU tone plans has 7 DC subcarriers and the 242-tone RU tone plan has 3 DC subcarriers.

TABLE 1
HE/EHT DATA, PILOT AND NULL SUBCARRIER
INDICES IN A 20 MHZ PPDU

| RU type | RU index and subcarrier range | | | | |
|---|---|---|---|---|---|
| 26-tone RU | RU 1 | RU 2 | RU 3 | RU 4 | RU 5 |
| | [−121:46] | [−95:−70] | [−6%:−43] | [−42:−17] | [−16:−4, |
| | | | | | 4:16] |
| | RU 6 | RU 7 | RU 8 | RU 9 | |
| | [17:42] | [43:68] | [70:95] | [96:121] | |
| 52-tone RU | RU 1 | RU 2 | RU 3 | RU 4 | |
| | [−121:−70] | [−68:−17] | [7:68] | [70:121] | |

| | | |
|---|---|---|
| 106-tone RU | RU 1 | RU 2 |
| | [−122:−17] | [17:122] |

| | |
|---|---|
| 242-tone RU | RU 1 |
| | [−122:−2, 2:122] |

Table 2 (reproduced from Table 27-9 in Sec. 27.3.2.2, specified in 802.11ax, Draft P802.11REVme_D7.0) below presents the mapping between the subcarrier indices of 26-, 52- and 106-tone RUs and the corresponding subcarrier indices of a 242-tone RU for a 40 MHz PPDU (which are identical to those defined in 802.11be). Note that each of the 26-, 52- and 106-tone RU tone plans has 7 DC subcarriers and the 242-tone RU tone plan has 5 DC subcarriers.

TABLE 2
HE/EHT DATA, PILOT AND NULL SUBCARRIER
INDICES IN A 40 MHZ PPDU

| RU type | RU index and subcarrier range | | | | |
|---|---|---|---|---|---|
| 26-tone RU | RU 1 | RU 2 | RU 3 | RU 4 | RU 5 |
| | [−243:−218] | [−212:−192] | [−189:−164] | [−163:−138] | [−136:−111] |
| | RU 6 | RU 7 | RU 8 | RU 9 | |
| | [−109:−8] | [−83:−58] | [−55:−30] | [−29:−4] | |
| | RU 10 | RU 11 | RU 12 | RU 13 | RU 14 |
| | [4:29] | [30:55] | [58:83] | [84:109] | [111:136] |
| | RU 15 | RU 16 | RU 17 | RU 18 | |
| | [138:163] | [164:189] | [192:217] | [218:243] | |
| 52-tone RU | RU 1 | RU 2 | RU 3 | RU 4 | |
| | [−243:−192] | [189:−138] | [−109:−58] | [−55:−4] | |
| | RU 5 | RU 6 | RU 7 | RU 8 | |
| | [4:55] | [58:109] | [138:189] | [192:243] | |
| 106-tone RU | RU 1 | RU 2 | RU 3 | RU 4 | |
| | [−243:−138] | [−109:−4] | [4:109] | [138:243] | |

| | | |
|---|---|---|
| 242-tone RU | RU 1 | RU 2 |
| | [−244:−3] | [3:244] |

| | |
|---|---|
| 484-tone RU | RU 1 |
| | (−244:−3, 3:244] |

Table 3 below shows the 242-tone indices in an 80 MHz PPDU in EHT (reproduced from Table 36-5, IEEE P802.11be/D5.1).

TABLE 3
242-TONE INDICES IN AN 80 MHZ PPDU IN EHT

| | RU1 | Null | RU2 | DC | RU3 | Null | RU4 |
|---|---|---|---|---|---|---|---|
| 242-tone | [−500:−259] | [−258:−254] | [−253:−12] | [−11:11] | [12:253] | [254:258] | [259:500] |

Table 4 below shows the 242-tone indices in an 80 MHz PPDU in EHT, according to a modified tone plan, disclosed in Applicant's U.S. Provisional Application Ser. No. 63/670,540 filed on Jul. 12, 2024, the content of which is incorporated herein by reference in its entirety.

TABLE 4
MODIFIED 242-TONE INDICES IN AN 80 MHZ PPDU FOR UHR

| | Null | RU1 | RU2 | DC | RU3 | RU4 | Null |
|---|---|---|---|---|---|---|---|
| 242-tone | [−500:−496] | [−495:−254] | [−253:−12] | [−11:11] | [12:253] | [254:495] | [496:500] |

In this disclosure, Table 4 is used to facilitate the design of DRU tone distribution in an 80 MHz PPDU. The distributed data and pilot subcarriers are allocated to the RU locations as specified in EHT as shown in Table 3.

In the 6 GHz low power indoor (LPI) bands, regulatory bodies such as Federal Communications Commission (FCC) apply stringent rules on the limit of maximum Equivalent isotropic radiated power (EIRP) power spectral density (PSD), for example, −1 decibel-milliwatts per megahertz (dBm/MHz) for non-AP STA 112. This limits the transmission range and/or reduces transmission rates.

IEEE 802.11bn (Ultra-high reliability (UHR)) standardization is currently under development for a next generation of WLANs. One of the most important goals for UHR is to improve the reliability. FCC allocates about the 1.2 GHz unlicensed spectrum for low power indoor applications at the 6 GHz band. FCC regulates the maximum conducted output power spectrum density (PSD) as: 5 dBm/MHz for an AP; −1 dBm/MHz for a STA. These FCC regulation rules significantly limit the transmit power of a Wi-Fi AP/STA operating in the 6 GHz LPI band compared to those operations in other unlicensed bands. This may result in much shorter communication links and/or lower reliability.

Distributed resource units (DRU) (see IEEE 802.11-23-0037r0) may also be used to distribute tones of a user in an OFDMA system across a wide portion of spectrum within the PPDU bandwidth. In other words, the concept of DRU is to distribute the contiguously allocated data/pilot tones in a RRU (currently specified in 802.11) over a broader spectrum shared with other RUs. Therefore, a separation of data/pilot tones in DRU is required to be a multiple of subcarrier spacing specified in 802.1lax/be and the transmit power of each distributed tone in a DRU can be boosted under the regulation on the output PSD. More specifically, by using DRU, the number of tones of one user within one (1) MHz is reduced and the transmit power can be boosted, which may increase the transmit distance and/or improve the reliability for the STAs operating in the LPI bands.

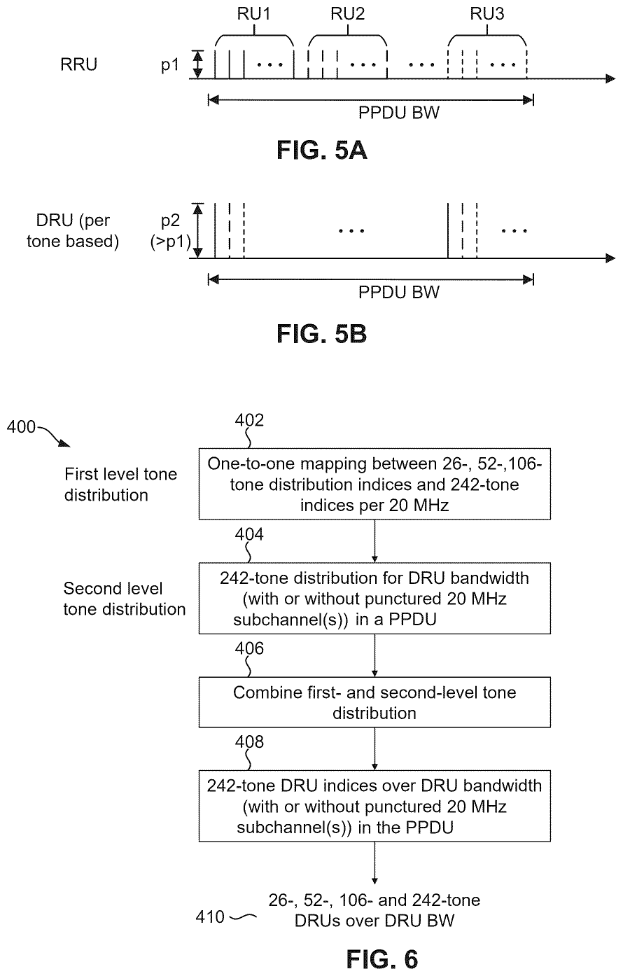

FIGS. 5A and 5B illustrate the RRUs (FIG. 5A) and the DRUs (FIG. 5B) in the BW of a PPDU. The transmit power p2 of each tone in DRUs may be allowed to be greater than the transmit power p1 of each tone in RRUs because of the tone distribution.

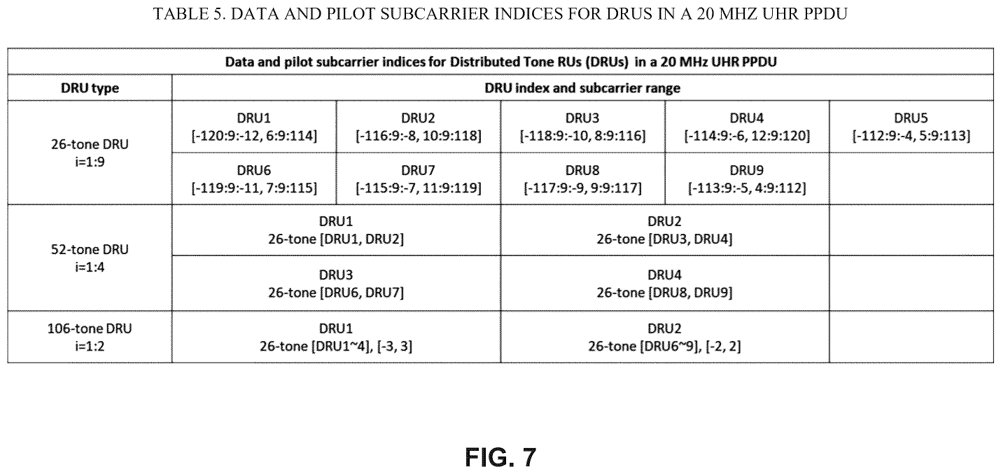

DRU tone plans for different DRU bandwidths (BWs) are shown in IEEE 802.11-24-0468r2, in which preamble puncturing is not considered. FIG. 7 illustrates Table 5 which shows data and pilot subcarrier indices for DRUs in a 20 MHz UHR PPDU.

As those skilled in the art will appreciate, DRU tone distribution is important for system performance and implementation. However, the prior-art DRU plans have serval disadvantages.

For example, the proposed DRU for BW 80 MHz in IEEE 802.11-24-0468r2 has a disadvantage that the design of tone distribution does not consider preamble puncturing.

Preamble puncturing (also called “subchannel puncturing”) is one of main features specified in 802.11be (EHT) (see subclause 36.3.12.11, IEEE P802.11be/D5.1), in which one or multiple 20 MHz subchannels are unavailable for transmission of an RU. Furthermore, in an 80 MHz PPDU, when a 20 MHz subchannel is used by a 20 MHz operation device only, this 20 MHz subchannel may not be available for tone distribution in DRU over 80 MHz. Herein, a subchannel refers to a frequency band that may be used to form a channel of a larger BW. A subchannel generally comprises a plurality of OFDM subcarriers. In some embodiments or use cases, a subchannel may be used as a channel.

While IEEE 802.11-24-0766r2 proposes DRU plans with consideration of preamble puncturing, its disadvantage is that the proposal DRU plans sacrifice the per-tone power boosting gain in DRU.

More specifically, IEEE 802.11-24-0766r2 proposes that, when one 20 MHz subchannel is punctured for an 80 MHz PPDU, subcarriers are allowed to be distributed over two separate DRU BWs including a 20 MHz DRU BW and a 40 MHz DRU BW. In this case, the available BW for distributed subcarriers can be up to 60 MHz. This proposal sacrifices per-tone power boosting gain in DRU. For example, for transmissions of 3×242-tone in an 80 MHz PPDU with one 20 MHz punctured, if the DRU BW is 60 MHz, per-tone power can be boosted by 4.7 dB rather than 0 dB and 3 dB as proposed in this prior art.

In IEEE 802.11-24-0814r0, another solution for preamble puncturing is proposed, in which all subcarriers allocated within a DRU BW are distributed with an equal-tone separation (equal per-tone transmit power) or an almost-equal-tone separation through relative prime interleaving. For the case that one 20 MHz subchannel is punctured for an 80 MHz PPDU, subcarriers are allowed to be distributed over available 60 MHz to maximize per-tone transmit power boosting gain. In this solution, the interleaving size is changeable with a change of combinations of DRU sizes for different STAs and some non-AP STAs may require transmitting higher per-tone power than others.

B-2. Tone Distribution with Preamble Puncturing

DRU tone distribution is important or even crucial for the system performance and implementation. In the following, various embodiments of DRU tone plans and related methods are described, in which preamble puncturing may be applied to UHR for excluding one or more subcarriers in a DRU from being used for data and/or pilot transmission.

Furthermore, in UHR, when a STA 112 operating in the 20 MHz PPDU or a STA 112 transmitting RRU only is multiplexed with a STA with DRU capability across the 20 MHz subchannel boundary in an OFDMA PPDU, the spectrum assigned to the STA 112 operating in the 20 MHz PPDU or a STA 112 transmitting RRU only is also unavailable for STA with DRU capability across the 20 MHz subchannel boundary. In some embodiments, subchannel puncturing for DRU is also used for this case.

In some embodiments, the DRU tone distribution and related methods are suitable for a wideband PPDU with a bandwidth larger than or equal to 80 MHz including, for example, (i) the case wherein all 20 MHz subchannels are available in an 80 MHz PPDU, and (ii) the case wherein the entirety of one or two 20 MHz subchannels are not available for tone distribution. In some embodiments, if a 20 MHz subchannel in an 80 MHz PPDU is punctured, or is allocated for use by a 20-MHz-operating STA or for use by a legacy STA without DRU capability, to maximize the per data and pilot tone transmit power, data and pilot subcarriers may be distributed over all available spectrum for DRU within the corresponding PPDU bandwidth.

FIG. 6 is a flowchart showing a dual-level tone distribution method 400, according to some embodiments of this disclosure. The dual-level tone distribution method 400 is similar to that described in Applicant's U.S. Provisional Application Ser. No. 63/670,540, the content of which is incorporated herein by reference in its entirety, but with a novel design on tone mapping in the first-level tone distribution 402.

As shown, at step 402, the first-level tone distribution is defined for one-to-one mapping between 26-, 52-, 106-tone distribution indices and 242-tone indices per 20 MHz. More specifically, at this step, an initial tone distribution such as a DRU distribution may be obtained using any suitable method. Generally, the initial tone distribution only comprises the usable tones (such as the data tones and pilot tones). Then, null tones are included into the tone distribution to obtain the first-level tone distribution, wherein the null tones are allocated at and around the DC tone, and evenly allocated on both sides of the PPDU, the null tones may be allocated to two edges implying that data and pilot tones in 26-, 52- and 106-tone DRUs are always allocated in the middle tone indices, or the null tones may be allocated according to preset allocation conditions, which will not be limited herein. As those skilled in the art understand, a null tone is a subcarrier which does not carry any information.

At step 404, the second-level tone distribution is specified for 242-tone distribution for DRU bandwidth (with or without punctured 20 MHz subchannel(s)) for a PPDU such as for an 80 MHz PPDU. Then, the first- and second-level tone distribution are combined (step 406) to obtain the 242-tone DRU indices 408 over the DRU BW (with or without punctured 20 MHz subcarrier(s)) in the PPDU. The 26-tone, 52-tone, 106-tone, and 242-tone DRUs 410 over the DRU BW are outputted.

Since the granularity of preamble puncturing in EHT is 20 MHz subchannel, in some embodiments, the dual-level tone distribution method 400 is used for designing the tone distribution in DRU, with a new design of first-level tone distribution 402 related to the data and pilot subcarrier indices for DRUs in a 20 MHz UHR PPDU as described in IEEE 802.11-24-0468r2.

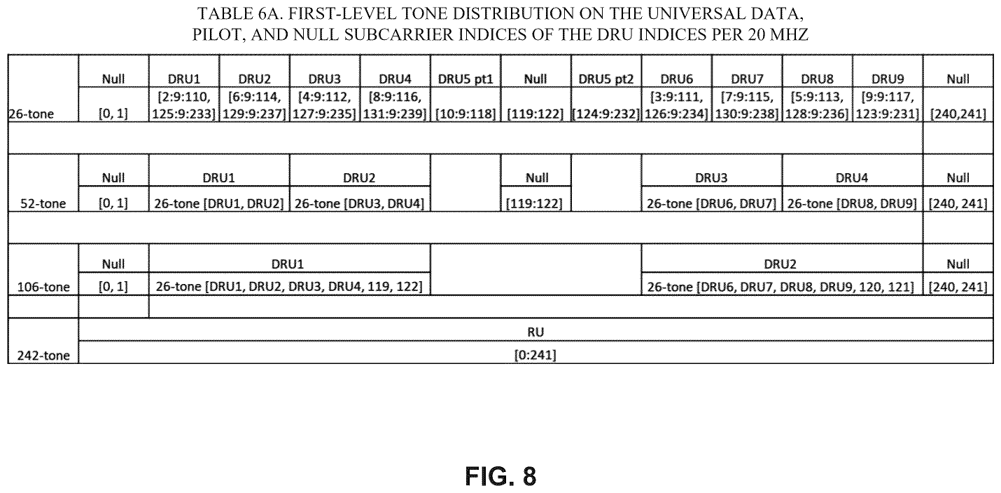

FIG. 8 illustrates Table 6A which shows the first-level tone distribution on the universal data, pilot, and null subcarrier indices of the DRU indices per 20 MHz. In this embodiment, the wherein the tone or subcarrier indices are between 0 and 241 (that is, starting from index zero (0) and increasing to the last index 241). For ease of illustration, the three (3) DC subcarriers in a 242-tone RU are omitted. Herein, the notion “[idx1:idx2]” refers to subcarrier indices from idx1 to idx2. The notion “[idx1:k:idx2]” refers to subcarrier indices from idx1 to idx2 with a separation of k, that is, idx1, idx1+k, idx1+2k, . . . , idx2. The comma symbol (“,”) links a plurality of index ranges. For example, the notion “[idx1:k1:idx2, idx3:idx4]” refers to indices from idx1 to idx2 with a separation of k1, and from idx3 to idx4. As another example, the notion “[DRU1, DRU2] refers to the combination of DRU1 (which is [2:9:110, 125:9:233]) and DRU2 (which is [6:9:114, 129:9:237]). Moreover, the tilde symbol (“˜”) means “to”; for example, “DRU1-4” means “DRU1 to DRU4”, that is, the combination of DRU1, DRU2, DRU3, and DRU4.

As shown in FIG. 8, a tone-distribution method is used to obtain the DRUs without taking into account the null tones. After inserting the null tones, the 26-tone DRU tone plan includes the following null tones and 26-tone DRUs in the index range of [0:241]:
Null: [0, 1];
26-tone DRU1: [2:9:110, 125:9:233];
26-tone DRU2: [6:9:114, 129:9:237];
26-tone DRU3: [4:9:112, 127:9:235];
26-tone DRU4: [8:9:116, 131:9:239];
26-tone DRU5: [10:9:118, 124:9:232](wherein [10:9:118] is referred to as “DRU5 pt1” in FIG. 8, and [124:9:232] is referred to as “DRU5 pt2” in FIG. 8);
Null: [119:122](which is located between DRU5 pt1 and DRU5 pt2);
26-tone DRU6: [3:9:111, 126:9:234];
26-tone DRU7: [7:9:115, 130:9:238];
26-tone DRU8: [5:9:113, 128:9:236];
26-tone DRU9: [9:9:117, 123:9:231]; and
Null: [240, 241].

The 52-tone plan then includes the following null tones and DRUs in the index range of [0:241]:
Null: [0, 1];
52-tone DRU1: combination of 26-tone DRU1 and 26-tone DRU2 (that is, [2:9:110, 125:9:233, 6:9:114, 129:9:237]);
52-tone DRU2: combination of 26-tone DRU3 and 26-tone DRU4 (that is, [4:9:112, 127:9:235, 8:9:116, 131:9:239]);
Null: [119:122];
52-tone DRU3: combination of 26-tone DRU6 and 26-tone DRU7 (that is, [3:9:111, 126:9:234, 7:9:115, 130:9:238]); and
52-tone DRU4: combination of 26-tone DRU8 and 26-tone DRU9 (that is, [5:9:113, 128:9:236, 9:9:117, 123:9:231]).

The 106-tone plan then includes the following DRUs in the index range of [0:241]:
106-tone DRU1: combination of 26-tone DRU1 to 26-tone DRU4, and tones 119 and 122 (that is, [2:9:110, 125:9:233, 6:9:114, 129:9:237, 4:9:112, 127:9:235, 8:9:116, 131:9:239, 119, 122]); and
106-tone DRU2: combination of 26-tone DRU6 to 26-tone DRU9, and tones 120 and 121 (that is, [3:9:111, 126:9:234, 7:9:115, 130:9:238, 5:9:113, 128:9:236, 9:9:117, 123:9:231, 120, 121]).

The 242-tone plan then includes all tones in the index range of [0:241].

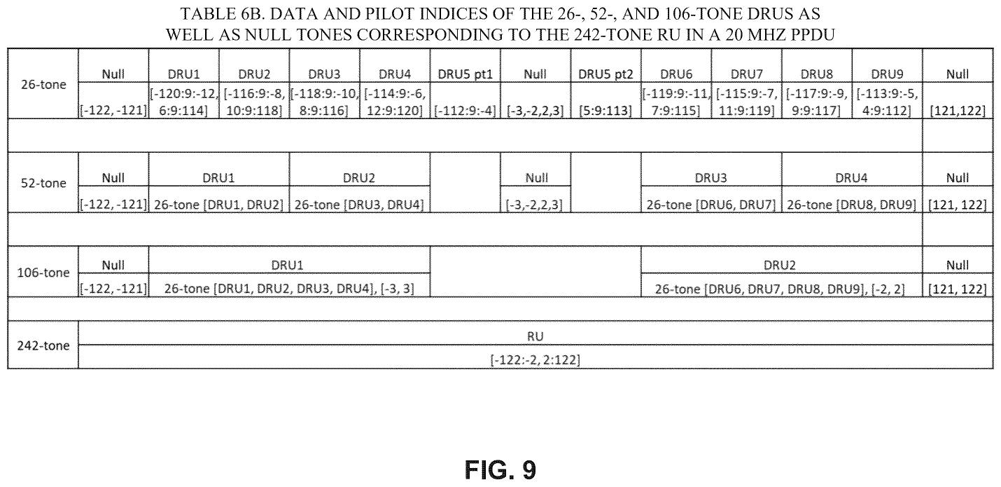

To map the tone indices in Table 6A to the 242-tone RU indices in a 20 MHz PPDU specified in IEEE 802.1lax, that is, 242 data and pilot tones allocated within [−122:−2, 2:122] and 3 DC tones allocated within [−1, 0, 1], each tone index idx in Table 6A (the first-level tone distribution) is replaced with index (idx+ini) when idx≤120, or with index (idx+ini+3) when idx>120 (where the index offset ini=−122 is the smallest index in a 20 MHz PPDU). The result is illustrated in Table 6B shown in FIG. 9, which shows the data and pilot indices of the 26-, 52- and 106-tone DRUs as well as null tones corresponding to the 242-tone RU in a 20 MHz PPDU obtained by above-described index replacing.

It can be observed that the data and pilot tone distributions of the 26-, 52- and 106-tone DRUs in a 20 MHz PPDU shown in Table 6B are equivalent to those disclosed in IEEE 802.11-24-0468r2.

Based on the EHT data, pilot, and null subcarrier indices in a 40 MHz PPDU (see Table 2), the second-level tone distribution 404 of 242-tone DRUs in a 40 MHz PPDU (which should be within [−244:−3] and [3:244] as shown in Table 2) can be obtained as shown in Table 7.

TABLE 7
SECOND-LEVEL TONE DISTRIBUTION OF
242-TONE DRUS IN A 40 MHZ PPDU

| | DRU1 | DRU2 |
|---|---|---|
| 242-tone | [−244:2:−4, | [−243:2:−3, 4:2, |
| | 3:2:243] ⇔[DRU1] | 244] ⇔[DRU1] →1 |

In Table 7, herein, the notion “→j” (also represented in some of the figures as “->j”) denotes that an index is right-shifted (that is, increasing the indices) by j positions (note: index right-shifting is applied to data/pilot/null tones only (that is, DC tones are skipped in performing the index right-shifting. For example, if there are five DC tones −2:2, right-shifting the index −3 (which may be a data, pilot, or null tone) by one (1) obtains the index 3 (that is, increasing the index and skipping the range of DC tones). The notion “idx_range_1⇔idx_range_2” means that index range idx_range_on the left-hand side of the notion “⇔” is equivalent to index range idx_range_2 on the right-hand side of the notion “⇔”.

Thus, Table 7 shows that the indices of the 242-tone DRU1 is [−244:2:−4, 3:2:243], and the indices of the 242-tone DRU2 are the indices of the 242-tone DRU1 right-shifted by one (1), that is, [−243:2:−3, 4:2, 244]. Accordingly, the data and pilot tone indices are allocated within [−244:−3, 3:244] and 5 DC tones are allocated within [−2:2] as defined in 802.1 lax.

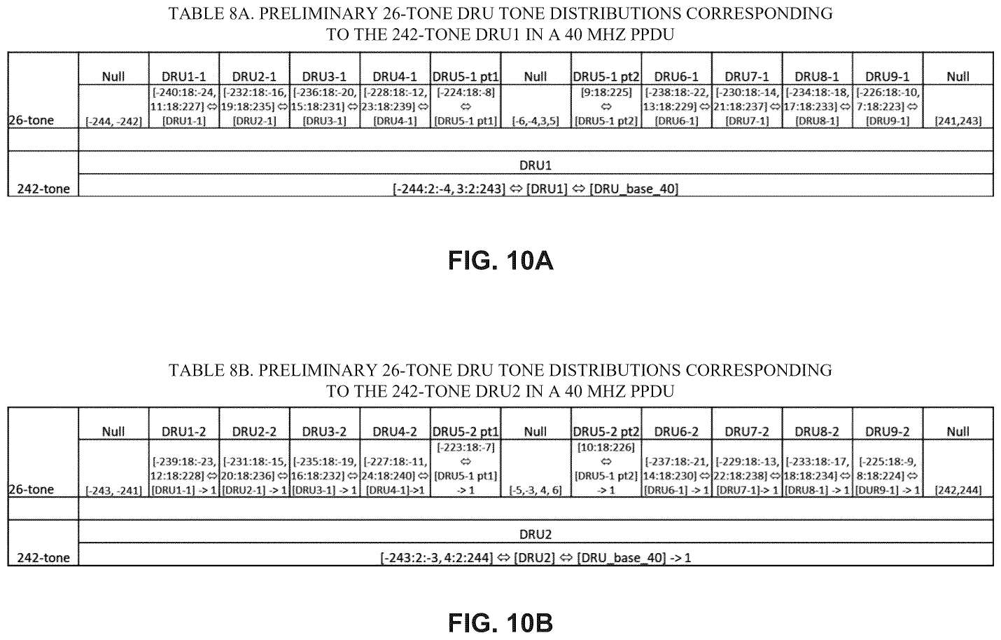

FIG. 10A illustrates Table 8A which shows the preliminary 26-tone DRU tone distributions corresponding to the 242-tone DRU1 in a 40 MHz PPDU obtained based on the first-level tone distribution on the universal data, pilot, and null subcarrier indices of the 26-tone DRU indices per 20 MHz (shown in Table 6A of FIG. 8), and within the second-level tone distribution of 242-tone DRUs in a 40 MHz PPDU (shown in Table 7 above) by replacing each index idx in Table 6A of FIG. 8 (the first-level tone distribution) with the index (idx*2+ini) when idx≤120, or with the index (idx*2+ini+5) when idx>120 (where the index offset ini=−244 is the smallest index in the 242-tone DRU1 in a 40 MHz PPDU). The tone indices of the 242-tone DRU1 are also defined as [DRU_base_40]. Note that, after index replacements (effectively doubled from the indices in the first-level tone distribution, and with an offset), the index spacing (which is now 18) is also doubled from that of the first-level tone distribution (that is, which is nine (9) in Table 6A of FIG. 8). Similar index replacements are also used in embodiments described below, wherein the index spacing or separation is also accordingly changed in a similar manner).

FIG. 10B illustrates Table 8B which shows the preliminary 26-tone DRU tone distributions corresponding to the 242-tone DRU2 in a 40 MHz PPDU obtained based on the first-level tone distribution on the universal data, pilot, and null subcarrier indices of the 26-tone DRU indices per 20 MHz (shown in Table 6A of FIG. 8), and within the second-level tone distribution of 242-tone DRUs in a 40 MHz PPDU (shown in Table 7) by replacing each index idx in Table 6A of FIG. 8 (the first-level tone distribution) with the index (idx*2+ini) when idx≤120, or with the index (idx*2+ini+5) when idx>120 (where the index offset ini=−243 is the smallest index in the 242-tone DRU2 in a 40 MHz PPDU). The tone indices of the 242-tone DRU2 can also be obtained by right-shifting all tone indices in [DRU_base_40] by one (1), which are denoted as [DRU_base_40]→1.

The preliminary 26-tone DRUs shown in Table 8A and 8B, which correspond to 242-tone DRU1 and DRU2 in a 40 MHz PPDU, may be rearranged to construct 26-, 52-, and 106-tone DRU tone distributions in a 40 MHz PPDU in order to satisfy different requirements, for example, tone spacing or peak-to-average power ratio (PAPR).

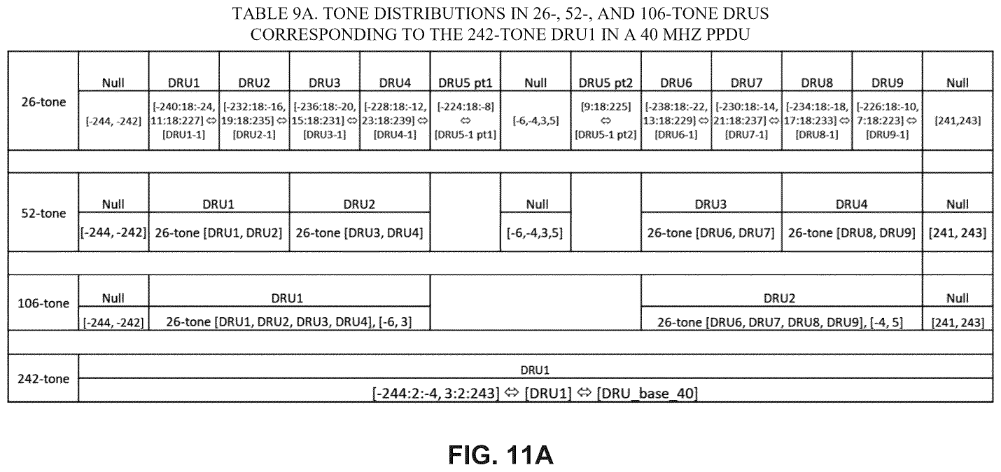

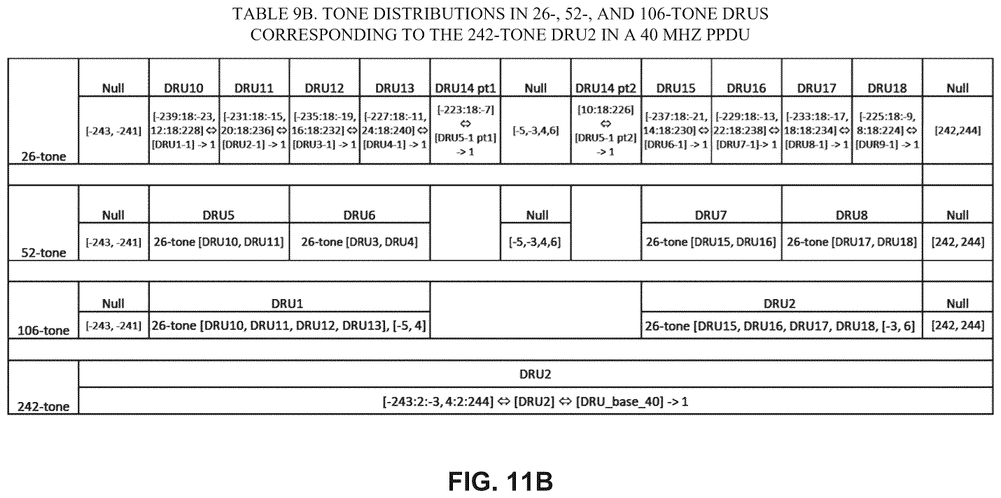

FIGS. 11A and 11B illustrate Table 9A and 9B showing the tone distributions in 26-, 52- and 106-tone DRUs corresponding to the 242-tone DRUs in a 40 MHz PPDU, obtained from the preliminary 26-tone DRU tone distributions shown in Tables 8A and 8B, respectively.

FIG. 11A illustrates Table 9A which shows an example of tone distributions in 26-, 52- and 106-tone DRUs corresponding to the 242-tone DRU1 in a 40 MHz PPDU, obtained from the preliminary 26-tone DRU tone distributions shown in Table 8A of FIG. 10A. Note that the tone separations are 18, 8 or 10, and 4 or 6 for 26-, 52- and 106-tone DRUs, respectively.

FIG. 11B illustrates Table 9B which shows an example of tone distributions in 26-, 52- and 106-tone DRUs corresponding to the 242-tone DRU2 in a 40 MHz PPDU, obtained from the preliminary 26-tone DRU tone distributions shown in Table 8B of FIG. 10B (equivalent to obtained from the preliminary 26-tone DRU tone distributions shown in Table 8A of FIG. 10A, and then further right-shifting the tone indices of all DRUs). Note that the tone separations are 18, 8 or 10, and 4 or 6 for 26-, 52- and 106-tone DRUs, respectively.

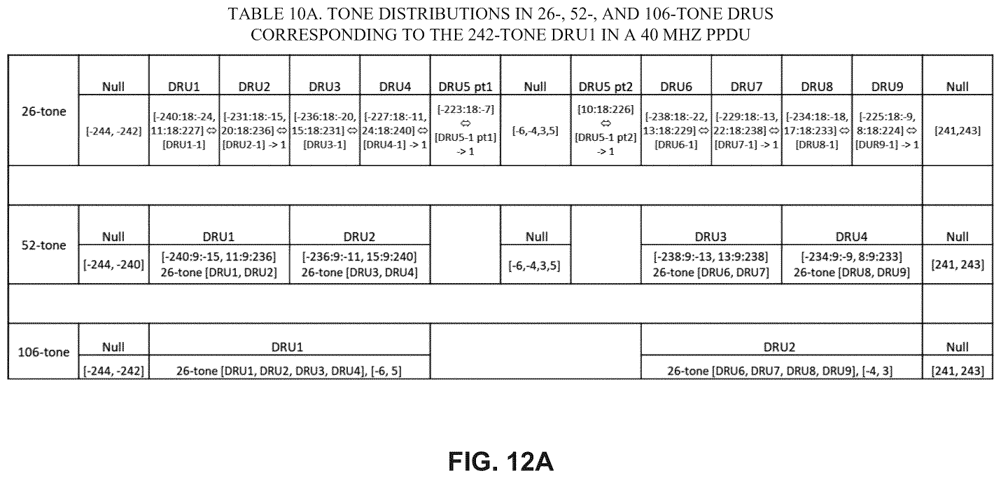

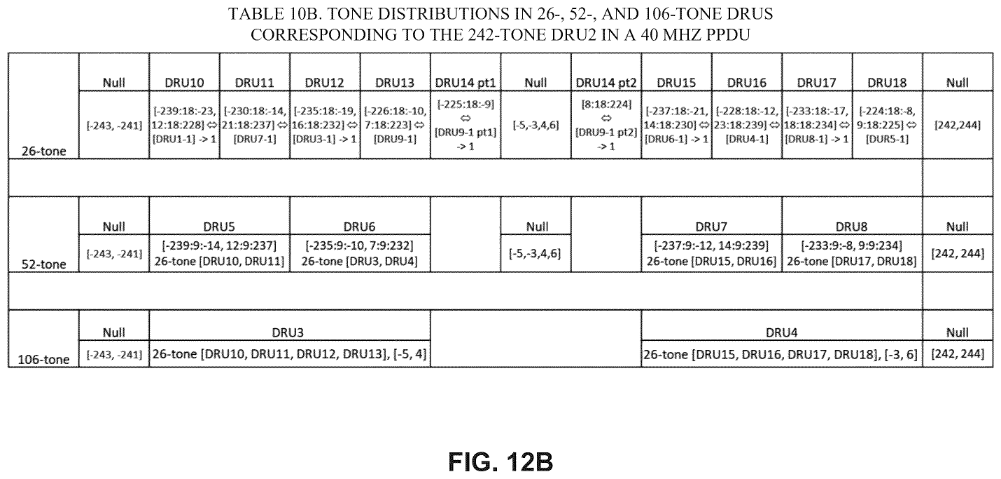

FIG. 12A illustrates Table 10A which shows another example of tone distributions in 26-, 52- and 106-tone DRUs corresponding to the 242-tone DRU1 in a 40 MHz PPDU, obtained from the preliminary 26-tone DRU tone distributions shown in Table 8A of FIG. 10A, and then further right-shifting the tone indices of the 26-tone DRU2, DRU4, DRU5, DRU7, and DRU9.

FIG. 12B illustrates Table 10B which shows another example of tone distributions in 26-, 52- and 106-tone DRUs corresponding to the 242-tone DRU2 in a 40 MHz PPDU, obtained from the preliminary 26-tone DRU tone distributions shown in Table 8A of FIG. 10A, and then further right-shifting the tone indices of the 26-tone DRU10, DRU12, DRU14, DRU15, and DRU17.

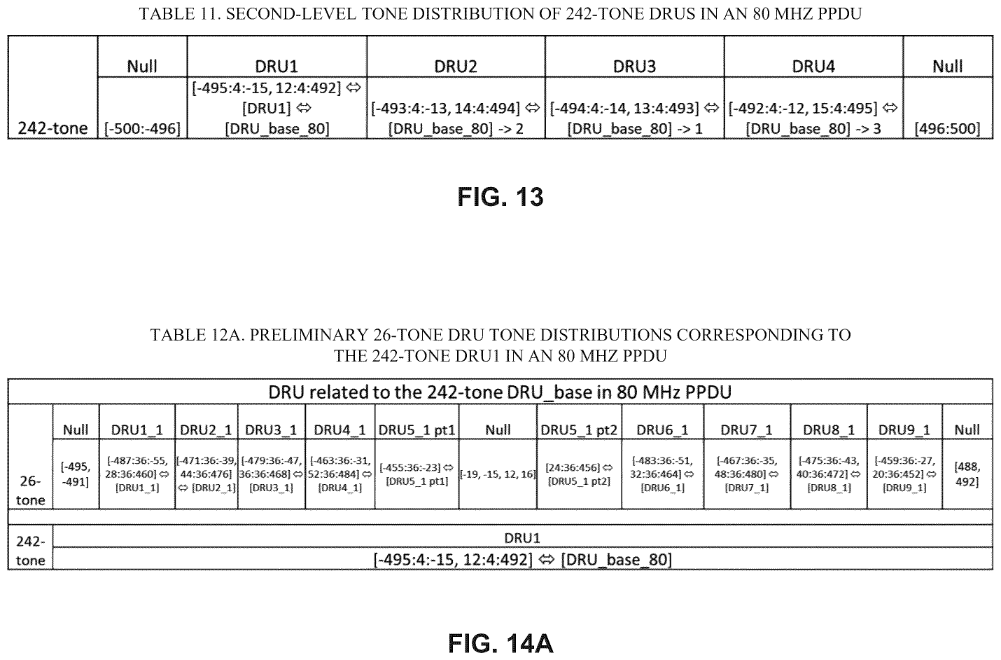

In some embodiments when DRU BW equals 80 MHz in an 80 MHz PPDU, it implies that the whole 80 MHz spectrum is available for tone distribution and there is no 20 MHz subchannel unavailable for tone distribution across 20 MHz subchannels. In these embodiments, the first-level tone distribution on the universal data, pilot, and null subcarrier indices of the DRU indices per 20 MHz is shown in Table 6A of FIG. 8. The second-level tone distribution of 242-tone DRUs in an 80 MHz PPDU is shown in Table 11 illustrated in FIG. 13, which is defined based on the tone plan of 242-tone RUs in an 80 MHz EHT PPDU as shown in Table 3 where 23 DC tones are allocated within [−11:11].

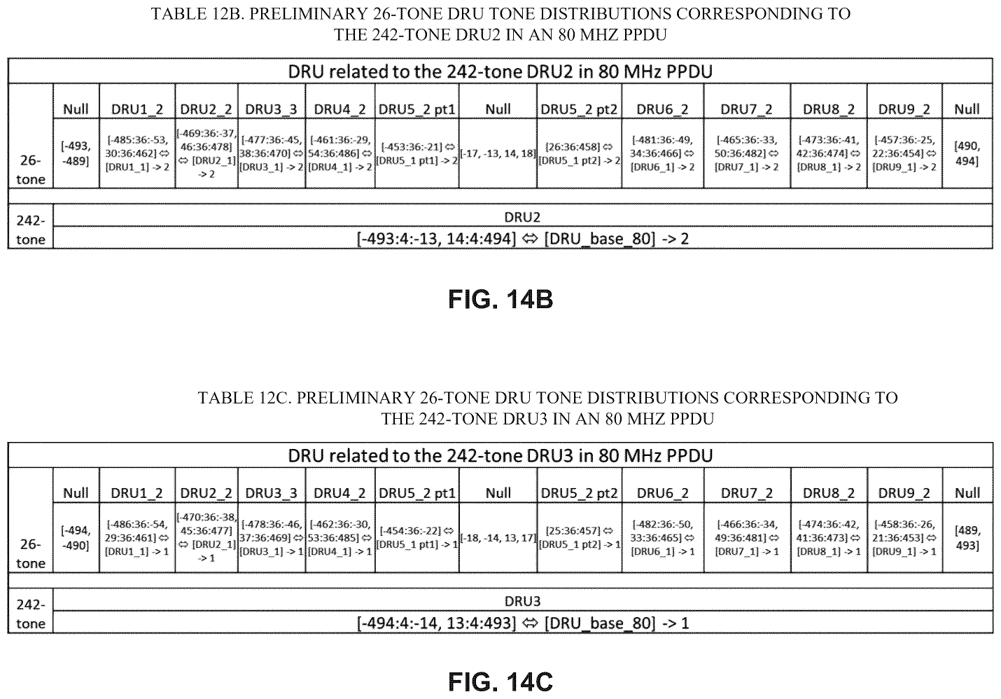

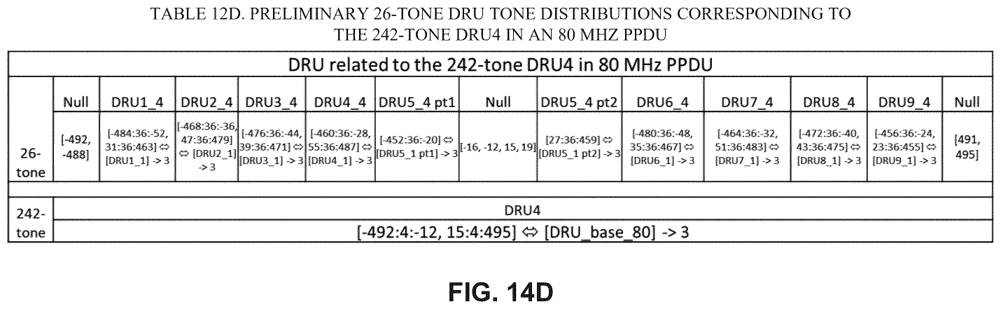

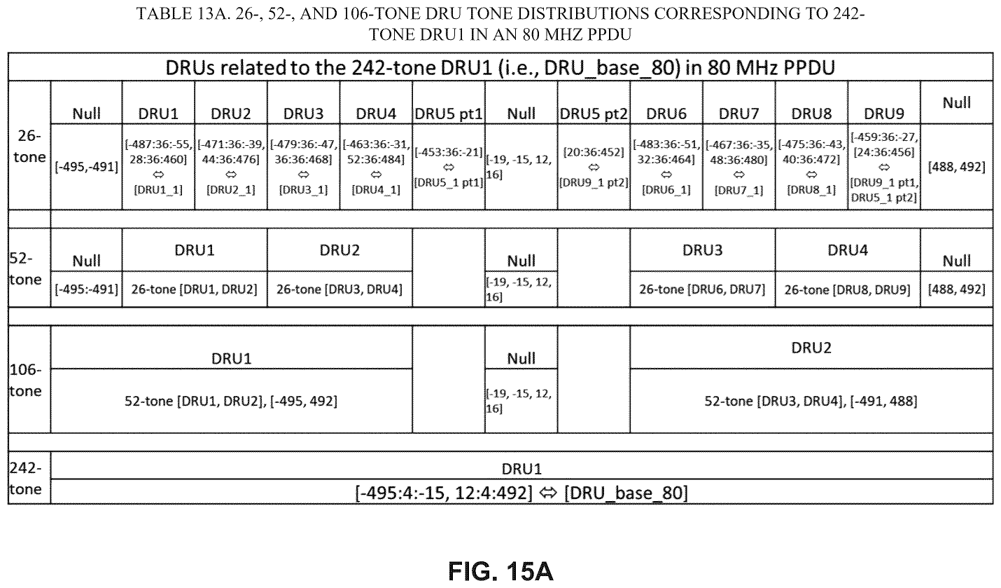

FIG. 14A illustrates Table 12A which shows the preliminary 26-tone DRU tone distributions corresponding to the 242-tone DRU1 in an 80 MHz PPDU obtained based on the first-level tone distribution on the universal data, pilot, and null subcarrier indices of the DRU indices per 20 MHz (shown in Table 6A of FIG. 8) and the second-level tone distribution of 242-tone DRUs in an 80 MHz PPDU (shown in Table 11 of FIG. 13) by replacing each index idx in the first-level tone distribution with the index (idx*4+ini) when idx≤120, or with the index (idx*4+ini+23) when idx>120 (where the index offset ini=−495 is the smallest index in the 242-tone DRU1 in an 80 MHz PPDU). The tone indices of the 242-tone DRU1 are also defined as [DRU_base_80].

Similar to Table 12A, FIG. 14B illustrates Table 12B which shows the preliminary 26-tone DRU tone distributions corresponding to the 242-tone DRU2 in an 80 MHz PPDU can be obtained by setting the index offset ini=−493.

Similar to Table 12A, FIG. 14C illustrates Table 12C which shows the preliminary 26-tone DRU tone distributions corresponding to the 242-tone DRU3 in an 80 MHz PPDU can be obtained by setting the index offset ini=−494.

Similar to Table 12A, FIG. 14D illustrates Table 12D which shows the preliminary 26-tone DRU tone distributions corresponding to the 242-tone DRU4 in an 80 MHz PPDU can be obtained by setting the index offset ini=−492.

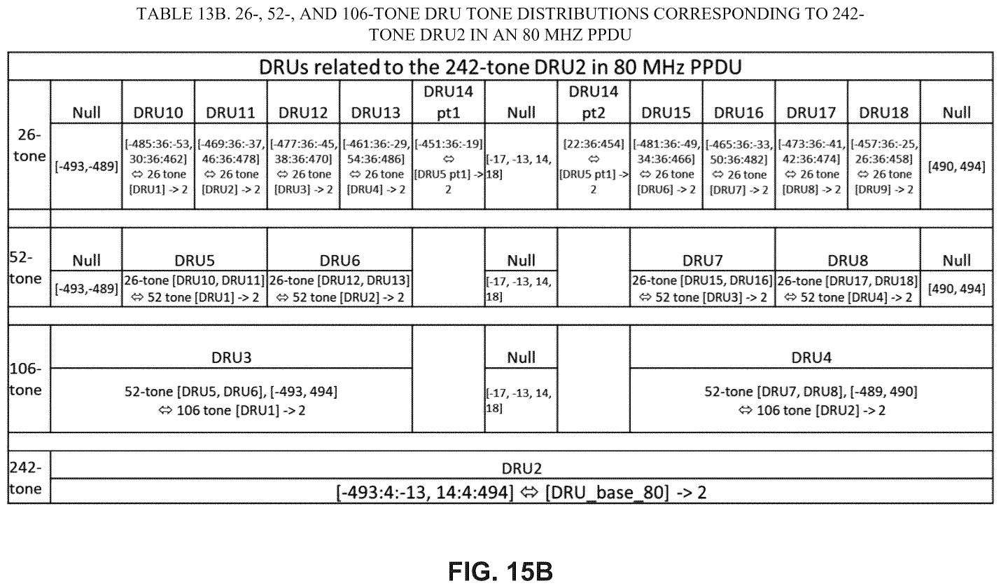

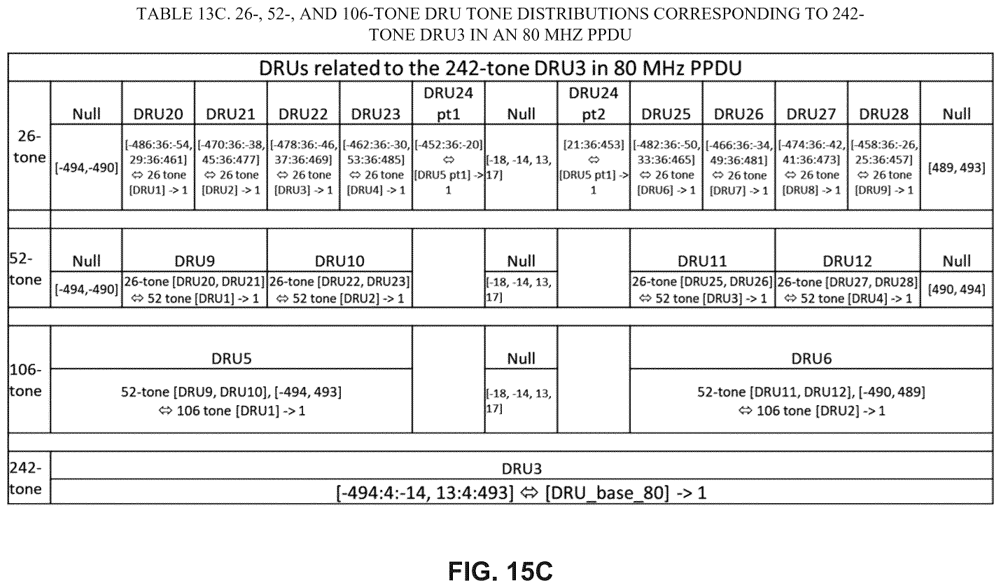

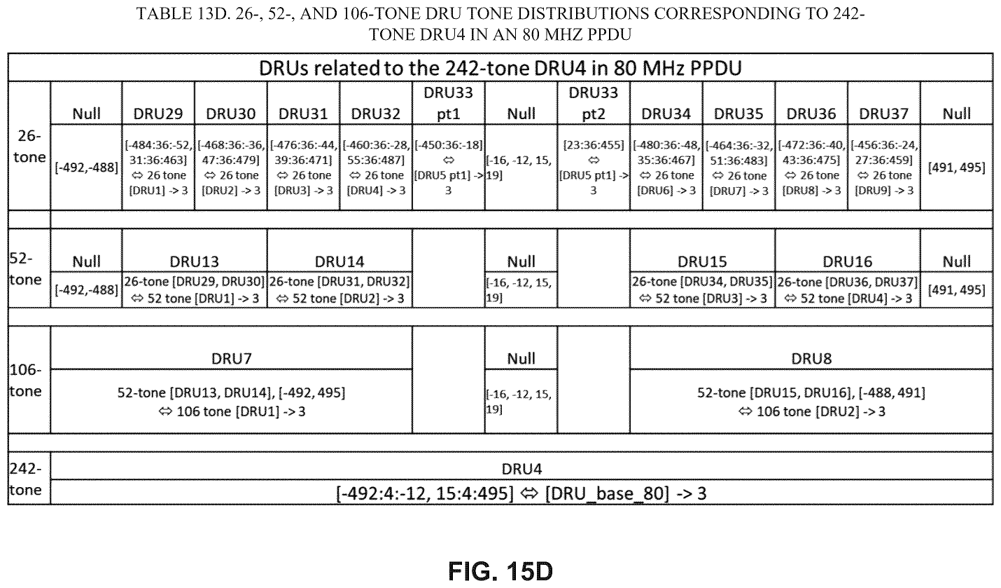

The preliminary 26-tone DRUs shown in Tables 12A to 12D of FIGS. 14A to 14D, which correspond to 242-tone DRU1 to DRU4 in an 80 MHz PPDU, may be rearranged in order before constructing 52-, and 106-tone DRU tone distributions in an 80 MHz PPDU. One example is illustrated in FIGS. 15A to 15D showing Tables 13A to 13D of 26-, 52- and 106-tone DRU tone distributions corresponding to 242-tone DRUs in an 80 MHz PPDU.

All DRU tone distributions shown in FIGS. 15A to 15D are obtained based on the definitions of RU tone locations defined in Table 4 “MODIFIED 242-tone RUs in an 80 MHz PPDU”, which are denoted as intermediate tone distributions. Table 3 shows the 242-tone indices in an 80 MHz PPDU in EHT (reproduced from Table 36-5, IEEE P802.11be/D5.1), in which in an 80 MHz PPDU, null tones are located in [−258:−254] and [254:258]. The following operations, which are applied to the data, pilot and null tones in the intermediate tone distributions, are needed to generate DRU tone indices to be allocated within 242-tone RU locations as specified in EHT (see Table 4).

In the following operations, an index in intermediate DRU tone distributions is denoted as “IDX_inter”. DRU tone distributions in an 80 MHz PPDU denoted as “IDX” can be obtained by the following remapping procedure (wherein “←j” or “<−j” represents an index being left-shifted (that is, decreasing the indices) by j positions, and “→j” or “->j” represents an index being right-shifted (that is, increasing the indices) by j positions):

```
if IDX_inter ≤ −254,
  IDX = IDX_inter ← 5
else if −254 < IDX_inter < 254,
  IDX = IDX_inter
else if IDX_inter ≥ 254
  IDX = IDX_inter → 5.
```

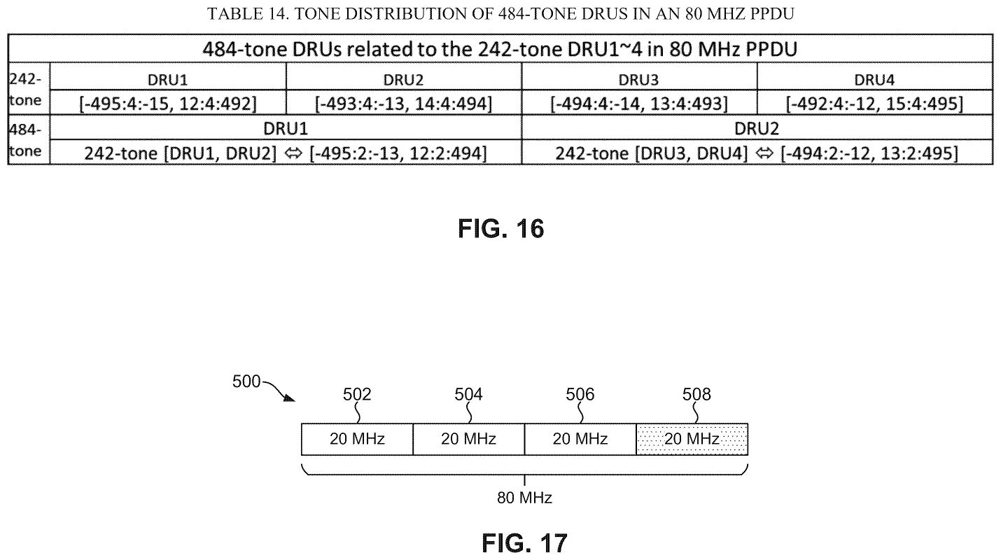

In some embodiments as shown in Table 14 of FIG. 16, intermediate tone distribution of 484-tone DRUs in an 80 MHz PPDU can be constructed from the intermediate 242-tone DRUs in an 80 MHz PPDU, which are defined in Table 11 of FIG. 13. 484-tone DRU tone distributions in an 80 MHz PPDU can be obtained with a further remapping procedure described above.

The tone plans disclosed here are suitable for adapting to the cases that one or more subchannels are unavailable for tone distribution across subchannels, wherein such one or more subchannels may be excluded using, for example, the so-called puncturing. For example, in some embodiments, a 20 MHz subchannel of an 80 MHz PPDU may be punctured in tone distribution (that is, the 20 MHz subchannel is unavailable for tone distribution across subchannels) such that the DRU BW equals to 60 MHz.

The punctured 20 MHz subchannel may be in various locations of the 80 MHz PPDU. For example, as shown in FIG. 17, the 80 MHz PPDU 500 comprises four (4) 20 MHz subchannels 502 to 508, wherein the last (highest) 20 MHz subchannel 508 may be punctured. Based on Table 4, the last (highest) 20 MHz subchannel 508 of the 80 MHz PPDU 500 is RU4 which includes the tone indices [254:495].

Table 15 shows the second-level tone distribution of 242-tone DRUs in an 80 MHz PPDU with DRU BW of 60 MHz with the last 20 MHz subchannel 508 punctured, which is constructed based on the modified tone plan of 242-tone RUs in an 80 MHz PPDU as shown in Table 4 where all data, pilot and DC tones are considered, and 23 DC tones are allocated within [−11:11].

TABLE 15
SECOND-LEVEL TONE DISTRIBUTION OF 242-TONE DRUS
IN AN 80 MHZ PPDU WITH DRU BW OF 60 MHZ WHEN
THE LAST 20 MHZ SUBCHANNEL IS PUNCTURED

| | DRU1 | DRU2 | DRU3 | |
|---|---|---|---|---|
| 242-tone | [−495:3:−12, | [−493:3:−13, | [−494:3:−14, | [254:495] |
| | 14:3:251] | 13:3:253] | 12:3:252] | |
| | ⇔[DRU1]⇔ | ⇔[DRU_base_60]→2 | ⇔[DRU_base_60]→ 1 | |
| | [DRU_base_60] | | | |

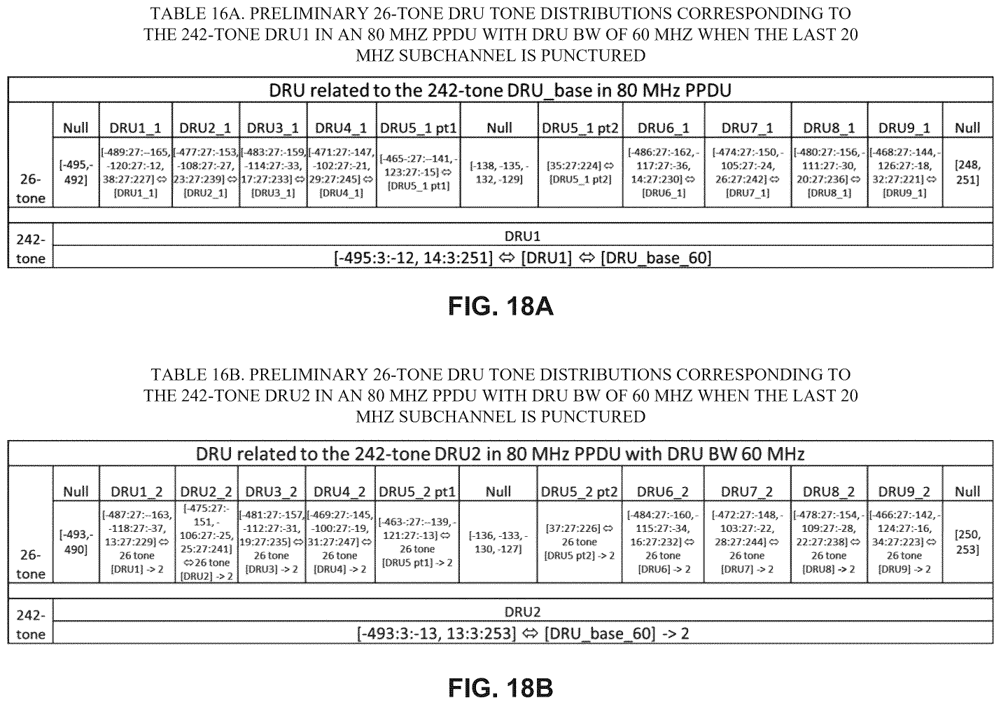

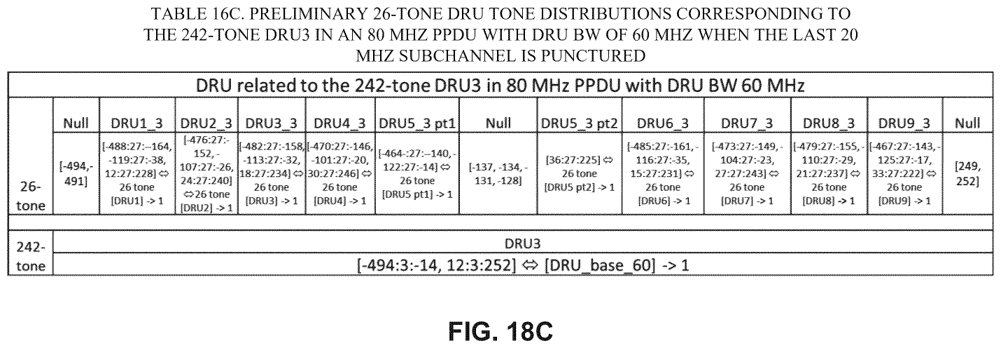

FIG. 18A illustrates Table 16A which shows the preliminary 26-tone DRU tone distributions corresponding to the 242-tone DRU1 in an 80 MHz PPDU 500 with DRU BW of 60 MHz when the last (highest) 20 MHz subchannel 508 is punctured, which are obtained based on the first-level tone distribution on the universal data, pilot, and null subcarrier indices of the DRU indices per 20 MHz (shown in Table 6A of FIG. 8) and the second-level tone distribution of 242-tone DRUs in an 80 MHz PPDU with DRU BW of 60 MHz (shown in Table 15) by replacing each index idx in the first-level tone distribution with the index (idx*3+ini) when idx≤161, or with the index (idx*3+ini+23) when idx>161 (where ini=−495 is the smallest index in the 242-tone DRU1 in an 80 MHz PPDU). The tone indices of the 242-tone DRU1 are defined as [DRU_base_60].

Similar to Table 16A, FIG. 18B illustrates Table 16B which shows the preliminary 26-tone DRU tone distributions corresponding to the 242-tone DRU2 in an 80 MHz PPDU with DRU BW of 60 MHz when the last (highest) 20 MHz subchannel 508 is punctured, which can be obtained by replacing each index idx in the first-level tone distribution with the index (idx*3+ini) when idx≤160, or with the index (idx*3+ini+23) when idx>160 (where ini=−493).

Similar to Table 16B, FIG. 18C illustrates Table 16C which shows the preliminary 26-tone DRU tone distributions corresponding to the 242-tone DRU3 in an 80 MHz PPDU with DRU BW of 60 MHz when the last (highest) 20 MHz subchannel 508 is punctured, which can be obtained by replacing each index idx in the first-level tone distribution with the index (idx*3+ini) when idx≤160, or with the index (idx*3+ini+23) when idx>160 (where ini=−494).

The preliminary 26-tone DRUs, which correspond to 242-tone DRU1 to DRU3 in an 80 MHz PPDU with DRU BW of 60 MHz when the last 20 MHz subchannel 508 is punctured, may be rearranged in order before constructing 52-, and 106-tone DRU tone distributions in an 80 MHz PPDU with DRU BW of 60 MHz when the last 20 MHz subchannel 508 is punctured.

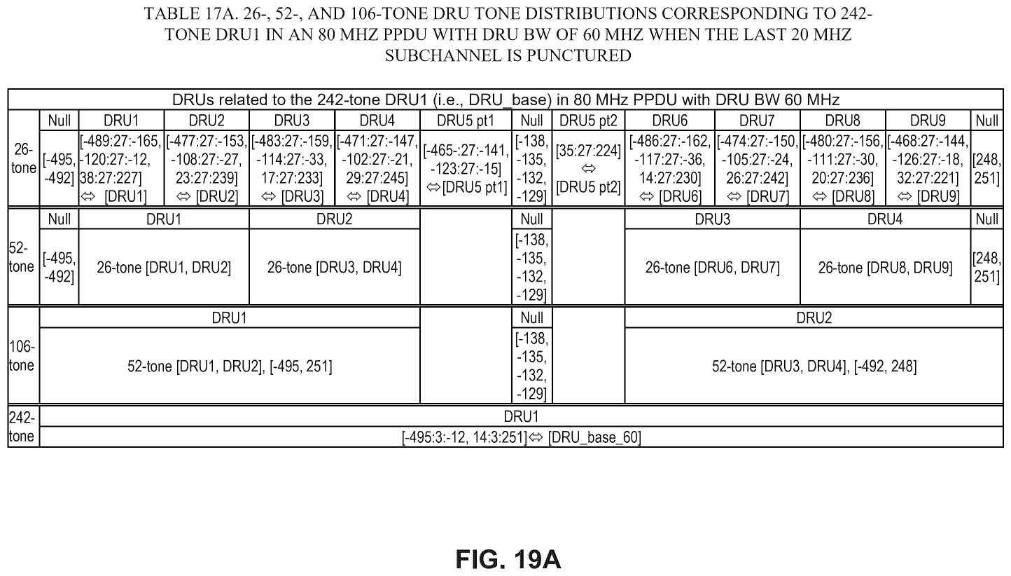

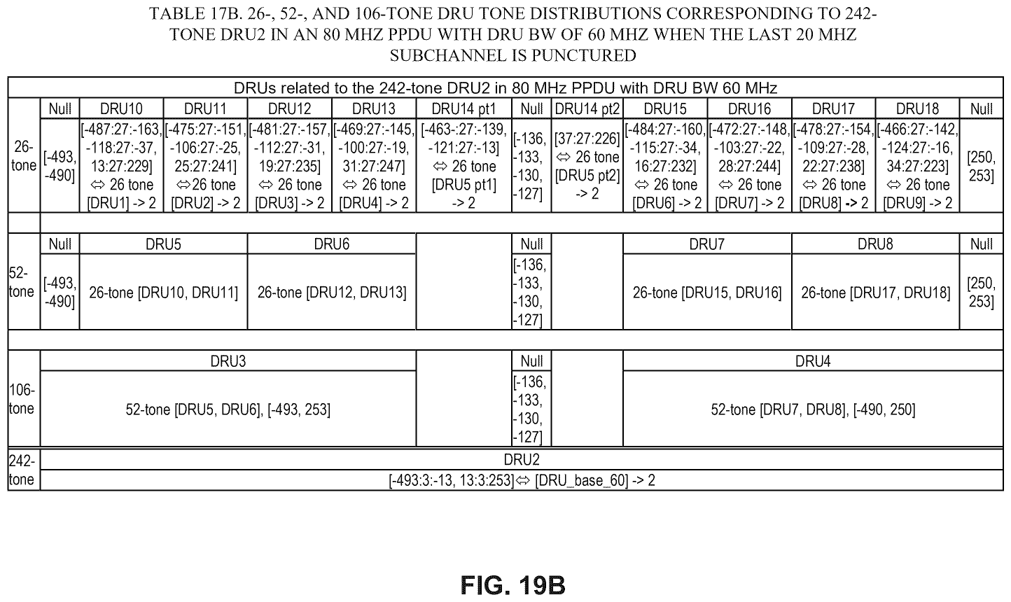

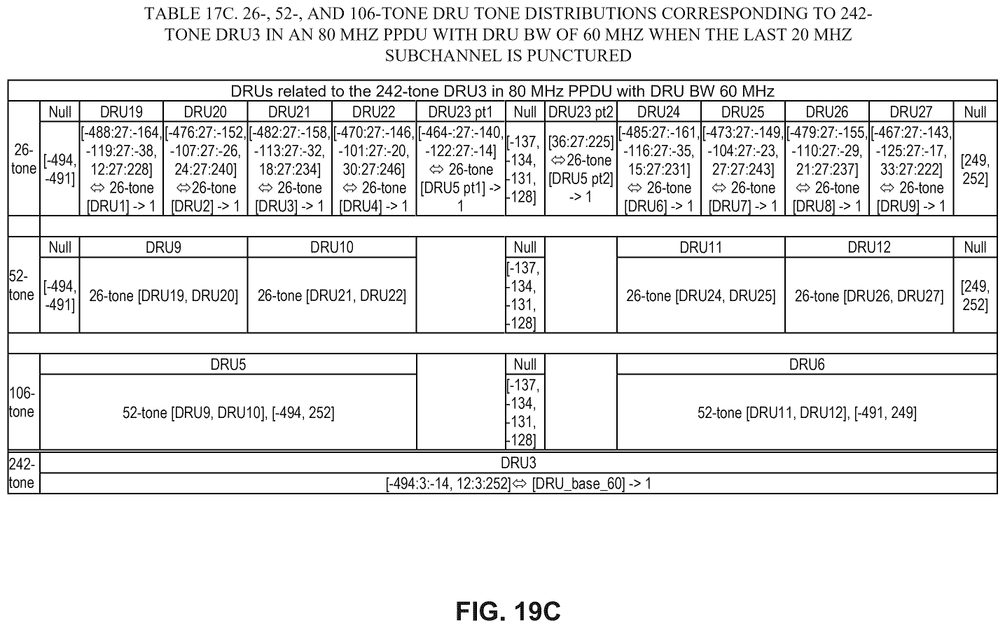

One example is illustrated in Tables 17A to 17C of FIGS. 19A to 19C, including:
26-tone DRU1: [−489:27:−165, −120:27:−12, 38:27:227];
26-tone DRU2: [−477:27:−153, −108:27:−27, 23:27:239];
26-tone DRU3: [−483:27:−159, −114:27:−33, 17:27:233];
26-tone DRU4: [−471:27:−147, −102:27:−21, 29:27:245];
26-tone DRU5: [−465−:27:−141, −123:27:−15, 35:27:224];
26-tone DRU6: [−486:27:−162, −117:27:−36, 14:27:230];
26-tone DRU7: [−474:27:−150, −105:27:−24, 26:27:242];
26-tone DRU8: [−480:27:−156, −111:27:−30, 20:27:236];
26-tone DRU9: [−468:27:−144, −126:27:−18, 32:27:221];
26-tone DRU10: [−487:27:−163, −118:27:−37, 13:27:229](that is, 26-tone [DRU1]→2);
26-tone DRU11: [−475:27:−151, −106:27:−25, 25:27:241](that is, 26-tone [DRU2]→2);
26-tone DRU12: [−481:27:−157, −112:27:−31, 19:27:235](that is, 26-tone [DRU3]→2);
26-tone DRU13: [−469:27:−145, −100:27:−19, 31:27:247](that is, 26-tone [DRU4]→2);
26-tone DRU14: [−463−:27:−139, −121:27:−13](that is, 26-tone [DRU5 pt1]→2) and [37:27:226](that is, 26 tone [DRU5 pt2]→2);
26-tone DRU15: [−484:27:−160, −115:27:−34, 16:27:232](that is, 26-tone [DRU6]→2);
26-tone DRU16: [−472:27:−148, −103:27:−22, 28:27:244](that is, 26-tone [DRU7]→2);
26-tone DRU17: [−478:27:−154, −109:27:−28, 22:27:238](that is, 26-tone [DRU8]→2);
26-tone DRU18: [−466:27:−142, −124:27:−16, 34:27:223](that is, 26-tone [DRU9]→2);
26-tone DRU19: [−488:27:−164, −119:27:−38, 12:27:228](that is, 26-tone [DRU1]→1);
26-tone DRU20: [−476:27:−152, −107:27:−26, 24:27:240](that is, 26-tone [DRU2]→1);
26-tone DRU21: [−482:27:−158, −113:27:−32, 18:27:234](that is, 26-tone [DRU3]→1);
26-tone DRU22: [−470:27:−146, −101:27:−20, 30:27:246](that is, 26-tone [DRU4]→1);
26-tone DRU23: [−464−:27:−140, −122:27:−14](that is, 26-tone [DRU5 pt1]→1) and [36:27:225](that is, 26-tone [DRU5 pt2]→1);
26-tone DRU24: [−485:27:−161, −116:27:−35, 15:27:231](that is, 26-tone [DRU6]→1);
26-tone DRU25: [−473:27:−149, −104:27:−23, 27:27:243](that is, 26-tone [DRU7]→1);
26-tone DRU26: [−479:27:−155, −110:27:−29, 21:27:237](that is, 26-tone [DRU8]→1);
26-tone DRU27: [−467:27:−143, −125:27:−17, 33:27:222](that is, 26-tone [DRU9]→1);
52-tone DRU1: 26-tone [DRU1, DRU2](that is, [−489:27:−165, −120:27:−12, 38:27:227, −477:27:−153, −108:27:−27, 23:27:239]);
52-tone DRU2: 26-tone [DRU3, DRU4](that is, [−483:27:−159, −114:27:−33, 17:27:233, −471:27:−147, −102:27:−21, 29:27:245]);
52-tone DRU3: 26-tone [DRU6, DRU7](that is, [−486:27:−162, −117:27:−36, 14:27:230, −474:27:−150, −105:27:−24, 26:27:242]);
52-tone DRU4: 26-tone [DRU8, DRU9](that is, [−480:27:−156, −111:27:−30, 20:27:236, −468:27:−144, −126:27:−18, 32:27:221]);
52-tone DRU5: 26-tone [DRU10, DRU11](that is, [−487:27:−163, −118:27:−37, 13:27:229, −475:27:−151, −106:27:−25, 25:27:241]);
52-tone DRU6: 26-tone [DRU12, DRU13](that is, [−481:27:−157, −112:27:−31, 19:27:235, −469:27:−145, −100:27:−19, 31:27:247]);
52-tone DRU7: 26-tone [DRU15, DRU16](that is, [−484:27:−160, −115:27:−34, 16:27:232, −472:27:−148, −103:27:−22, 28:27:244]);
52-tone DRU8: 26-tone [DRU17, DRU18](that is, [−478:27:−154, −109:27:−28, 22:27:238, −466:27:−142, −124:27:−16, 34:27:223]);
52-tone DRU9: 26-tone [DRU19, DRU20](that is, [−488:27:−164, −119:27:−38, 12:27:228, −476:27:−152, −107:27:−26, 24:27:240]);
52-tone DRU10: 26-tone [DRU21, DRU22](that is, [−482:27:−158, −113:27:−32, 18:27:234, −470:27:−146, −101:27:−20, 30:27:246]);
52-tone DRU11: 26-tone [DRU24, DRU25](that is, [−485:27:−161, −116:27:−35, 15:27:231, −473:27:−149, −104:27:−23, 27:27:243]);
52-tone DRU12: 26-tone [DRU26, DRU27](that is, [−479:27:−155, −110:27:−29, 21:27:237, −467:27:−143, −125:27:−17, 33:27:222]);
106-tone DRU1: 52-tone [DRU1, DRU2], [−495, 251](that is, [−495, −489:27:−165, −120:27:−12, 38:27:227, −477:27:−153, −108:27:−27, 23:27:239, −483:27:−159, −114:27:−33, 17:27:233, −471:27:−147, −102:27:−21, 29:27:245, 251]);
106-tone DRU2: 52-tone [DRU3, DRU4], [−492, 248](that is, [−492, −486:27:−162, −117:27:−36, 14:27:230, −474:27:−150, −105:27:−24, 26:27:242, −480:27:−156, −111:27:−30, 20:27:236, −468:27:−144, −126:27:−18, 32:27:221, 248]);
106-tone DRU3: 52-tone [DRU5, DRU6], [−493, 253](that is, [−493, −487:27:−163, −118:27:−37, 13:27:229, −475:27:−151, −106:27:−25, 25:27:241, −481:27:−157, −112:27:−31, 19:27:235, −469:27:−145, −100:27:−19, 31:27:247, 253]);
106-tone DRU4: 52-tone [DRU7, DRU8], [−490, 250](that is, [−490, −484:27:−160, −115:27:−34, 16:27:232, −472:27:−148, −103:27:−22, 28:27:244, −478:27:−154, −109:27:−28, 22:27:238, −466:27:−142, −124:27:−16, 34:27:223, 250]);
106-tone DRU5: 52-tone [DRU9, DRU10], [−494, 252](that is, [−494, −488:27:−164, −119:27:−38, 12:27:228, −476:27:−152, −107:27:−26, 24:27:240, −482:27:−158, −113:27:−32, 18:27:234, −470:27:−146, −101:27:−20, 30:27:246, 252]);
106-tone DRU6: 52-tone [DRU11, DRU12], [−491, 249](that is, [−491, −485:27:−161, −116:27:−35, 15:27:231, −473:27:−149, −104:27:−23, 27:27:243, −479:27:−155, −110:27:−29, 21:27:237, −467:27:−143, −125:27:−17, 33:27:222, 249]);
242-tone DRU1: [−495:3:−12, 14:3:251](that is, [DRU_base_60]);
242-tone DRU2: [−493:3:−13, 13:3:253](that is, [DRU_base_60]→2); and
242-tone DRU3: [−494:3:−14, 12:3:252](that is, [DRU_base_60]→1).

All DRU tone distributions shown in Tables 17A to 17C of FIGS. 19A to 19C are obtained based on the definitions of RU tone locations defined in Table 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in Tables 17A to 17C of FIGS. 19A to 19C is denoted as “IDX inter”. DRU tone distributions with indices denoted as “IDX” in an 80 MHz PPDU can be obtained by the following remapping procedure:

```
if IDX_inter ≤ −254,
  IDX = IDX_inter ← 5
else if −254 < IDX_inter < 254,
  IDX = IDX_inter
```

Thus, the tone plan for an 80 MHZ PPDU with DRU BW of 60 MHz when the last 20 MHz subchannel is punctured includes the following 26-tone DRUs:
26-tone DRU1: [−494:27:−278, −246:27:−165, −120:27:−12, 38:27:227];
26-tone DRU2: [−482:27:−266, −234:27:−153, −108:27:−27, 23:27:239];
26-tone DRU3: [−488:27:−272, −240:27:−159, −114:27:−33, 17:27:233];
26-tone DRU4: [−476:27:−260, −228:27:−147, −102:27:−21, 29:27:245];
26-tone DRU5: [−470:27:−281, −249:27:−141, −123:27:−15, 35:27:224];
26-tone DRU6: [−491:27:−275, −243:27:−162, −117:27:−36, 14:27:230];
26-tone DRU7: [−479:27:−263, −231:27:−150, −105:27:−24, 26:27:242];
26-tone DRU8: [−485:27:−269, −237:27:−156, −111:27:−30, 20:27:236];
26-tone DRU9: [−473:27:−284, −252:27:−144, −126:27:−18, 32:27:221];
26-tone DRU10: [−492:27:−276, −244:27:−163, −118:27:−37, 13:27:229];
26-tone DRU11: [−480:27:−264, −232:27:−151, −106:27:−25, 25:27:241];
26-tone DRU12: [−486:27:−270, −238:27:−157, −112:27:−31, 19:27:235];
26-tone DRU13: [−474:27:−285, −253:27:−145, −100:27:−19, 31:27:247];
26-tone DRU14: [−468:27:−279, −247:27:−139, −121:27:−13, 37:27:226];
26-tone DRU15: [−489:27:−273, −241:27:−160, −115:27:−34, 16:27:232];
26-tone DRU16: [−477:27:−261, −229:27:−148, −103:27:−22, 28:27:244];
26-tone DRU17: [−483:27:−267, −235:27:−154, −109:27:−28, 22:27:238];
26-tone DRU18: [−471:27:−282, −250:27:−142, −124:27:−16, 34:27:223];
26-tone DRU20: [−493:27:−277, −245:27:−164, −119:27:−38, 12:27:228];
26-tone DRU21: [−481:27:−265, −233:27:−152, −107:27:−26, 24:27:240];
26-tone DRU22: [−487:27:−271, −239:27:−158, −113:27:−32, 18:27:234];
26-tone DRU23: [−475:27:−259, −227:27:−146, −101:27:−20, 30:27:246];
26-tone DRU24: [−469:27:−280, −248:27:−140, −122:27:−14, 36:27:225];
26-tone DRU25: [−490:27:−274, −242:27:−161, −116:27:−35, 15:27:231];
26-tone DRU26: [−478:27:−262, −230:27:−149, −104:27:−23, 27:27:243];
26-tone DRU27: [−484:27:−268, −236:27:−155, −110:27:−29, 21:27:237];
26-tone DRU28: [−472:27:−283, −251:27:−143, −125:27:−17, 33:27:222];

The tone plan for an 80 MHZ PPDU with DRU BW of 60 MHz when the last 20 MHz subchannel includes the following 52-tone DRUs:
52-tone DRU1: [−494:27:−278, −246:27:−165, −120:27:−12, 38:27:227, −482:27:−266, −234:27:−153, −108:27:−27, 23:27:239];
52-tone DRU2: [−488:27:−272, −240:27:−159, −114:27:−33, 17:27:233, −476:27:−260, −228:27:−147, −102:27:−21, 29:27:245];
52-tone DRU3: [−491:27:−275, −243:27:−162, −117:27:−36, 14:27:230, −479:27:−263, −231:27:−150, −105:27:−24, 26:27:242];
52-tone DRU4: [−485:27:−269, −237:27:−156, −111:27:−30, 20:27:236, −473:27:−284, −252:27:−144, −126:27:−18, 32:27:221];
52-tone DRU5: [−492:27:−276, −244:27:−163, −118:27:−37, 13:27:229, −480:27:−264, −232:27:−151, −106:27:−25, 25:27:241];
52-tone DRU6: [−486:27:−270, −238:27:−157, −112:27:−31, 19:27:235, −474:27:−285, −253:27:−145, −100:27:−19, 31:27:247];
52-tone DRU7: [−489:27:−273, −241:27:−160, −115:27:−34, 16:27:232, −477:27:−261, −229:27:−148, −103:27:−22, 28:27:244];
52-tone DRU8: [−483:27:−267, −235:27:−154, −109:27:−28, 22:27:238, −471:27:−282, −250:27:−142, −124:27:−16, 34:27:223];
52-tone DRU9: [−493:27:−277, −245:27:−164, −119:27:−38, 12:27:228, −481:27:−265, −233:27:−152, −107:27:−26, 24:27:240];
52-tone DRU10: [−487:27:−271, −239:27:−158, −113:27:−32, 18:27:234, −475:27:−259, −227:27:−146, −101:27:−20, 30:27:246];
52-tone DRU11: [−490:27:−274, −242:27:−161, −116:27:−35, 15:27:231, −478:27:−262, −230:27:−149, −104:27:−23, 27:27:243];
52-tone DRU12: [−484:27:−268, −236:27:−155, −110:27:−29, 21:27:237, −472:27:−283, −251:27:−143, −125:27:−17, 33:27:222];

The tone plan for an 80 MHZ PPDU with DRU BW of 60 MHz when the last 20 MHz subchannel includes the following 106-tone DRUs:
106-tone DRU1: [−500, −494:27:−278, −246:27:−165, −120:27:−12, 38:27:227, −482:27:−266, −234:27:−153, −108:27:−27, 23:27:239, −488:27:−272, −240:27:−159, −114:27:−33, 17:27:233, −476:27:−260, −228:27:−147, −102:27:−21, 29:27:245, 251];
106-tone DRU2: [−497, −491:27:−275, −243:27:−162, −117:27:−36, 14:27:230, −479:27:−263, −231:27:−150, −105:27:−24, 26:27:242, −485:27:−269, −237:27:−156, −111:27:−30, 20:27:236, −473:27:−284, −252:27:−144, −126:27:−18, 32:27:221, 248];
106-tone DRU3: [−498, −492:27:−276, −244:27:−163, −118:27:−37, 13:27:229, −480:27:−264, −232:27:−151, −106:27:−25, 25:27:241, −486:27:−270, −238:27:−157, −112:27:−31, 19:27:235, −474:27:−285, −253:27:−145, −100:27:−19, 31:27:247, 253];
106-tone DRU4: [−495, −489:27:−273, −241:27:−160, −115:27:−34, 16:27:232, −477:27:−261, −229:27:−148, −103:27:−22, 28:27:244, −483:27:−267, −235:27:−154, −109:27:−28, 22:27:238, −471:27:−282, −250:27:−142, −124:27:−16, 34:27:223, 250];
106-tone DRU5: [−499, −493:27:−277, −245:27:−164, −119:27:−38, 12:27:228, −481:27:−265, −233:27:−152, −107:27:−26, 24:27:240, −487:27:−271, −239:27:−158, −113:27:−32, 18:27:234, −475:27:−259, −227:27:−146, −101:27:−20, 30:27:246, 252];
106-tone DRU6: [−496, −490:27:−274, −242:27:−161, −116:27:−35, 15:27:231, −478:27:−262, −230:27:−149, −104:27:−23, 27:27:243, −484:27:−268, −236:27:−155, −110:27:−29, 21:27:237, −472:27:−283, −251:27:−143, −125:27:−17, 33:27:222, 249];

The tone plan for an 80 MHZ PPDU with DRU BW of 60 MHz when the last 20 MHz subchannel includes the following 242-tone DRUs:
242-tone DRU1: [−500:3:−260, −252:3:−12, 14:3:251];
242-tone DRU2: [−498:3:−261, −253:3:−13, 13:3:253];
242-tone DRU3: [−499:3:−259, −251:3:−14, 12:3:252].

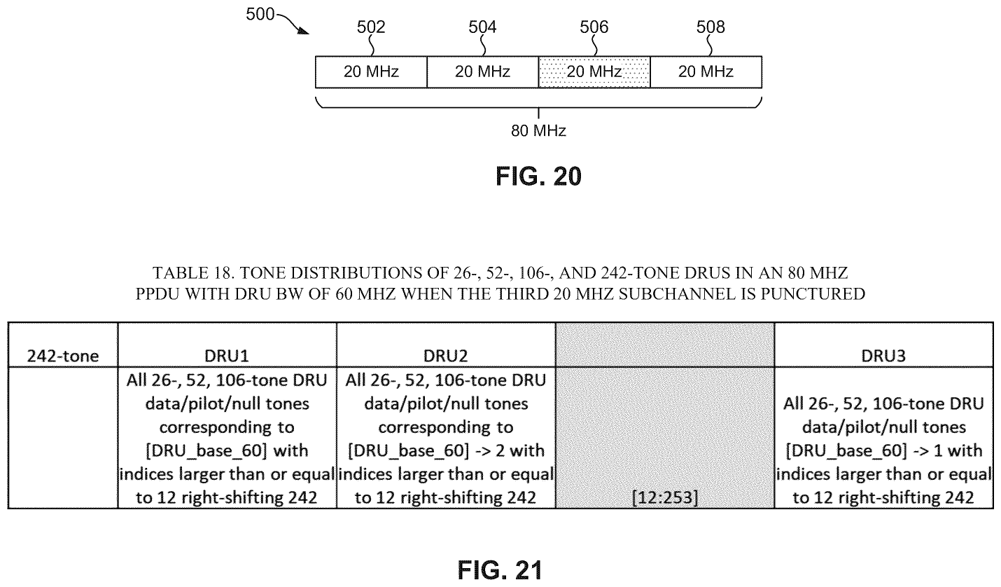

As another example, as shown in FIG. 20, the third (second highest) 20 MHz subchannel 506 of the 80 MHz PPDU 500 may be punctured. Based on Table 4, the third (second highest) 20 MHz subchannel 506 of the 80 MHz PPDU 500 is RU3 which includes the tone indices [12:253].

Tone distributions of 26-, 52-, 106- and 242-tone DRUs in this example can be obtained from those for the case of an 80 MHz PPDU with DRU BW of 60 MHz when the third (second highest) 20 MHz subchannel 506 is punctured with tone shifting as shown in Table 18 of FIG. 21, that is:
the 242-tone DRU1 comprising all 26-, 52-, 106-tone DRU data/pilot/null tones corresponding to [DRU_base_60] with indices larger than or equal to 12 right-shifting by 242 positions;
the 242-tone DRU2 comprising all 26-, 52-, 106-tone DRU data/pilot/null tones corresponding to [DRU_base_60]→2 with indices larger than or equal to 12 right-shifting by 242 positions;
[12:253]being punctured;
the 242-tone DRU3 comprising all 26-, 52, 106-tone DRU data/pilot/null tones [DRU_base_60]→1 with indices larger than or equal to 12 right-shifting by 242 positions.

All DRU tone distributions after group shifting as shown in FIG. 21 are obtained based on the definitions of RU tone locations defined in Table 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in FIG. 21 is denoted as “IDX_inter”. DRU tone distributions denoted as “IDX” in an 80 MHz PPDU can be obtained by the following remapping procedure:

```
if IDX_inter ≤ −254,
  IDX = IDX_inter ← 5
else if −254 < IDX_inter ≤ −12 ,
  IDX = IDX_inter
else if IDX_inter ≥ 254
  IDX = IDX_inter → 5
```

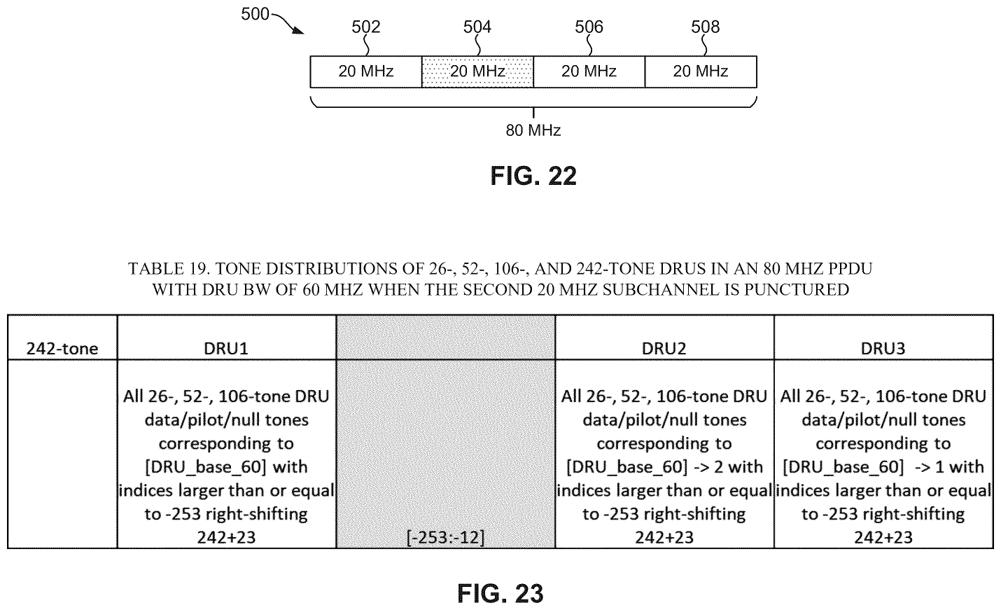

As yet another example, as shown in FIG. 22, the second lowest 20 MHz subchannel 504 of the 80 MHz PPDU 500 may be punctured. Based on Table 4, the second 20 MHz subchannel 504 of the 80 MHz PPDU 500 is RU2 which includes the tone indices [−253:−12].

Tone distributions of 26-, 52-, 106- and 242-tone DRUs in this example can be obtained from those for the case of an 80 MHz PPDU with DRU BW of 60 MHz when the second lowest 20 MHz subchannel is punctured with tone shifting as shown in Table 19 of FIG. 23, that is:
the 242-tone DRU1 comprising all 26-, 52-, 106-tone DRU data/pilot/null tones corresponding to [DRU_base_60] with indices larger than or equal to −253 right-shifting by 265 (=242+23) positions;
[−253:−12]being punctured;
the 242-tone DRU2 comprising all 26-, 52-, 106-tone DRU data/pilot/null tones corresponding to [DRU_base_60]→2 with indices larger than or equal to −253 right-shifting by 265 (=242+23) positions;
the 242-tone DRU3 comprising all 26-, 52-, 106-tone DRU data/pilot/null tones corresponding to [DRU_base_60]→1 with indices larger than or equal to −253 right-shifting by 265 (=242+23) positions.

All DRU tone distributions after group shifting as shown in FIG. 23 are obtained based on the definitions of RU tone locations defined in TABLE 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in FIG. 23 is denoted as “IDX_inter”. DRU tone distributions denoted as “IDX” in an 80 MHz PPDU can be obtained by the following remapping procedure:

```
if IDX_inter ≤ −254,
  IDX = IDX_inter ← 5
else if 12 ≤ IDX_inter < −254,
  IDX = IDX_inter
else if IDX_inter ≥ 254
  IDX = IDX_inter → 5
```

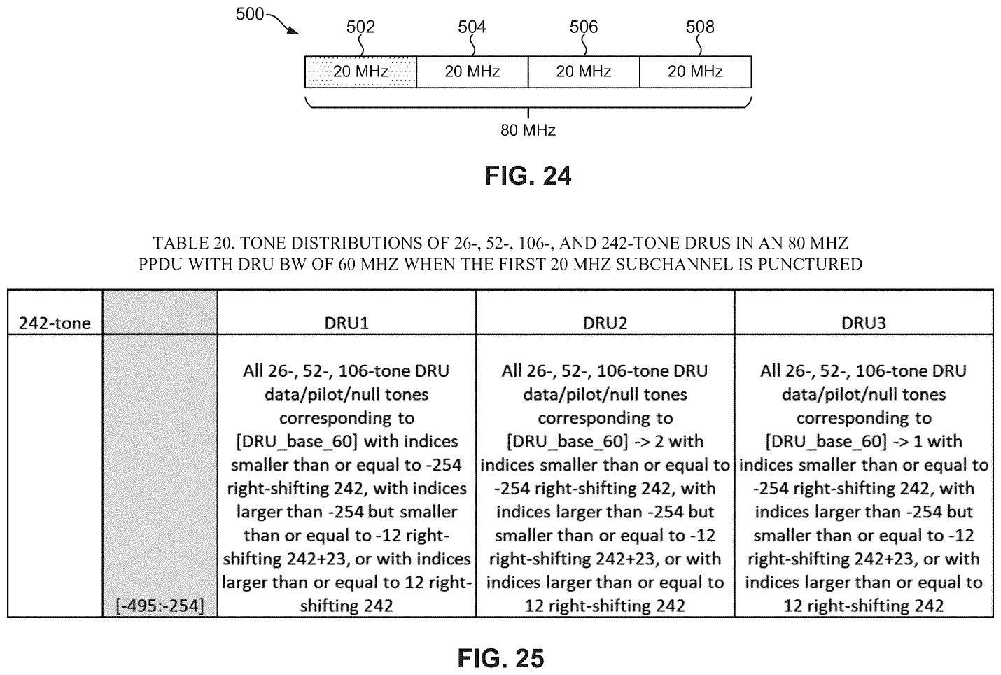

As still another example, as shown in FIG. 24, the first (lowest) 20 MHz subchannel 502 of the 80 MHz PPDU 500 may be punctured. Based on Table 4, the first (lowest) 20 MHz subchannel 504 of the 80 MHz PPDU 500 is RU2 which includes the tone indices [−495:−254].

Tone distributions of 26-, 52-, 106- and 242-tone DRUs in this example can be obtained from those for the case of an 80 MHz PPDU with DRU BW of 60 MHz when the first (lowest) 20 MHz subchannel is punctured with tone shifting as shown in Table 20 of FIG. 25, that is:
[−495:−254]being punctured;
the 242-tone DRU1 comprising all 26-, 52-, 106-tone DRU data/pilot/null tones corresponding to [DRU_base_60] with indices smaller than or equal to −254 right-shifting by 242 positions, with indices larger than −254 but smaller than or equal to −12 right-shifting by 265 (=242+23) positions, or with indices larger than or equal to 12 right-shifting by 242 positions;
the 242-tone DRU2 comprising all 26-, 52-, 106-tone DRU data/pilot/null tones corresponding to [DRU_base_60]→2 with indices smaller than or equal to −254 right-shifting by 242 positions, with indices larger than −254 but smaller than or equal to −12 right-shifting by 265 (=242+23) positions, or with indices larger than or equal to 12 right-shifting by 242 positions;
the 242-tone DRU3 comprising all 26-, 52-, 106-tone DRU data/pilot/null tones corresponding to [DRU_base_60]→1 with indices smaller than or equal to −254 right-shifting by 242 positions, with indices larger than −254 but smaller than or equal to −12 right-shifting by 265 (=242+23) positions, or with indices larger than or equal to 12 right-shifting by 242 positions.

All DRU tone distributions after group shifting as shown in FIG. 25 are obtained based on the definitions of RU tone locations defined in Table 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in FIG. 25 is denoted as “IDX inter”. DRU tone distributions denoted as “IDX” in an 80 MHz PPDU can be obtained by the following remapping procedure:

```
if −254 < IDX_inter < 254,
  IDX = IDX_inter
else if IDX_inter ≥ 254
  IDX = IDX_inter → 5
```

In some embodiments, a 40 MHz subchannel of an 80 MHz PPDU may be punctured in tone distribution (that is, the 40 MHz subchannel is unavailable for tone distribution) such that the DRU BW equals to 40 MHz.

A DRU BW equal to 40 MHz in an 80 MHz PPDU implies that there are two punctured 20 MHz subchannel in tone distribution, that is, two 20 MHz subchannels are unavailable for tone distribution across the 20 MHz boundary. Some examples are described below.

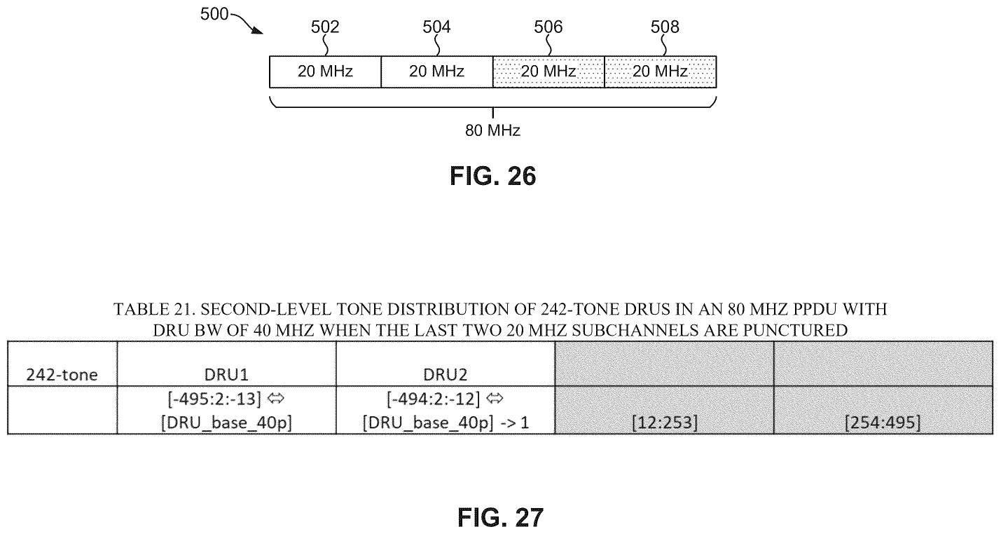

In an example shown in FIG. 26, the last (highest) two 20 MHz subchannels 506 and 508 of an 80 MHz PPDU 500 are punctured. Based on Table 4, the last (highest) two 20 MHz subchannels 506 and 508 include tone indices [12:253] and [254:495]which are unavailable for tone distribution for DRUs that distribute tones over other 20 MHz subchannels.

FIG. 27 illustrates Table 21 which shows the second-level tone distribution of 242-tone DRUs in an 80 MHz PPDU with DRU BW of 40 MHz when the last two 20 MHz subchannels 506 and 508 are punctured, which is constructed based on the modified tone plan of 242-tone RUs in an 80 MHz PPDU as shown in Table 4 where 23 DC tones are allocated within [−11:11].

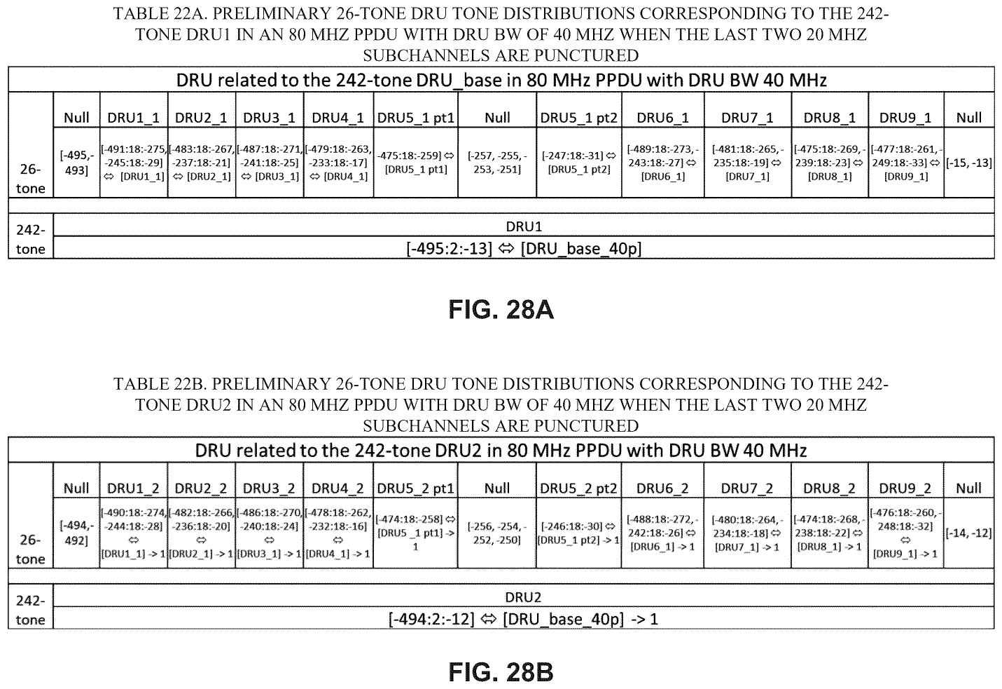

FIG. 28A illustrates Table 22A which shows the preliminary 26-tone DRU tone distributions corresponding to the 242-tone DRU1 in an 80 MHz PPDU with DRU BW of 40 MHz when the last two 20 MHz subchannels are punctured, which are obtained based on the first-level tone distribution on the universal data, pilot, and null subcarrier indices of the DRU indices per 20 MHz (shown in Table 6A of FIG. 8) and the second-level tone distribution of 242-tone DRUs in an 80 MHz PPDU with DRU BW of 40 MHz (shown in Table 21 of FIG. 27) by replacing each index idx in the first-level tone distribution with the index (idx*2+ini) (where ini=−495 is the smallest index in the 242-tone DRU1 in an 80 MHz PPDU). The tone indices of the 242-tone DRU1 are defined as [DRU base 40p].

Similar to Table 22A, as shown in Table 22B of FIG. 28B, the preliminary 26-tone DRU tone distributions corresponding to the 242-tone DRU2 in an 80 MHz PPDU with DRU BW of 40 MHz when the last two 20 MHz subchannels are punctured can be obtained by setting the index offset ini=−494.

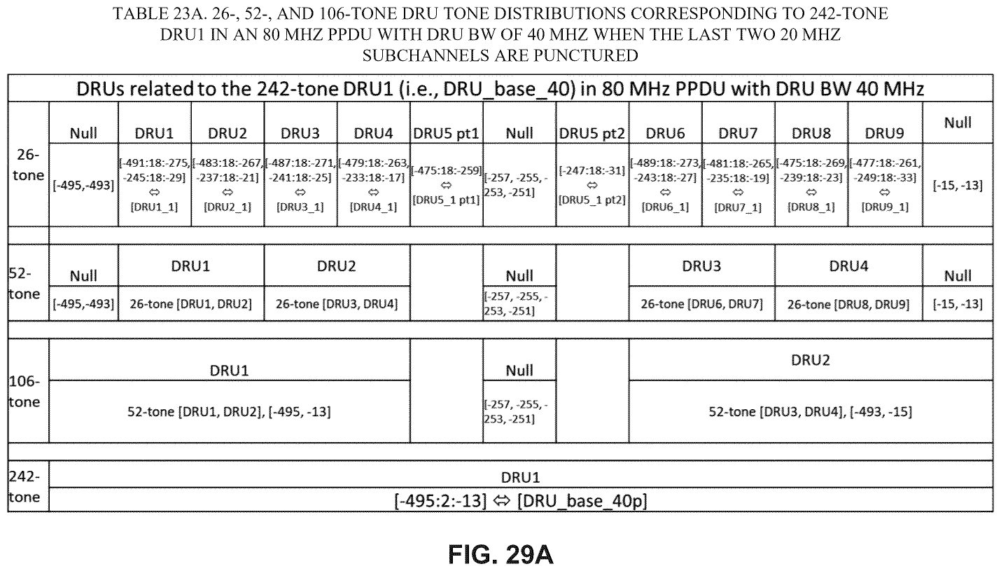

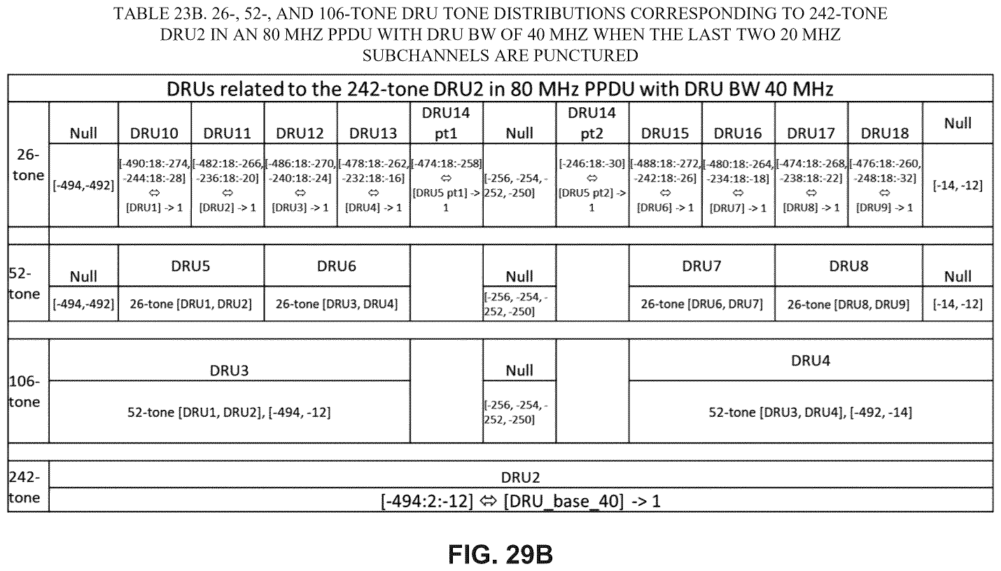

The preliminary 26-tone DRUs shown in Tables 22A and 22B, which correspond to 242-tone DRU1 and DRU2 in an 80 MHz PPDU with DRU BW of 40 MHz when the last two 20 MHz subchannels are punctured, may be rearranged in order before constructing 52-, and 106-tone DRU tone distributions in an 80 MHz PPDU with DRU BW of 40 MHz when the last two 20 MHz subchannels are punctured. One example is illustrated in Tables 23A and 23B of FIGS. 29A and 29B showing 26-, 52- and 106-tone DRU tone distributions corresponding to 242-tone DRUs in an 80 MHz PPDU with DRU BW of 40 MHz when the last two 20 MHz subchannels 506 and 508 are punctured.

All DRU tone distributions after group shifting as shown in Tables 23A and 23B of FIGS. 29A and 29B are obtained based on the definitions of RU tone locations defined in Table 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in FIGS. 29A and 29B is denoted as “IDX inter”. DRU tone distributions denoted as “IDX” in an 80 MHz PPDU can be obtained by the following remapping procedure:

```
if IDX_inter ≤ −254,
    IDX = IDX_inter ← 5
  else if −254 < IDX_inter < −11,
    IDX = IDX_inter
```

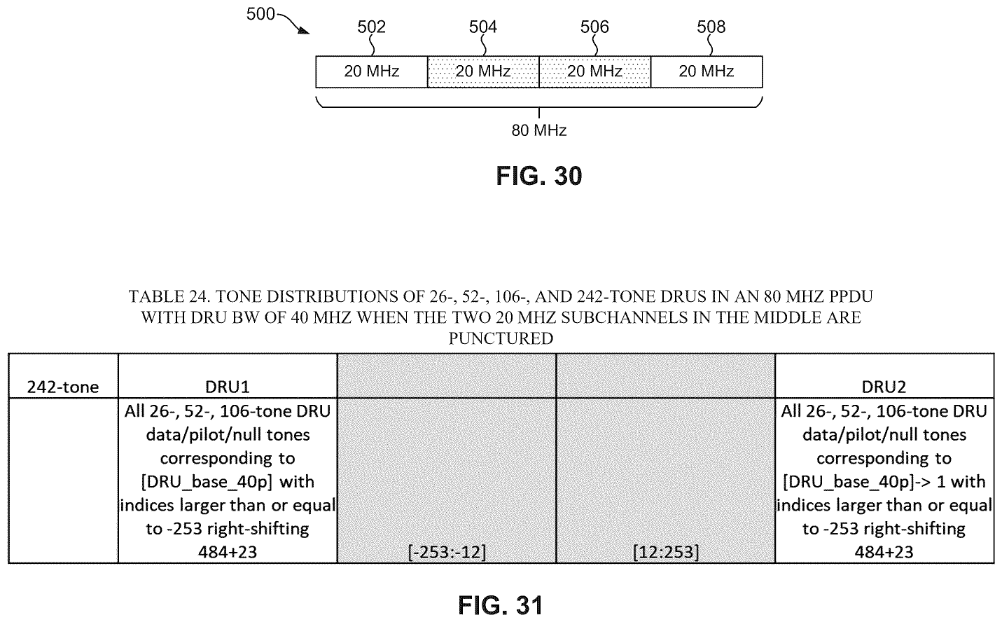

In an example shown in FIG. 30, the two 20 MHz subchannels 504 and 506 in the middle of an 80 MHz PPDU 500 are punctured. Based on Table 4, the two 20 MHz subchannels 504 and 506 in the middle include tone indices [−253:−12] and [12:253]which are unavailable for tone distribution for DRUs that distribute tones over other 20 MHz subchannels.

Tone distributions of 26-, 52-, 106- and 242-tone DRUs in this example can be obtained from those for the case of an 80 MHz PPDU with DRU BW of 40 MHz when the last (highest) two 20 MHz subchannels are punctured with tone shifting as shown in Table 24 of FIG. 31, that is:
the 242-tone DRU1 comprising all 26-, 52-, 106-tone DRU data/pilot/null tones corresponding to [DRU_base_40p] with indices larger than or equal to −253 right-shifting by 507 (=484+23) positions;
[−253:−12] and [12:253]being punctured;
the 242-tone DRU2 comprising all 26-, 52-, 106-tone DRU data/pilot/null tones corresponding to [DRU_base_40p]->1 with indices larger than or equal to −253 right-shifting by 507 (=484+23) positions.

All DRU tone distributions after group shifting as shown in FIG. 31 are obtained based on the definitions of RU tone locations defined in Table 4 “MODIFIED 242-tone RUs in an 80 MHz PPDU”, which are denoted as intermediate tone distributions. Remapping is needed to generate DRU tone indices to be allocated within 242-tone RU locations as specified in EHT.

In the following operations, an index in intermediate DRU tone distributions in FIG. 11 is denoted as “IDX_inter”. DRU tone distributions denoted as “IDX” in an 80 MHz PPDU can be obtained by the following remapping procedure:

```
if IDX_inter ≤ −254,
    IDX = IDX_inter ← 5
  else if IDX_inter ≥ 254,
    IDX = IDX_inter → 5
```

In some embodiments, the above-described methods and examples may be used for PPDU's with other bandwidths. For example, in IEEE 802.11be, 80 MHz frequency subblock is defined for 160 and 320 MHz PPDU. In some embodiments, the above-described methods and examples for DRU tone plans in an 80 MHz PPDU may be used to specify the DRU tone plans in each of one or more 80 MHz subblocks in a 160 MHz PPDU or a 320 MHz PPDU.

In some embodiment, the method illustrated above may be used for forming or otherwise generating other DRU plans.

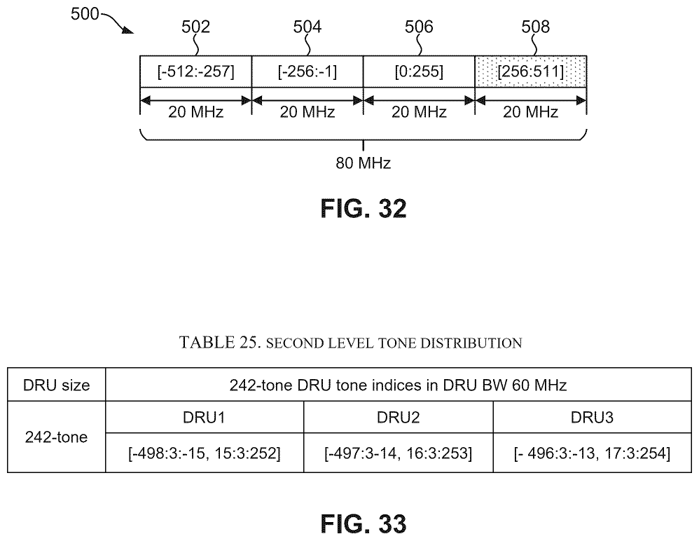

FIG. 32 is a schematic diagram showing an example of an 80 MHz PPDU 500 having four (4) 20 MHz subchannels 502 to 508. The tone indices of the lowest subchannel 502 are from −512 to −257, the tone indices of the second-lowest subchannel 504 are from −256 to −1, the tone indices of the second-highest subchannel 506 are from 0 to 255, and the tone indices of the highest subchannel 508 are from 256 to 511. In this example, the last (highest) 20 MHz subchannel 508 is punctured.

FIG. 33 shows TABLE 25, the second-level tone distribution for the three usable subchannels 502 to 506 of the 80 MHz PPDU 500 shown in FIG. 32, which includes the following 242-tone DRUs:
242-tone DRU1: [−498:3:−15, 15:3:252];
242-tone DRU2: [−497:3−14, 16:3:253]; and
242-tone DRU3: [−496:3:−13, 17:3:254].

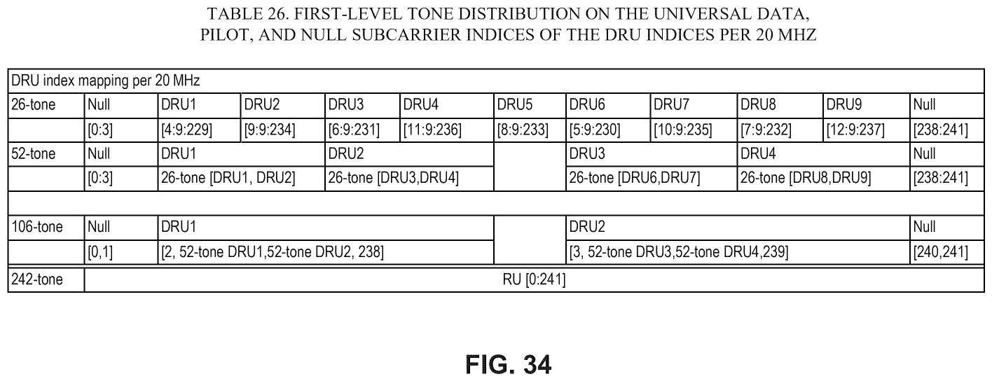

The tone plan may be obtained from the first-level tone distribution on the universal data, pilot, and null subcarrier indices of the DRU indices per 20 MHz as listed in TABLE 26 of FIG. 34. As shown, the 26-tone plan includes the following null tones and 26-tone DRUs:
Null tones: [0:3];
26-tone DRU1: [4:9:229];
26-tone DRU2: [9:9:234];
26-tone DRU3: [6:9:231];
26-tone DRU4: [11:9:236];
26-tone DRU5: [8:9:233];
26-tone DRU6: [5:9:230];
26-tone DRU7: [10:9:235];
26-tone DRU8: [7:9:232];
26-tone DRU9: [12:9:237];
Null tones: [238:241].

The 52-tone plan includes the following null tones and 52-tone DRUs:
Null tones: [0:3];
52-tone DRU1: 26-tone [DRU1, DRU2];
52-tone DRU2: 26-tone [DRU3,DRU4];
52-tone DRU3: 26-tone [DRU6,DRU7];
52-tone DRU4: 26-tone [DRU8,DRU9]; and
Null tones: [238:241].

The 106-tone plan includes the following null tones and 106-tone DRUs:
Null tones: [0:1];
106-tone DRU1: [2, 52-tone DRU1, 52-tone DRU2, 238];
106-tone DRU2: [3, 52-tone DRU3, 52-tone DRU4, 239]; and
Null tones: [240:241].

The 242-tone plan includes an RU of [0:241].

The tone plan for the 80 MHz PPDU 500 with the last subchannel 508 punctured (shown in FIG. 32) may be obtained from the first-level tone distribution shown in TABLE 26 of FIG. 34 by the following index modification (where “idx” represents the tone index of the first-level tone distribution shown in TABLE 26 of FIG. 34 and “IDX” represents the tone index of the tone plan for the 80 MHz PPDU 500 with the last subchannel 508 punctured):

```
  if idx * 3 + ini ≤ −13
  IDX = idx * 3 + ini
else
  IDX = idx * 3 + ini + 27
```

That is, by replacing each index idx in the first-level tone distribution with the index (idx*3+ini) when idx*3+ini≤−13, or with the index (idx*3+ini+27) when idx*3+ini>−13, wherein ini=−498 for the 242-tone DRU1, ini=−497 for the 242-tone DRU2, and ini=−496 for the 242-tone DRU3.

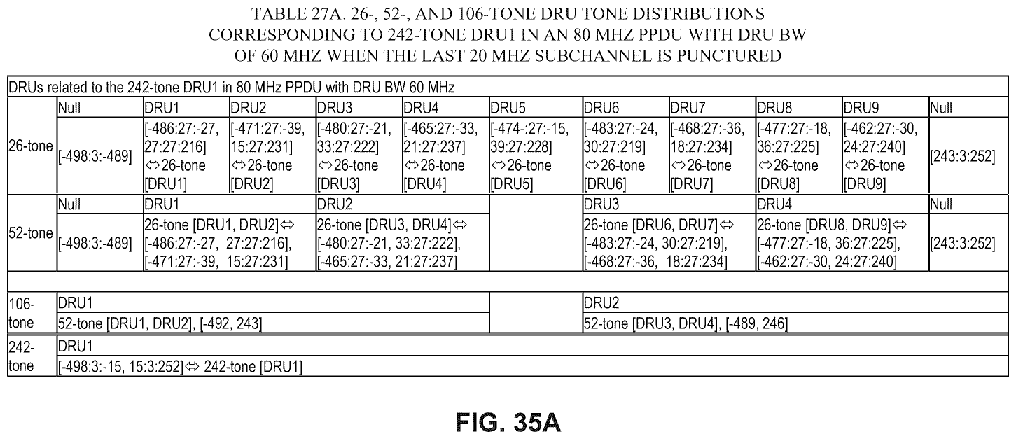

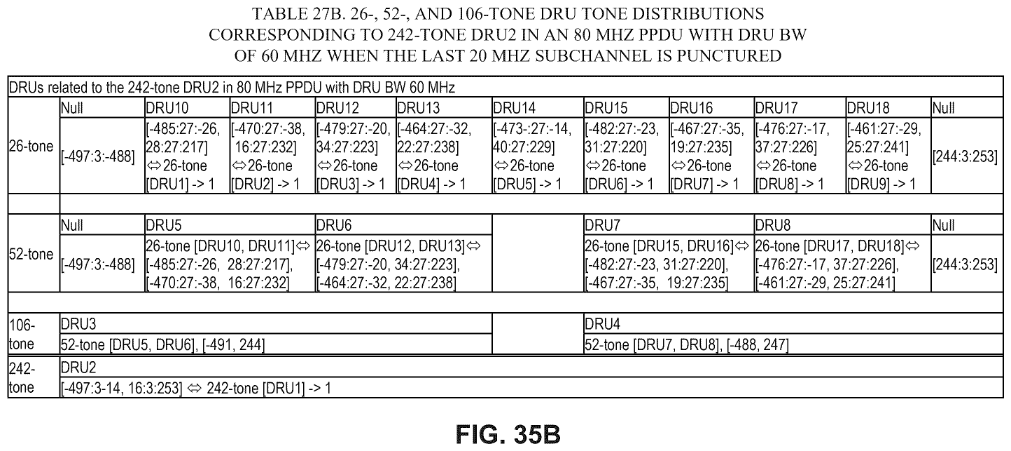

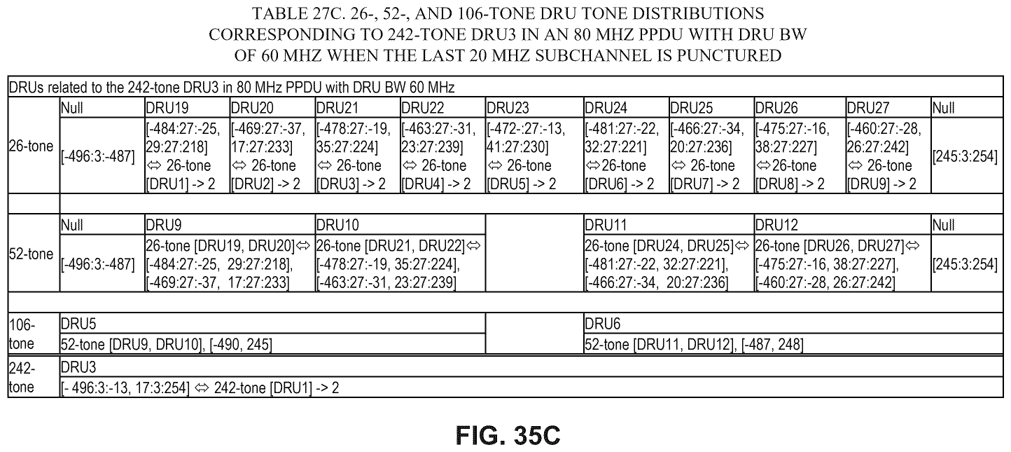

The tone plan for the 242-tone DRU1, 242-tone DRU2, and 242-tone DRU3 and the corresponding 26-tone, 52-tone and 106-tone DRUs of the 80 MHz PPDU 500 with the last subchannel 508 punctured (shown in FIG. 32) are shown in TABLE 27A of FIG. 35A, TABLE 27B of FIG. 35B, and TABLE 27C of FIG. 35C, respectively. In other words, the tone plan for the 80 MHz PPDU 500 with the last subchannel 508 punctured (shown in FIG. 32) includes the following 26-tone DRUs:
26-tone DRU1: [−486:27:−27, 27:27:216];
26-tone DRU2: [−471:27:−39, 15:27:231];
26-tone DRU3: [−480:27:−21, 33:27:222];
26-tone DRU4: [−465:27:−33, 21:27:237];
26-tone DRU5: [−474−:27:−15, 39:27:228];
26-tone DRU6: [−483:27:−24, 30:27:219];
26-tone DRU7: [−468:27:−36, 18:27:234];
26-tone DRU8: [−477:27:−18, 36:27:225];
26-tone DRU9: [−462:27:−30, 24:27:240];
26-tone DRU10: [−485:27:−26, 28:27:217];
26-tone DRU11: [−470:27:−38, 16:27:232];
26-tone DRU12: [−479:27:−20, 34:27:223];
26-tone DRU13: [−464:27:−32, 22:27:238];
26-tone DRU14: [−473−:27:−14, 40:27:229];
26-tone DRU15: [−482:27:−23, 31:27:220];
26-tone DRU16: [−467:27:−35, 19:27:235];
26-tone DRU17: [−476:27:−17, 37:27:226];
26-tone DRU18: [−461:27:−29, 25:27:241];
26-tone DRU19: [−484:27:−25, 29:27:218];
26-tone DRU20: [−469:27:−37, 17:27:233];
26-tone DRU21: [−478:27:−19, 35:27:224];
26-tone DRU22: [−463:27:−31, 23:27:239];
26-tone DRU23: [−472−:27:−13, 41:27:230];
26-tone DRU24: [−481:27:−22, 32:27:221];
26-tone DRU25: [−466:27:−34, 20:27:236];
26-tone DRU26: [−475:27:−16, 38:27:227]; and
26-tone DRU27: [−460:27:−28, 26:27:242].

The tone plan for the 80 MHz PPDU 500 with the last subchannel 508 punctured (shown in FIG. 32) includes the following 52-tone DRUs:
52-tone DRU1: [−486:27:−27, 27:27:216, −471:27:−39, 15:27:231](that is, [26-tone DRU1, 26-tone DRU2]);
52-tone DRU2: [−480:27:−21, 33:27:222, −465:27:−33, 21:27:237](that is, [26-tone DRU3, 26-tone DRU4]);
52-tone DRU3: [−483:27:−24, 30:27:219, −468:27:−36, 18:27:234](that is, [26-tone DRU6, 26-tone DRU7]);
52-tone DRU4: [−477:27:−18, 36:27:225, −462:27:−30, 24:27:240](that is, [26-tone DRU8, 26-tone DRU9]);
52-tone DRU5: [−485:27:−26, 28:27:217, −470:27:−38, 16:27:232](that is, [26-tone DRU10, 26-tone DRU11]);
52-tone DRU6: [−479:27:−20, 34:27:223, −464:27:−32, 22:27:238](that is, [26-tone DRU12, 26-tone DRU13]);
52-tone DRU7: [−482:27:−23, 31:27:220, −467:27:−35, 19:27:235](that is, [26-tone DRU15, 26-tone DRU16]);
52-tone DRU8: [−476:27:−17, 37:27:226, −461:27:−29, 25:27:241](that is, [26-tone DRU17, 26-tone DRU18]);
52-tone DRU9: [−484:27:−25, 29:27:218, −469:27:−37, 17:27:233](that is, [26-tone DRU19, 26-tone DRU20]);
52-tone DRU10: [−478:27:−19, 35:27:224, −463:27:−31, 23:27:239](that is, [26-tone DRU21, 26-tone DRU22]);
52-tone DRU11: [−481:27:−22, 32:27:221, −466:27:−34, 20:27:236](that is, [26-tone DRU24, 26-tone DRU25]); and
52-tone DRU12: [−475:27:−16, 38:27:227, −460:27:−28, 26:27:242](that is, [26-tone DRU26, 26-tone DRU27]).

The tone plan for the 80 MHz PPDU 500 with the last subchannel 508 punctured (shown in FIG. 32) includes the following 106-tone DRUs:
106-tone DRU1: [−486:27:−27, 27:27:216, −471:27:−39, 15:27:231, −480:27:−21, 33:27:222, −465:27:−33, 21:27:237, −492, 243](that is, [52-tone DRU1, 52-tone DRU2, −492, 243]);
106-tone DRU2: [−483:27:−24, 30:27:219, −468:27:−36, 18:27:234, −477:27:−18, 36:27:225, −462:27:−30, 24:27:240, −489, 246](that is, [52-tone DRU3, 52-tone DRU4, −489, 246]);
106-tone DRU3: [−485:27:−26, 28:27:217, −470:27:−38, 16:27:232, −479:27:−20, 34:27:223, −464:27:−32, 22:27:238, −491, 244](that is, [52-tone DRU5, 52-tone DRU6, −491, 244]);
106-tone DRU4: [−482:27:−23, 31:27:220, −467:27:−35, 19:27:235, −476:27:−17, 37:27:226, −461:27:−29, 25:27:241, −488, 247](that is, [52-tone DRU7, 52-tone DRU8, −488, 247]);
106-tone DRU5: [−484:27:−25, 29:27:218, −469:27:−37, 17:27:233, −478:27:−19, 35:27:224, −463:27:−31, 23:27:239, −490, 245](that is, [52-tone DRU8, 52-tone DRU10, −490, 245]); and
106-tone DRU6: [−481:27:−22, 32:27:221, −466:27:−34, 20:27:236, −475:27:−16, 38:27:227, −460:27:−28, 26:27:242, −487, 248](that is, [52-tone DRU11, 52-tone DRU12, −487, 248]).

The tone plan for the 80 MHz PPDU 500 with the last subchannel 508 punctured (shown in FIG. 32) includes the following 242-tone DRUs:
242-tone DRU1: [−498:3:−15, 15:3:252];
242-tone DRU2: [−497:3−14, 16:3:253]; and
242-tone DRU3: [−496:3:−13, 17:3:254].

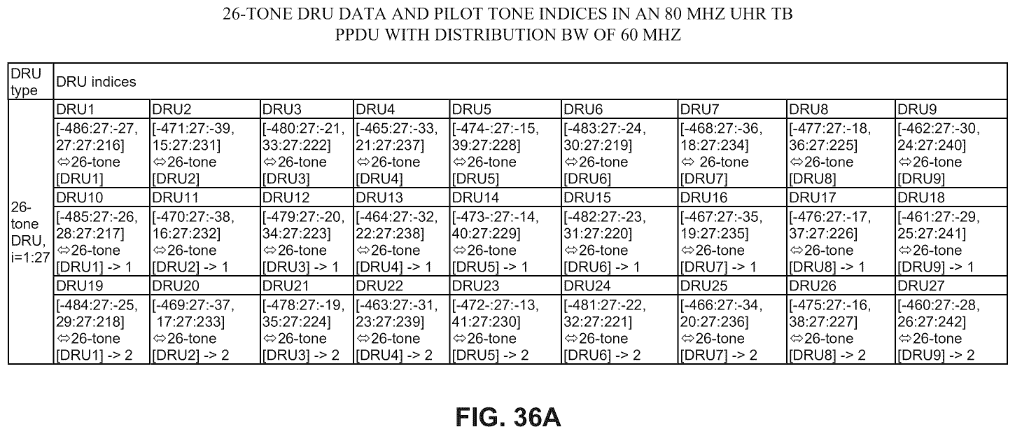

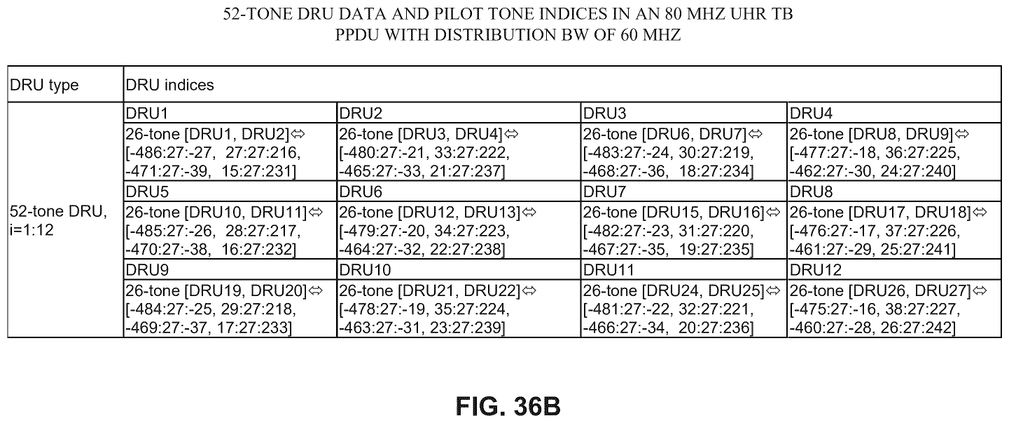

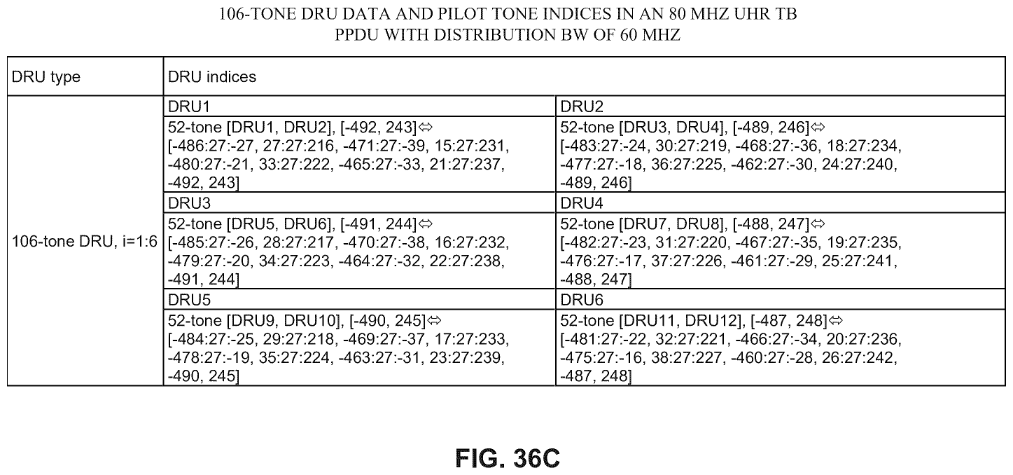

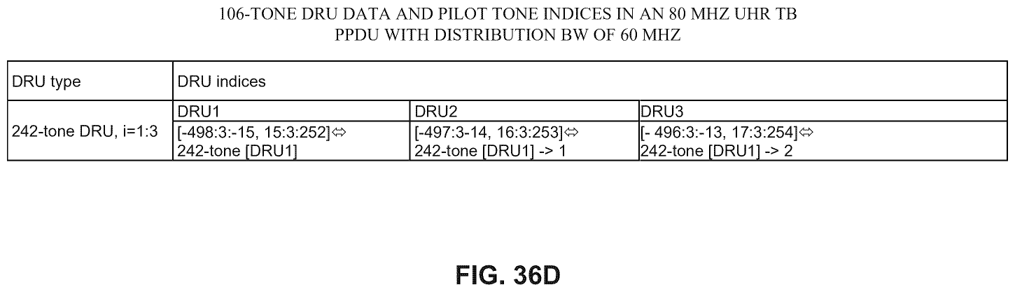

FIGS. 36A to 36D shows the summary of the 26-, 52-, 106, and 242-tone DRU tone distributions in an 80 MHz PPDU with DRU BW 60 MHz (the highest 20 MHz subchannel is punctured).

Those skilled in the art will appreciate that, in various embodiments, the communication system 100 and/or a device 102, 104 thereof may implement the entirety or a portion of any one of above-described tone plans, or the entirety or a portion of any combination of above-described tone plans.

In some embodiments, a DRU plan determined as described above may be stored in both an AP 102 and an STA 112 such as storing in one non-transitory computer-readable storage devices or media thereof as a DRU table. Then, the AP 102 and STA 112 may find a DRU for data and/or pilot transmission therebetween by looking up the DRU table.

In some embodiments, instead of using a DRU table, the AP 102 and STA 112 may calculate the DRU plan as described above, and select a DRU from the calculated DRU plan for data and/or pilot transmission therebetween by looking up the DRU table.

Herein, various DRU tone plans in PPDU BWs and related methods for tone distribution are disclosed. The DRU tone plans disclosed herein may be used without subchannel puncturing, and are also suitable for subchannel puncturing if needed. The DRU-design methods disclosed herein are systematic methods using a dual-level tone distribution methodology for designing tone distributions in DRU with different tone sizes, DRU BWs, and subchannel puncturing patterns, so as to distribute subcarriers (that is, tones) in multiple RUs, each of which is for a specific STA, in an OFDMA PPDU. The DRU tone plans and methods disclosed herein provide simple implementation on tone distributions in DRU for various cases of different tone sizes, DRU BWs, and subchannel puncturing patterns.

With the DRU tone plans and methods disclosed herein, individual tones (including data tones and pilot tones) in an RRU for a STA 112 using OFDMA are substantially distributed over a DRU BW as large as possible so as to maximize the per-tone power based on the regulatory body's PSD limitation rules. By using the DRU tone plans and methods disclosed herein, the DRUs in some embodiments have the same set of RU sizes as corresponding RRUs.

The DRU tone plans and methods disclosed herein are flexible for different RU sizes and different PPDU BWs, and provide simplified practical implementation with simple signaling for tone distribution. For example, the DRU tone plans and methods disclosed herein provide at least the following advantages:
unified design for DRU tone distribution with or without subchannel puncturing; and
simple implementation while maximizing tone separation in DRU.

The DRU tone plans and methods disclosed herein and the resulting DRU plans may be related to the standardization of next generation of WLAN systems such as IEEE 802.11bn (WI-FI® 8).

The DRU tone plans and methods disclosed herein may be used in WI-Fl APs and STAs with operating capability in both sub-7 GHz and millimeter bands.

### C. Acronym Key

| | Acronym/Abbre- |
|---|---|
| Full Name | viation/Initialism |
| Access point | AP |
| Bandwidth | BW |
| Distributed Resource Unit | DRU |
| Equivalent isotropic radiated power | EIRP |
| Local Area Network | LAN |
| Medium Access Control Layer | MAC |
| Orthogonal frequency division | OFDMA |
| multiplexing access | |
| Power spectral density | PSD |
| Physical layer protocol data unit | PPDU |
| Regular Resource Unit | RRU |
| Resource Unit | RU |
| Stations | STAs |
| Ultra−high reliability | UHR |
| Wireless LAN | WLAN |

Those skilled in the art will appreciate that, in some embodiments, the methods disclosed herein may be implemented as one or more circuits of a module, a device, an apparatus, a system, and/or the like. In some embodiments, the methods disclosed herein may be implemented as computer-executable instructions stored in one or more non-transitory computer-readable storage devices such that, the instructions, when executed, may cause one or more circuits to perform the methods disclosed herein.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
transmitting or receiving a signal using a resource unit (RU) in an orthogonal frequency-division multiple access (OFDMA) physical layer protocol data unit (PPDU);
wherein the PPDU has a bandwidth of 60 MHz partitioned to three 20 MHz subchannels, or a bandwidth of 80 MHz partitioned to four 20 MHz subchannels with a highest 20 MHz subchannels temporarily unusable;
wherein the RU is selected from a first tone plan, and the first tone plan is one of a second tone plan or a third tone plan;
wherein the second tone plan comprises:
a plurality of 26-tone RUs,
a plurality of 52-tone RUs,
a plurality of 106-tone RUs,
a plurality of 242-tone RUs, or
a combination thereof;
wherein the plurality of 26-tone RUs of the second tone plan comprise:
[−494:27:−278, −246:27:−165, −120:27:−12, 38:27:227],
[−482:27:−266, −234:27:−153, −108:27:−27, 23:27:239],
[−488:27:−272, −240:27:−159, −114:27:−33, 17:27:233],
[−476:27:−260, −228:27:−147, −102:27:−21, 29:27:245],
[−470:27:−281, −249:27:−141, −123:27:−15, 35:27:224],
[−491:27:−275, −243:27:−162, −117:27:−36, 14:27:230],
[−479:27:−263, −231:27:−150, −105:27:−24, 26:27:242],
[−485:27:−269, −237:27:−156, −111:27:−30, 20:27:236],
[−473:27:−284, −252:27:−144, −126:27:−18, 32:27:221],
[−492:27:−276, −244:27:−163, −118:27:−37, 13:27:229],
[−480:27:−264, −232:27:−151, −106:27:−25, 25:27:241],
[−486:27:−270, −238:27:−157, −112:27:−31, 19:27:235],
[−474:27:−285, −253:27:−145, −100:27:−19, 31:27:247],
[−468:27:−279, −247:27:−139, −121:27:−13, 37:27:226],
[−489:27:−273, −241:27:−160, −115:27:−34, 16:27:232],
[−477:27:−261, −229:27:−148, −103:27:−22, 28:27:244],
[−483:27:−267, −235:27:−154, −109:27:−28, 22:27:238],
[−471:27:−282, −250:27:−142, −124:27:−16, 34:27:223],
[−493:27:−277, −245:27:−164, −119:27:−38, 12:27:228],
[−481:27:−265, −233:27:−152, −107:27:−26, 24:27:240],
[−487:27:−271, −239:27:−158, −113:27:−32, 18:27:234],
[−475:27:−259, −227:27:−146, −101:27:−20, 30:27:246],
[−469:27:−280, −248:27:−140, −122:27:−14, 36:27:225],
[−490:27:−274, −242:27:−161, −116:27:−35, 15:27:231],
[−478:27:−262, −230:27:−149, −104:27:−23, 27:27:243],
[−484:27:−268, −236:27:−155, −110:27:−29, 21:27:237], and
[−472:27:−283, −251:27:−143, −125:27:−17, 33:27:222],
the plurality of 52-tone RUs of the second tone plan comprise:
[−494:27:−278, −246:27:−165, −120:27:−12, 38:27:227, −482:27:−266, −234:27:−153, −108:27:−27, 23:27:239],
[−488:27:−272, −240:27:−159, −114:27:−33, 17:27:233, −476:27:−260, −228:27:−147, −102:27:−21, 29:27:245],
[−491:27:−275, −243:27:−162, −117:27:−36, 14:27:230, −479:27:−263, −231:27:−150, −105:27:−24, 26:27:242],
[−485:27:−269, −237:27:−156, −111:27:−30, 20:27:236, −473:27:−284, −252:27:−144, −126:27:−18, 32:27:221],
[−492:27:−276, −244:27:−163, −118:27:−37, 13:27:229, −480:27:−264, −232:27:−151, −106:27:−25, 25:27:241],
[−486:27:−270, −238:27:−157, −112:27:−31, 19:27:235, −474:27:−285, −253:27:−145, −100:27:−19, 31:27:247],
[−489:27:−273, −241:27:−160, −115:27:−34, 16:27:232, −477:27:−261, −229:27:−148, −103:27:−22, 28:27:244],
[−483:27:−267, −235:27:−154, −109:27:−28, 22:27:238, −471:27:−282, −250:27:−142, −124:27:−16, 34:27:223],
[−493:27:−277, −245:27:−164, −119:27:−38, 12:27:228, −481:27:−265, −233:27:−152, −107:27:−26, 24:27:240],
[−487:27:−271, −239:27:−158, −113:27:−32, 18:27:234, −475:27:−259, −227:27:−146, −101:27:−20, 30:27:246],
[−490:27:−274, −242:27:−161, −116:27:−35, 15:27:231, −478:27:−262, −230:27:−149, −104:27:−23, 27:27:243], and
[−484:27:−268, −236:27:−155, −110:27:−29, 21:27:237, −472:27:−283, −251:27:−143, −125:27:−17, 33:27:222],
the plurality of 106-tone RUs of the second tone plan comprise:
[−500, −494:27:−278, −246:27:−165, −120:27:−12, 38:27:227, −482:27:−266, −234:27:−153, −108:27:−27, 23:27:239, −488:27:−272, −240:27:−159, −114:27:−33, 17:27:233, −476:27:−260, −228:27:−147, −102:27:−21, 29:27:245, 251],
[−497, −491:27:−275, −243:27:−162, −117:27:−36, 14:27:230, −479:27:−263, −231:27:−150, −105:27:−24, 26:27:242, −485:27:−269, −237:27:−156, −111:27:−30, 20:27:236, −473:27:−284, −252:27:−144, −126:27:−18, 32:27:221, 248],
[−498, −492:27:−276, −244:27:−163, −118:27:−37, 13:27:229, −480:27:−264, −232:27:−151, −106:27:−25, 25:27:241, −486:27:−270, −238:27:−157, −112:27:−31, 19:27:235, −474:27:−285, −253:27:−145, −100:27:−19, 31:27:247, 253],
[−495, −489:27:−273, −241:27:−160, −115:27:−34, 16:27:232, −477:27:−261, −229:27:−148, −103:27:−22, 28:27:244, −483:27:−267, −235:27:−154, −109:27:−28, 22:27:238, −471:27:−282, −250:27:−142, −124:27:−16, 34:27:223, 250],
[−499, −493:27:−277, −245:27:−164, −119:27:−38, 12:27:228, −481:27:−265, −233:27:−152, −107:27:−26, 24:27:240, −487:27:−271, −239:27:−158, −113:27:−32, 18:27:234, −475:27:−259, −227:27:−146, −101:27:−20, 30:27:246, 252],
[−496, −490:27:−274, −242:27:−161, −116:27:−35, 15:27:231, −478:27:−262, −230:27:−149, −104:27:−23, 27:27:243, −484:27:−268, −236:27:−155, −110:27:−29, 21:27:237, −472:27:−283, −251:27:−143, −125:27:−17, 33:27:222, 249], and
the plurality of 242-tone RUs of the second tone plan comprise:
[−500:3:−260, −252:3:−12, 14:3:251],
[−498:3:−261, −253:3:−13, 13:3:253], and
[−499:3:−259, −251:3:−14, 12:3:252],
where indices of each RU are enclosed between “[” and “]”, and a:b:c represents an index range from a to c with a spacing of b;
wherein the third tone plan comprises:
a plurality of 26-tone RUs,
a plurality of 52-tone RUs,
a plurality of 106-tone RUs,
a plurality of 242-tone RUs, or
a combination thereof;
wherein the plurality of 26-tone RUs of the third tone plan comprise:
[−486:27:−27, 27:27:216],
[−471:27:−39, 15:27:231],
[−480:27:−21, 33:27:222],
[−465:27:−33, 21:27:237],
[−474−:27:−15, 39:27:228],
[−483:27:−24, 30:27:219],
[−468:27:−36, 18:27:234],
[−477:27:−18, 36:27:225],
[−462:27:−30, 24:27:240],
[−485:27:−26, 28:27:217],
[−470:27:−38, 16:27:232],
[−479:27:−20, 34:27:223],
[−464:27:−32, 22:27:238],
[−473−:27:−14, 40:27:229],
[−482:27:−23, 31:27:220],
[−467:27:−35, 19:27:235],
[−476:27:−17, 37:27:226],
[−461:27:−29, 25:27:241],
[−484:27:−25, 29:27:218],
[−469:27:−37, 17:27:233],
[−478:27:−19, 35:27:224],
[−463:27:−31, 23:27:239],
[−472−:27:−13, 41:27:230],
[−481:27:−22, 32:27:221],
[−466:27:−34, 20:27:236],
[−475:27:−16, 38:27:227], and
[−460:27:−28, 26:27:242],
the plurality of 52-tone RUs of the third tone plan comprise:
[−486:27:−27, 27:27:216, −471:27:−39, 15:27:231],
[−480:27:−21, 33:27:222, −465:27:−33, 21:27:237],
[−483:27:−24, 30:27:219, −468:27:−36, 18:27:234],
[−477:27:−18, 36:27:225, −462:27:−30, 24:27:240],
[−485:27:−26, 28:27:217, −470:27:−38, 16:27:232],
[−479:27:−20, 34:27:223, −464:27:−32, 22:27:238],
[−482:27:−23, 31:27:220, −467:27:−35, 19:27:235],
[−476:27:−17, 37:27:226, −461:27:−29, 25:27:241],
[−484:27:−25, 29:27:218, −469:27:−37, 17:27:233],
[−478:27:−19, 35:27:224, −463:27:−31, 23:27:239],
[−481:27:−22, 32:27:221, −466:27:−34, 20:27:236], and
[−475:27:−16, 38:27:227, −460:27:−28, 26:27:242],
the plurality of 106-tone RUs of the third tone plan comprise:
[−486:27:−27, 27:27:216, −471:27:−39, 15:27:231, −480:27:−21, 33:27:222, −465:27:−33, 21:27:237, −492, 243],
[−483:27:−24, 30:27:219, −468:27:−36, 18:27:234, −477:27:−18, 36:27:225, −462:27:−30, 24:27:240, −489, 246],
[−485:27:−26, 28:27:217, −470:27:−38, 16:27:232, −479:27:−20, 34:27:223, −464:27:−32, 22:27:238, −491, 244],
[−482:27:−23, 31:27:220, −467:27:−35, 19:27:235, −476:27:−17, 37:27:226, −461:27:−29, 25:27:241, −488, 247],
[−484:27:−25, 29:27:218, −469:27:−37, 17:27:233, −478:27:−19, 35:27:224, −463:27:−31, 23:27:239, −490, 245], and
[−481:27:−22, 32:27:221, −466:27:−34, 20:27:236, −475:27:−16, 38:27:227, −460:27:−28, 26:27:242, −487, 248], and
the plurality of 242-tone RUs of the third tone plan comprise:
[−498:3:−15, 15:3:252],
[−497:3−14, 16:3:253], and
[−496:3:−13, 17:3:254].

2. The communication method of claim 1, wherein the plurality of 26-tone, 52-tone, 106-tone, and 242-tone RUs of the second tone plan are obtained from a plurality of intermediate 26-tone, 52-tone, 106-tone, and 242-tone RUs by deducting 5 from indices of the plurality of intermediate 26-tone, 52-tone, 106-tone, and 242-tone RUs that are smaller than or equal to −254;
wherein the plurality of intermediate 26-tone RUs comprise:
[−489:27:−165, −120:27:−12, 38:27:227],
[−477:27:−153, −108:27:−27, 23:27:239],
[−483:27:−159, −114:27:−33, 17:27:233],
[−471:27:−147, −102:27:−21, 29:27:245],
[−465−:27:−141, −123:27:−15, 35:27:224],
[−486:27:−162, −117:27:−36, 14:27:230],
[−474:27:−150, −105:27:−24, 26:27:242],
[−480:27:−156, −111:27:−30, 20:27:236],
[−468:27:−144, −126:27:−18, 32:27:221],
[−487:27:−163, −118:27:−37, 13:27:229],
[−475:27:−151, −106:27:−25, 25:27:241],
[−481:27:−157, −112:27:−31, 19:27:235],
[−469:27:−145, −100:27:−19, 31:27:247],
[−463−:27:−139, −121:27:−13, 37:27:226],
[−484:27:−160, −115:27:−34, 16:27:232],
[−472:27:−148, −103:27:−22, 28:27:244],
[−478:27:−154, −109:27:−28, 22:27:238],
[−466:27:−142, −124:27:−16, 34:27:223],
[−488:27:−164, −119:27:−38, 12:27:228],
[−476:27:−152, −107:27:−26, 24:27:240],
[−482:27:−158, −113:27:−32, 18:27:234],
[−470:27:−146, −101:27:−20, 30:27:246],
[−464−:27:−140, −122:27:−14, 36:27:225],
[−485:27:−161, −116:27:−35, 15:27:231],
[−473:27:−149, −104:27:−23, 27:27:243],
[−479:27:−155, −110:27:−29, 21:27:237],
[−467:27:−143, −125:27:−17, 33:27:222];
wherein the plurality of intermediate 52-tone RUs comprise:
[−489:27:−165, −120:27:−12, 38:27:227, −477:27:−153, −108:27:−27, 23:27:239],
[−483:27:−159, −114:27:−33, 17:27:233, −471:27:−147, −102:27:−21, 29:27:245],
[−486:27:−162, −117:27:−36, 14:27:230, −474:27:−150, −105:27:−24, 26:27:242],
[−480:27:−156, −111:27:−30, 20:27:236, −468:27:−144, −126:27:−18, 32:27:221],
[−487:27:−163, −118:27:−37, 13:27:229, −475:27:−151, −106:27:−25, 25:27:241],
[−481:27:−157, −112:27:−31, 19:27:235, −469:27:−145, −100:27:−19, 31:27:247],
[−484:27:−160, −115:27:−34, 16:27:232, −472:27:−148, −103:27:−22, 28:27:244],
[−478:27:−154, −109:27:−28, 22:27:238, −466:27:−142, −124:27:−16, 34:27:223],
[−488:27:−164, −119:27:−38, 12:27:228, −476:27:−152, −107:27:−26, 24:27:240],
[−482:27:−158, −113:27:−32, 18:27:234, −470:27:−146, −101:27:−20, 30:27:246],
[−485:27:−161, −116:27:−35, 15:27:231, −473:27:−149, −104:27:−23, 27:27:243],
[−479:27:−155, −110:27:−29, 21:27:237, −467:27:−143, −125:27:−17, 33:27:222];
wherein the plurality of intermediate 106-tone RUs comprise:
[−489:27:−165, −120:27:−12, 38:27:227, −477:27:−153, −108:27:−27, 23:27:239, −483:27:−159, −114:27:−33, 17:27:233, −471:27:−147, −102:27:−21, 29:27:245, −495, 251],
[−486:27:−162, −117:27:−36, 14:27:230, −474:27:−150, −105:27:−24, 26:27:242, −480:27:−156, −111:27:−30, 20:27:236, −468:27:−144, −126:27:−18, 32:27:221, −492, 248],
[−487:27:−163, −118:27:−37, 13:27:229, −475:27:−151, −106:27:−25, 25:27:241, −481:27:−157, −112:27:−31, 19:27:235, −469:27:−145, −100:27:−19, 31:27:247, −493, 253],
[−484:27:−160, −115:27:−34, 16:27:232, −472:27:−148, −103:27:−22, 28:27:244, −478:27:−154, −109:27:−28, 22:27:238, −466:27:−142, −124:27:−16, 34:27:223, −490, 250],
[−488:27:−164, −119:27:−38, 12:27:228, −476:27:−152, −107:27:−26, 24:27:240, −482:27:−158, −113:27:−32, 18:27:234, −470:27:−146, −101:27:−20, 30:27:246, −494, 252],
[−485:27:−161, −116:27:−35, 15:27:231, −473:27:−149, −104:27:−23, 27:27:243, −479:27:−155, −110:27:−29, 21:27:237, −467:27:−143, −125:27:−17, 33:27:222, −491 249]; and
wherein the plurality of intermediate 242-tone RUs comprise:
[−495:3:−12, 14:3:251](that is, [DRU_base_60]),
[−493:3:−13, 13:3:253], and
[−494:3:−14, 12:3:252].

3. One or more processors functionally coupled to one or more non-transitory computer-readable storage media, wherein the one or more non-transitory computer-readable storage media comprise computer-executable instructions; and wherein the instructions, when executed, cause the one or more processors to perform the method of claim 1.

4. The one or more processors of claim 3, wherein the plurality of 26-tone, 52-tone, 106-tone, and 242-tone RUs of the second tone plan are obtained from a plurality of intermediate 26-tone, 52-tone, 106-tone, and 242-tone RUs by deducting 5 from indices of the plurality of intermediate 26-tone, 52-tone, 106-tone, and 242-tone RUs that are smaller than or equal to −254;
wherein the plurality of intermediate 26-tone RUs comprise:
[−489:27:−165, −120:27:−12, 38:27:227],
[−477:27:−153, −108:27:−27, 23:27:239],
[−483:27:−159, −114:27:−33, 17:27:233],
[−471:27:−147, −102:27:−21, 29:27:245],
[−465−:27:−141, −123:27:−15, 35:27:224],
[−486:27:−162, −117:27:−36, 14:27:230],
[−474:27:−150, −105:27:−24, 26:27:242],
[−480:27:−156, −111:27:−30, 20:27:236],
[−468:27:−144, −126:27:−18, 32:27:221],
[−487:27:−163, −118:27:−37, 13:27:229],
[−475:27:−151, −106:27:−25, 25:27:241],
[−481:27:−157, −112:27:−31, 19:27:235],
[−469:27:−145, −100:27:−19, 31:27:247],
[−463−:27:−139, −121:27:−13, 37:27:226],
[−484:27:−160, −115:27:−34, 16:27:232],
[−472:27:−148, −103:27:−22, 28:27:244],
[−478:27:−154, −109:27:−28, 22:27:238],
[−466:27:−142, −124:27:−16, 34:27:223],
[−488:27:−164, −119:27:−38, 12:27:228],
[−476:27:−152, −107:27:−26, 24:27:240],
[−482:27:−158, −113:27:−32, 18:27:234],
[−470:27:−146, −101:27:−20, 30:27:246],
[−464−:27:−140, −122:27:−14, 36:27:225],
[−485:27:−161, −116:27:−35, 15:27:231],
[−473:27:−149, −104:27:−23, 27:27:243],
[−479:27:−155, −110:27:−29, 21:27:237],
[−467:27:−143, −125:27:−17, 33:27:222];
wherein the plurality of intermediate 52-tone RUs comprise:
[−489:27:−165, −120:27:−12, 38:27:227, −477:27:−153, −108:27:−27, 23:27:239],
[−483:27:−159, −114:27:−33, 17:27:233, −471:27:−147, −102:27:−21, 29:27:245],
[−486:27:−162, −117:27:−36, 14:27:230, −474:27:−150, −105:27:−24, 26:27:242],
[−480:27:−156, −111:27:−30, 20:27:236, −468:27:−144, −126:27:−18, 32:27:221],
[−487:27:−163, −118:27:−37, 13:27:229, −475:27:−151, −106:27:−25, 25:27:241],
[−481:27:−157, −112:27:−31, 19:27:235, −469:27:−145, −100:27:−19, 31:27:247],
[−484:27:−160, −115:27:−34, 16:27:232, −472:27:−148, −103:27:−22, 28:27:244],
[−478:27:−154, −109:27:−28, 22:27:238, −466:27:−142, −124:27:−16, 34:27:223],
[−488:27:−164, −119:27:−38, 12:27:228, −476:27:−152, −107:27:−26, 24:27:240],
[−482:27:−158, −113:27:−32, 18:27:234, −470:27:−146, −101:27:−20, 30:27:246],
[−485:27:−161, −116:27:−35, 15:27:231, −473:27:−149, −104:27:−23, 27:27:243],
[−479:27:−155, −110:27:−29, 21:27:237, −467:27:−143, −125:27:−17, 33:27:222];
wherein the plurality of intermediate 106-tone RUs comprise:
[−489:27:−165, −120:27:−12, 38:27:227, −477:27:−153, −108:27:−27, 23:27:239, −483:27:−159, −114:27:−33, 17:27:233, −471:27:−147, −102:27:−21, 29:27:245, −495, 251],
[−486:27:−162, −117:27:−36, 14:27:230, −474:27:−150, −105:27:−24, 26:27:242, −480:27:−156, −111:27:−30, 20:27:236, −468:27:−144, −126:27:−18, 32:27:221, −492, 248],
[−487:27:−163, −118:27:−37, 13:27:229, −475:27:−151, −106:27:−25, 25:27:241, −481:27:−157, −112:27:−31, 19:27:235, −469:27:−145, −100:27:−19, 31:27:247, −493, 253],
[−484:27:−160, −115:27:−34, 16:27:232, −472:27:−148, −103:27:−22, 28:27:244, −478:27:−154, −109:27:−28, 22:27:238, −466:27:−142, −124:27:−16, 34:27:223, −490, 250],
[−488:27:−164, −119:27:−38, 12:27:228, −476:27:−152, −107:27:−26, 24:27:240, −482:27:−158, −113:27:−32, 18:27:234, −470:27:−146, −101:27:−20, 30:27:246, −494, 252],
[−485:27:−161, −116:27:−35, 15:27:231, −473:27:−149, −104:27:−23, 27:27:243, −479:27:−155, −110:27:−29, 21:27:237, −467:27:−143, −125:27:−17, 33:27:222, −491 249]; and
wherein the plurality of intermediate 242-tone RUs comprise:
[−495:3:−12, 14:3:251](that is, [DRU_base_60]),
[−493:3:−13, 13:3:253], and
[−494:3:−14, 12:3:252].

5. One or more non-transitory computer-readable storage media comprising computer-executable instructions, wherein the instructions, when executed, cause one or more processors to perform the method of claim 1.

6. The one or more non-transitory computer-readable storage media of claim 5, wherein the plurality of 26-tone, 52-tone, 106-tone, and 242-tone RUs of the second tone plan are obtained from a plurality of intermediate 26-tone, 52-tone, 106-tone, and 242-tone RUs by deducting 5 from indices of the plurality of intermediate 26-tone, 52-tone, 106-tone, and 242-tone RUs that are smaller than or equal to −254;
wherein the plurality of intermediate 26-tone RUs comprise:
[−489:27:−165, −120:27:−12, 38:27:227],
[−477:27:−153, −108:27:−27, 23:27:239],
[−483:27:−159, −114:27:−33, 17:27:233],
[−471:27:−147, −102:27:−21, 29:27:245],
[−465−:27:−141, −123:27:−15, 35:27:224],
[−486:27:−162, −117:27:−36, 14:27:230],
[−474:27:−150, −105:27:−24, 26:27:242],
[−480:27:−156, −111:27:−30, 20:27:236],
[−468:27:−144, −126:27:−18, 32:27:221],
[−487:27:−163, −118:27:−37, 13:27:229],
[−475:27:−151, −106:27:−25, 25:27:241],
[−481:27:−157, −112:27:−31, 19:27:235],
[−469:27:−145, −100:27:−19, 31:27:247],
[−463−:27:−139, −121:27:−13, 37:27:226],
[−484:27:−160, −115:27:−34, 16:27:232],
[−472:27:−148, −103:27:−22, 28:27:244],
[−478:27:−154, −109:27:−28, 22:27:238],
[−466:27:−142, −124:27:−16, 34:27:223],
[−488:27:−164, −119:27:−38, 12:27:228],
[−476:27:−152, −107:27:−26, 24:27:240],
[−482:27:−158, −113:27:−32, 18:27:234],
[−470:27:−146, −101:27:−20, 30:27:246],
[−464−:27:−140, −122:27:−14, 36:27:225],
[−485:27:−161, −116:27:−35, 15:27:231],
[−473:27:−149, −104:27:−23, 27:27:243],
[−479:27:−155, −110:27:−29, 21:27:237],
[−467:27:−143, −125:27:−17, 33:27:222];
wherein the plurality of intermediate 52-tone RUs comprise:
[−489:27:−165, −120:27:−12, 38:27:227, −477:27:−153, −108:27:−27, 23:27:239],
[−483:27:−159, −114:27:−33, 17:27:233, −471:27:−147, −102:27:−21, 29:27:245],
[−486:27:−162, −117:27:−36, 14:27:230, −474:27:−150, −105:27:−24, 26:27:242],
[−480:27:−156, −111:27:−30, 20:27:236, −468:27:−144, −126:27:−18, 32:27:221],
[−487:27:−163, −118:27:−37, 13:27:229, −475:27:−151, −106:27:−25, 25:27:241],
[−481:27:−157, −112:27:−31, 19:27:235, −469:27:−145, −100:27:−19, 31:27:247],
[−484:27:−160, −115:27:−34, 16:27:232, −472:27:−148, −103:27:−22, 28:27:244],
[−478:27:−154, −109:27:−28, 22:27:238, −466:27:−142, −124:27:−16, 34:27:223],
[−488:27:−164, −119:27:−38, 12:27:228, −476:27:−152, −107:27:−26, 24:27:240],
[−482:27:−158, −113:27:−32, 18:27:234, −470:27:−146, −101:27:−20, 30:27:246],
[−485:27:−161, −116:27:−35, 15:27:231, −473:27:−149, −104:27:−23, 27:27:243],
[−479:27:−155, −110:27:−29, 21:27:237, −467:27:−143, −125:27:−17, 33:27:222];
wherein the plurality of intermediate 106-tone RUs comprise:
[−489:27:−165, −120:27:−12, 38:27:227, −477:27:−153, −108:27:−27, 23:27:239, −483:27:−159, −114:27:−33, 17:27:233, −471:27:−147, −102:27:−21, 29:27:245, −495, 251],
[−486:27:−162, −117:27:−36, 14:27:230, −474:27:−150, −105:27:−24, 26:27:242, −480:27:−156, −111:27:−30, 20:27:236, −468:27:−144, −126:27:−18, 32:27:221, −492, 248],
[−487:27:−163, −118:27:−37, 13:27:229, −475:27:−151, −106:27:−25, 25:27:241, −481:27:−157, −112:27:−31, 19:27:235, −469:27:−145, −100:27:−19, 31:27:247, −493, 253],
[−484:27:−160, −115:27:−34, 16:27:232, −472:27:−148, −103:27:−22, 28:27:244, −478:27:−154, −109:27:−28, 22:27:238, −466:27:−142, −124:27:−16, 34:27:223, −490, 250],
[−488:27:−164, −119:27:−38, 12:27:228, −476:27:−152, −107:27:−26, 24:27:240, −482:27:−158, −113:27:−32, 18:27:234, −470:27:−146, −101:27:−20, 30:27:246, −494, 252],
[−485:27:−161, −116:27:−35, 15:27:231, −473:27:−149, −104:27:−23, 27:27:243, −479:27:−155, −110:27:−29, 21:27:237, −467:27:−143, −125:27:−17, 33:27:222, −491 249]; and
wherein the plurality of intermediate 242-tone RUs comprise:
[−495:3:−12, 14:3:251](that is, [DRU_base_60]),
[−493:3:−13, 13:3:253], and
[−494:3:−14, 12:3:252].

7. A communication method comprising:
transmitting or receiving a signal using a first resource unit (RU) in an orthogonal frequency-division multiple access (OFDMA) physical layer protocol data unit (PPDU), the first RU being selected from a plurality of first RUs of a first tone plan for the PPDU;
wherein the plurality of first RUs are same as a plurality of second RUs defined according to a second tone plan; and
wherein the second tone plan is obtained by a tone-distribution method comprising:
partitioning the PPDU into a plurality of subchannels,
determining a third tone plan having a plurality of third RUs, the indices of tones of the third tone plan being greater than or equal to zero, and
modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for at least a first subchannel of the plurality of subchannels.

8. The communication method of claim 7, wherein said modifying the indices of the tones of the third tone plan comprises:
modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for the first subchannel of the plurality of subchannels; and
shifting the modified indices of the tones of the third tone plan to obtain a plurality of further modified third RUs as a subset of the plurality of second RUs for each of one or more second subchannels of the plurality of subchannels.

9. One or more processors functionally coupled to one or more non-transitory computer-readable storage media, wherein the one or more non-transitory computer-readable storage media comprise computer-executable instructions; and wherein the instructions, when executed, cause the one or more processors to perform the method of claim 7.

10. The one or more processors of claim 9, wherein said modifying the indices of the tones of the third tone plan comprises:
modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for the first subchannel of the plurality of subchannels; and
shifting the modified indices of the tones of the third tone plan to obtain a plurality of further modified third RUs as a subset of the plurality of second RUs for each of one or more second subchannels of the plurality of subchannels.

11. The one or more processors of claim 9, wherein the third tone plan comprises:
a plurality of 26-tone RUs,
a plurality of 52-tone RUs,
a plurality of 106-tone RUs,
a plurality of 242-tone RUs, or
a combination thereof;
wherein the plurality of 26-tone RUs comprise:
[2:9:110, 125:9:233],
[6:9:114, 129:9:237],
[4:9:112, 127:9:235],
[8:9:116, 131:9:239],
[10:9:118, 124:9:232],
[3:9:111, 126:9:234],
[7:9:115, 130:9:238],
[5:9:113, 128:9:236], and
[9:9:117, 123:9:231];
wherein the plurality of 52-tone RUs comprise:
[2:9:110, 125:9:233, 6:9:114, 129:9:237],
4:9:112, 127:9:235, 8:9:116, 131:9:239],
[3:9:111, 126:9:234, 7:9:115, 130:9:238], and
[5:9:113, 128:9:236, 9:9:117, 123:9:231];
wherein the plurality of 106-tone RUs comprise:
[2:9:110, 125:9:233, 6:9:114, 129:9:237, 4:9:112, 127:9:235, 8:9:116, 131:9:239, 119, 122], and
[3:9:111, 126:9:234, 7:9:115, 130:9:238, 5:9:113, 128:9:236, 9:9:117, 123:9:231, 120, 121]; and
wherein the plurality of 242-tone RUs comprise: [0:241].

12. The one or more processors of claim 11, wherein the PPDU has a bandwidth of 80 MHz partitioned to four 20 MHz subchannels; and
wherein said modifying the indices of the tones of the third tone plan comprises:
(i) modifying the indices of the tones of the third tone plan by replacing each index idx of the tones of the third tone plan with index (idx*4+ini) when idx≤120, or with the index (idx*4+ini+23) when idx>120, where ini=−495, −494, −493, or −492, and
(ii) replacing each index idx of the tones of the third tone plan with index (idx−5) if idx≤−254, or with index (idx+5) if idx≥254.

13. The one or more processors of claim 11, wherein the PPDU has a bandwidth of 60 MHz partitioned to three 20 MHz subchannels, or a bandwidth of 80 MHz partitioned to four 20 MHz subchannels with a highest 20 MHz subchannel temporarily unusable; and
wherein said modifying the indices of the tones of the third tone plan comprises:
(i) modifying the indices of the tones of the third tone plan by replacing each index idx of the tones of the third tone plan with index (idx*3+ini) when idx≤161, or with the index (idx*3+ini+23) when idx>161, where ini=−495, or
modifying the indices of the tones of the third tone plan by replacing each index idx of the tones of the third tone plan with index (idx*3+ini) when idx≤160, or with the index (idx*3+ini+23) when idx>160, where ini=−493, or −494, and
(ii) replacing each index idx of the tones of the third tone plan with index (idx−5) if idx≤−254.

14. One or more non-transitory computer-readable storage media comprising computer-executable instructions, wherein the instructions, when executed, cause one or more processors to perform the method of claim 7.

15. The one or more non-transitory computer-readable storage media of claim 14, wherein said modifying the indices of the tones of the third tone plan comprises:
modifying the indices of the tones of the third tone plan such that the modified indices of the tones of the third tone plan comprise negative and positive indices excluding a plurality of direct current (DC) tones at and around index zero, so as to obtain a plurality of modified third RUs as a subset of the plurality of second RUs for the first subchannel of the plurality of subchannels; and
shifting the modified indices of the tones of the third tone plan to obtain a plurality of further modified third RUs as a subset of the plurality of second RUs for each of one or more second subchannels of the plurality of subchannels.

16. The one or more non-transitory computer-readable storage media of claim 14, wherein the third tone plan comprises:
a plurality of 26-tone RUs,
a plurality of 52-tone RUs,
a plurality of 106-tone RUs,
a plurality of 242-tone RUs, or
a combination thereof;
wherein the plurality of 26-tone RUs comprise:
[2:9:110, 125:9:233],
[6:9:114, 129:9:237],
[4:9:112, 127:9:235],
[8:9:116, 131:9:239],
[10:9:118, 124:9:232],
[3:9:111, 126:9:234],
[7:9:115, 130:9:238],
[5:9:113, 128:9:236], and
[9:9:117, 123:9:231];
wherein the plurality of 52-tone RUs comprise:
[2:9:110, 125:9:233, 6:9:114, 129:9:237],
4:9:112, 127:9:235, 8:9:116, 131:9:239],
[3:9:111, 126:9:234, 7:9:115, 130:9:238], and
[5:9:113, 128:9:236, 9:9:117, 123:9:231];
wherein the plurality of 106-tone RUs comprise:
[2:9:110, 125:9:233, 6:9:114, 129:9:237, 4:9:112, 127:9:235, 8:9:116, 131:9:239, 119, 122], and
[3:9:111, 126:9:234, 7:9:115, 130:9:238, 5:9:113, 128:9:236, 9:9:117, 123:9:231, 120, 121]; and
wherein the plurality of 242-tone RUs comprise: [0:241].

17. The one or more non-transitory computer-readable storage media of claim 16, wherein the PPDU has a bandwidth of 40 MHz partitioned to two 20 MHz subchannels; and
wherein said modifying the indices of the tones of the third tone plan comprises:
modifying the indices of the tones of the third tone plan by replacing each index idx of the second number of tones with index (idx*2+ini) when idx≤120, or with the index (idx*2+ini+5) when idx>120, where ini=−244 or −243.

18. The one or more non-transitory computer-readable storage media of claim 16, wherein the PPDU has a bandwidth of 80 MHz partitioned to four 20 MHz subchannels; and
wherein said modifying the indices of the tones of the third tone plan comprises:
(i) modifying the indices of the tones of the third tone plan by replacing each index idx of the tones of the third tone plan with index (idx*4+ini) when idx≤120, or with the index (idx*4+ini+23) when idx>120, where ini=−495, −494, −493, or −492, and
(ii) replacing each index idx of the tones of the third tone plan with index (idx−5) if idx S −254, or with index (idx+5) if idx≥254.

19. The one or more non-transitory computer-readable storage media of claim 16, wherein the PPDU has a bandwidth of 60 MHz partitioned to three 20 MHz subchannels, or a bandwidth of 80 MHz partitioned to four 20 MHz subchannels with a highest 20 MHz subchannel temporarily unusable; and
wherein said modifying the indices of the tones of the third tone plan comprises:
(i) modifying the indices of the tones of the third tone plan by replacing each index idx of the tones of the third tone plan with index (idx*3+ini) when idx≤161, or with the index (idx*3+ini+23) when idx>161, where ini=−495, or
modifying the indices of the tones of the third tone plan by replacing each index idx of the tones of the third tone plan with index (idx*3+ini) when idx≤160, or with the index (idx*3+ini+23) when idx>160, where ini=−493, or −494, and
(ii) replacing each index idx of the tones of the third tone plan with index (idx−5) if idx≤−254.

20. The one or more non-transitory computer-readable storage media of claim 16, wherein the PPDU has a bandwidth of 40 MHz partitioned to two 20 MHz subchannels, or a bandwidth of 80 MHz partitioned to four 20 MHz subchannels with two highest 20 MHz subchannels temporarily unusable; and
wherein said modifying the indices of the tones of the third tone plan comprises:
(i) modifying the indices of the tones of the third tone plan by replacing each index idx of the tones of the third tone plan with index (idx*2+ini), where ini=−495 or −494, and
(ii) replacing each index idx of the tones of the third tone plan with index (idx−5) if idx≤−254.
